(19) United States
(12) Patent Application Publication
(10) Pub. No.: US 2014/0121182 A1
(43) Pub. Date: May 1, 2014

(54) PROTEASOME INHIBITORS AND PROCESSES FOR THEIR PREPARATION, PURIFICATION AND USE

(71) Applicants: Roger P. Bakale, Malvern, PA (US); John P. Mallamo, Glenmoore, PA (US); Renee Caroline Roemmele, Maple Glen, PA (US)

(72) Inventors: Roger P. Bakale, Malvern, PA (US); John P. Mallamo, Glenmoore, PA (US); Renee Caroline Roemmele, Maple Glen, PA (US)

(73) Assignee: Cephalon, Inc., Frazer, PA (US)

(21) Appl. No.: 14/127,511

(22) PCT Filed: Jun. 21, 2012
(86) PCT No.: PCT/US12/43485

§ 371 Date: Dec. 19, 2013

Related U.S. Application Data
(60) Provisional application No. 61/499,962, filed on Jun. 22, 2011.

(51) Int. Cl. C07F 5/04; C07F 5/02

(52) U.S. Cl. CPC C07F 5/04; C07F 5/025
USPC 514/64; 558/289; 562/7

(57) ABSTRACT

The invention provides boronic esters of Formula (I) wherein R is H or methyl, and methods for the preparation and purification thereof.

### FIELD OF THE INVENTION

The invention pertains to proteasome inhibitors and to processes for their preparation, purification and use.

### BACKGROUND OF THE INVENTION

[(1R)-1-({[(2,5-dichlorobenzoyl)amino]acetyl}amino)-3-methylbutyl]boronic acid (Compound 1) is a proteasome inhibitor in the peptide boronic acid class, which may be useful in the treatment of multiple myeloma. Compound 1 and analogs thereof are described in U.S. Pat. No. 7,442,830 ('830 patent) and U.S. Pat. No. 7,687,662 ('662 patent). Compound 1 readily condenses with itself to form anhydride dimers and trimers, such as the trimer N,N′,N″-boroxin-2,4,6-triyltris{{(1R)-3-methylbutane-1,1-diyl]imino(2-oxoethane-2,1-diyl)]}tris(2,5-dichlorobenzamide). As used herein, the term “Compound 1” includes the free boronic acid and condensed anhydride forms, and the depiction of Compound 1 as a free boronic acid monomer is intended to include anhydride forms as well. The chemical structures of Compound 1 free boronic acid monomer and its trimer anhydride are provided below.

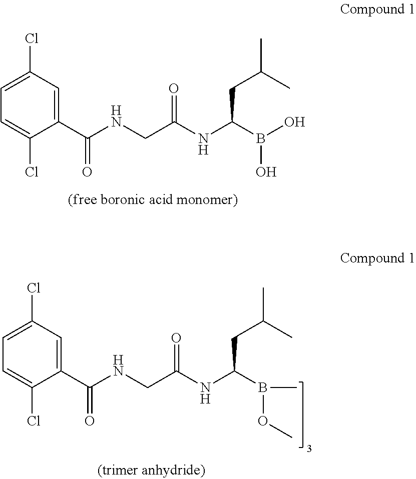 [SMILES: CC(C)C[C@H](NC(=O)CNC(=O)c1cc(Cl)ccc1Cl)B(O)O ; COB(C)[C@H](CC(C)C)NC(=O)CNC(=O)c1cc(Cl)ccc1Cl]

Compound 1 is challenging to work with from a pharmaceutical perspective because it is non-crystalline, difficult to purify and unstable. Improved methods for preparing and purifying Compound 1 are required. Also required are high purity and storage stable forms of Compound 1.

### SUMMARY OF THE INVENTION

The present invention provides a boronic ester of Formula I

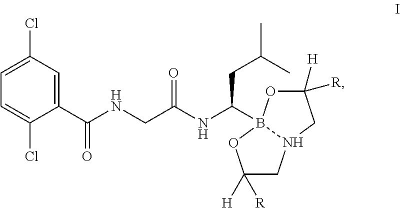

wherein R is H or methyl. In one embodiment, R is H. In another embodiment, R is CH₃.

The present invention further provides a process for preparing a pharmaceutical composition, comprising the step of combining a boronic ester of the present invention with a pharmaceutically acceptable excipient.

The present invention further provides Compound 1 having a chemical purity of at least 99.5%.

The present invention also provides a pharmaceutical composition comprising the Compound 1 of the present invention and a pharmaceutically acceptable excipient.

The present invention further provides a process for preparing a pharmaceutical composition of Compound 1,
comprising the steps of:
(a) converting a boronic ester of Formula I,

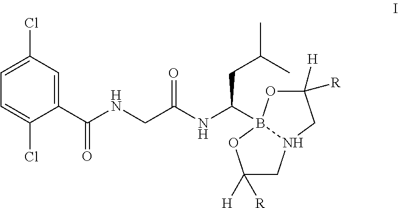

wherein R is H or methyl,
into Compound 1; and
(b) combining the Compound 1 with a pharmaceutically acceptable excipient.
   In one embodiment, R is H. In another embodiment, R is methyl.

The present invention further provides a process for purifying Compound 1,

comprising the steps of:
(a) converting the Compound 1 into a boronic ester of Formula I

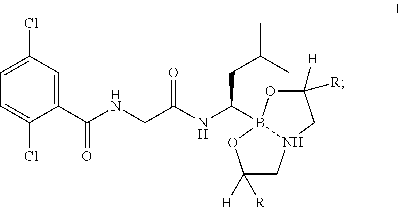

(b) crystallizing the boronic ester of Formula I from solution;
(c) isolating the crystallized boronic ester of Formula I from the solution; and
(d) converting the isolated boronic ester of Formula I into Compound 1.
   In one embodiment, R is H. In another embodiment, R is methyl.

The present invention further provides a process for preparing Compound 1, comprising the steps of
(a) crystallizing the boronic ester of Formula I from a solution; and

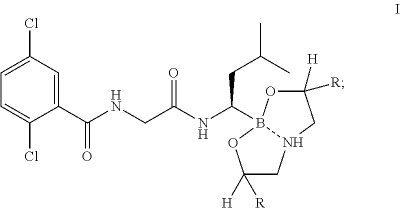

(b) converting the boronic ester of Formula I into Compound 1.
   In one embodiment, R is H. In another embodiment, R is methyl.

### BRIEF DESCRIPTION OF THE DRAWINGS

FIG. 1 depicts an XRPD pattern of the diethanolamine ester of Compound 1 (i.e., boronic ester of Formula X).

FIG. 2 depicts an XRPD pattern of the diisopropanolamine ester of Compound 1 (i.e., boronic ester of Formula IX).

FIG. 3 depicts an XRPD pattern of the N-methyldiethanol amine ester of Compound 1.

FIG. 4 depicts an XRPD pattern of the N-methylimino diacetic acid ester of Compound 1.

FIG. 5 depicts the plasma levels of Compound 1 in rat dosed as Form 1 of the citric acid ester of Compound 1.

FIG. 6 depicts the blood levels of Compound 1 in rat dosed as Form 1 of the citric acid ester of Compound 1.

FIG. 7 depicts plasma levels of Compound 1 in rat dosed as Form 2 of the citric acid ester of Compound 1.

FIG. 8 depicts blood levels of Compound 1 in rat dosed as Form 2 of the citric acid ester of Compound 1.

FIG. 9 depicts plasma levels of Compound 1 in rat dosed as the boronic ester of Formula X.

FIG. 10 depicts blood levels of Compound 1 in rat dosed as the boronic ester of Formula X.

### DETAILED DESCRIPTION OF ILLUSTRATIVE EMBODIMENTS

### Definitions

“Isolating” refers to separating a component (e.g., a compound) from a mixture.
“Purity” refers to chemical purity and/or chiral purity.
“Chemical Purity” refers to the relative quantity of one component in a mixture (i.e., ([quantity of component of interest]/[total quantity of all components])*100%).
“Chiral purity” refers to the proportion of one enantiomer or diastereomer in a mixture of enantiomers or diastereomers, and is expressed as enantiomeric excess (% ee) or diastereomeric excess (% de), which are defined as ((enantiomer of interest−other enantiomer)/(enantiomer of interest+other enantiomer))*100%, or ((diastereomer of interest)−(other diastereomers)/(total diastereomers))*100%.
“Purifying” refers to increasing the chemical purity and/or chiral purity of a compound.
“Solution” refers to a solvent containing a substance(s) that is at least partially dissolved; and which may contain undissolved (e.g., solid) substance(s)
“Alkyl” or “alkyl group” refers to a monoradical of a branched or unbranched saturated hydrocarbon chain. Examples include, but are not limited to, methyl, ethyl, n-propyl, n-butyl, n-pentyl, n-hexyl, n-heptyl, n-octyl, n-nonyl, n-decyl, isopropyl, tert-butyl, isobutyl, etc. Alkyl groups typically contain 1-10 carbon atoms, such as 1-6 carbon atoms, preferably 1-4 carbon atoms, and can be substituted or unsubstituted.
“Alkenyl” or “alkenyl group” refers to a monoradical of a branched or unbranched hydrocarbon chain containing at least one double bond. Examples include, but are not limited to, ethenyl, 3-buten-1-yl, 2-ethenylbutyl, and 3-hexen-1-yl. Alkenyl groups typically contain 2-10 carbon atoms, such as 2-6 carbon atoms, preferably 2-4 carbon atoms, and can be substituted or unsubstituted.
“Alkynyl” or “alkynyl group” refers to a monoradical of a branched or unbranched hydrocarbon chain containing at least one triple bond. Examples include, but are not limited to, ethynyl, 3-butyn-1-yl, propynyl, 2-butyn-1-yl, and 3-pentyn-1-yl. Alkynyl groups typically contain 2-10 carbon atoms, such as 2-6 carbon atoms, preferably 2-4 carbon atoms, and can be substituted or unsubstituted.
“Haloalkyl” or “haloalkyl group” refers to alkyl groups in which one or more hydrogen atoms are replaced by halogen atoms. Haloalkyl includes both saturated alkyl groups and unsaturated alkenyl and alkynyl groups, such as for example —CF₃, —CHF₂, —CH₂F, —CF₂CF₃, —CHFCF₃, —CH₂CF₃, —CF₂CH₃, —CHFCH₃, —CF₂CF₂CF₃, —CF₂CH₂CH₃, —CF═CF₂, —CCl═CH₂, —CBr═CH₂, —CI═CH₂, —C≡C—CF₃, —CHFCH₂CH₃ and —CHFCH₂CF₃.
“Halogen” includes fluorine, chlorine, bromine and iodine atoms.
“Pseudohalogen” refers to —OCN, —SCN, —CF₃, and —CN.
“Cycloalkyl” or “cycloalkyl group” refers to a monoradical non-aromatic carbocyclic ring system, which may be saturated or unsaturated, substituted or unsubstituted, and may be monocyclic, bicyclic, or tricyclic, and may be bridged, spiro, and/or fused. Examples include, but are not limited to, cyclopropyl, cyclopropenyl, cyclobutyl, cyclobutenyl, cyclopentyl, cyclopentenyl, cyclohexyl, cyclohexenyl, norbornyl, norbornenyl, bicyclo[2.2.1]hexane, bicyclo[2.2.1]heptane, bicyclo[2.2.1]heptene, bicyclo[3.1.1]heptane, bicyclo[3.2.1]octane, bicyclo[2.2.2]octane, bicyclo[3.2.2]nonane, bicyclo[3.3.1]nonane, and bicyclo[3.3.2]decane. Preferably, the cycloalkyl group contains from 3 to 10 ring atoms. More preferably, the cycloalkyl group contains from 3 to 7 ring atoms, such as 3 ring atoms, 5 ring atoms, 6 ring atoms, or 7 ring atoms.
“Cycloalkylalkyl” or “cycloalkylalkyl group” refers to an alkyl group in which a hydrogen atom is replaced by a cycloalkyl group, wherein alkyl group and cycloalkyl group are as previously defined (i.e., cycloalkylalkyl-). Cycloalkylalkyl groups can be substituted or unsubstituted. Examples include, but are not limited to, cyclohexylmethyl (C₆H₁₁CH₂—).
“Aryl” or “aryl group” refers to phenyl and 7-15 membered monoradical bicyclic or tricyclic hydrocarbon ring systems, including bridged, spiro, and/or fused ring systems, in which at least one of the rings is aromatic. Aryl groups can be substituted or unsubstituted. Examples include, but are not limited to, naphthyl, indanyl, 1,2,3,4-tetrahydronaphthalenyl, 6,7,8,9-tetrahydro-5H-benzocycloheptenyl, and 6,7,8,9-tetrahydro-5H-benzocycloheptenyl. Preferably, the aryl group contains 6 (i.e., phenyl) or 9 to 15 ring atoms. More preferably, the aryl group contains 6 (i.e., phenyl), 9 or 10 ring atoms. More preferably, the aryl group contains 6 (i.e., phenyl), or 9-11 ring atoms.
“Arylalkyl” or “arylalkyl group” refers to an alkyl group in which a hydrogen atom is replaced by an aryl group, wherein alkyl group and aryl group are as previously defined (i.e., arylalkyl-). Arylalkyl groups can be substituted or unsubstituted. Examples include, but are not limited to, benzyl (C₆H₅CH₂—).
“Heterocycloalkyl” or “heterocycloalkyl group” refers to 3-15 membered monocyclic, bicyclic, and tricyclic non-aromatic rings, which may be saturated or unsaturated, can be substituted or unsubstituted, may be bridged, spiro, and/or fused, and which contain, in addition to carbon atom(s), at least one heteroatom, such as nitrogen, oxygen, sulfur or phosphorus. Examples include, but are not limited to, tetrahydrofuranyl, pyrrolidinyl, pyrrolinyl, imidazolidinyl, imidazolinyl, pyrazolidinyl, pyrazolinyl, piperidyl, piperazinyl, indolinyl, isoindolinyl, morpholinyl, thiomorpholinyl, homomorpholinyl, homopiperidyl, homopiperazinyl, thiomorpholinyl-5-oxide, thiomorpholinyl-S,S-dioxide, pyrrolidinyl, tetrahydropyranyl, piperidinyl, tetrahydrothienyl, homopiperidinyl, homothiomorpholinyl-S,S-dioxide, oxazolidinonyl, dihydropyrazolyl, dihydropyrrolyl, dihydropyrazinyl, dihydropyridinyl, dihydropyrimidinyl, dihydrofuryl, dihydropyranyl, tetrahydrothienyl-5-oxide, tetrahydrothienyl-S,S-dioxide, homothiomorpholinyl-5-oxide, quinuclidinyl, 2-oxa-5-azabicyclo[2.2.1]heptane, 8-oxa-3-aza-bicyclo[3.2.1]octane, 3,8-diaza-bicyclo[3.2.1]octane, 2,5-diaza-bicyclo[2.2.1]heptane, 3,8-diaza-bicyclo[3.2.1]octane, 3,9-diaza-bicyclo[4.2.1]nonane, 2,6-diaza-bicyclo[3.2.2]nonane, [1,4]oxaphosphinane 4-oxide, [1,4]azaphosphinane 4-oxide, [1,2]oxaphospholane 2-oxide, phosphinane 1-oxide, [1,3]azaphospholidine 3-oxide, and [1,3]oxaphospholane 3-oxide. Preferably, the heterocycloalkyl group contains, in addition to carbon atom(s), at least one nitrogen, oxygen, or sulfur. More preferably, the heterocycloalkyl group contains, in addition to carbon atom(s), at least one nitrogen or oxygen. More preferably, the heterocycloalkyl group contains, in addition to carbon atom(s), at least one nitrogen. Preferably, the heterocycloalkyl group contains from 3 to 10 ring atoms. More preferably, the heterocycloalkyl group contains from 3 to 7 ring atoms. More preferably, the heterocycloalkyl group contains from 5 to 7 ring atoms, such as 5 ring atoms, 6 ring atoms, or 7 ring atoms. Unless otherwise indicated, the foregoing heterocycloalkyl groups can be C— attached or N-attached where such is possible and results in the creation of a stable structure. For example, piperidinyl can be piperidin-1-yl (N-attached) or piperidin-4-yl (C-attached).
“Heterocycloalkylalkyl” or “heterocycloalkylalkyl group” refers to an alkyl group in which a hydrogen atom is replaced by a heterocycloalkyl group, wherein alkyl group and heterocycloalkyl group are as previously defined (i.e., heterocycloalkylalkyl-). Heteroycloalkylalkyl groups can be substituted or unsubstituted. Examples include, but are not limited to, pyrrolidinylmethyl (C₄H₈CH₂—).
“Heteroaryl” or “heteroaryl group” refers to (a) 5 and 6 membered monocyclic aromatic rings, which contain, in addition to carbon atom(s), at least one heteroatom, such as nitrogen, oxygen or sulfur, and (b) 7-15 membered bicyclic and tricyclic rings, which contain, in addition to carbon atom(s), at least one heteroatom, such as nitrogen, oxygen or sulfur, and in which at least one of the rings is aromatic. Heteroaryl groups can be substituted or unsubstituted, and may be bridged, spiro, and/or fused. Examples include, but are not limited to, 2,3-dihydrobenzofuranyl, 1,2-dihydroquinolinyl, 3,4-dihydroisoquinolinyl, 1,2,3,4-tetrahydroisoquinolinyl, 1,2,3,4-tetrahydroquinolinyl, benzoxazinyl, benzthiazinyl, chromanyl, furanyl, 2-furanyl, 3-furanyl, imidazolyl, isoxazolyl, isothiazolyl, oxadiazolyl, oxazolyl, pyridinyl, 2-, 3-, or 4-pyridinyl, pyrimidinyl, 2-, 4-, or 5-pyrimidinyl, pyrazolyl, pyrrolyl, 2- or 3-pyrrolyl, pyrazinyl, pyridazinyl, 3- or 4-pyridazinyl, 2-pyrazinyl, thienyl, 2-thienyl, 3-thienyl, tetrazolyl, thiazolyl, thiadiazolyl, triazinyl, triazolyl, pyridin-2-yl, pyridin-4-yl, pyrimidin-2-yl, pyridazin-4-yl, pyrazin-2-yl, naphthyridinyl, pteridinyl, phthalazinyl, purinyl, alloxazinyl, benzimidazolyl, benzofuranyl, benzofurazanyl, 2H-1-benzopyranyl, benzothiadiazine, benzothiazinyl, benzothiazolyl, benzothiophenyl, benzoxazolyl, cinnolinyl, furopyridinyl, indolinyl, indolizinyl, indolyl, or 2-, 3-, 4-, 5-, 6-, or 7-indolyl, 3H-indolyl, quinazolinyl, quinoxalinyl, isoindolyl, isoquinolinyl, 10-aza-tricyclo[6.3.1.0*2,7*]dodeca-2(7),3,5-trienyl, 12-oxa-10-aza-tricyclo[6.3.1.0*2,7*]dodeca-2(7),3,5-trienyl, 12-aza-tricyclo[7.2.1.0*2,7*]dodeca-2(7),3,5-trienyl, 10-aza-tricyclo[6.3.2.0*2,7*]trideca-2(7),3,5-trienyl, 2,3,4,5-tetrahydro-1H-benzo[d]azepinyl, 1,3,4,5-tetrahydro-benzo[d]azepin-2-onyl, 1,3,4,5-tetrahydro-benzo[b]azepin-2-onyl, 2,3,4,5-tetrahydro-benzo[c]azepin-1-onyl, 1,2,3,4-tetrahydro-benzo[e][1,4]diazepin-5-onyl, 2,3,4,5-tetrahydro-1H-benzo[e][1,4]diazepinyl, 5,6,8,9-tetrahydro-7-oxa-benzocycloheptenyl, 2,3,4,5-tetrahydro-1H-benzo[b]azepinyl, 1,2,4,5-tetrahydro-benzo[e][1,3]diazepin-3-onyl, 3,4-dihydro-2H-benzo[b][1,4]dioxepinyl, 3,4-dihydro-2H-benzo[f][1,4]oxazepin-5-onyl, 6,7,8,9-tetrahydro-5-thia-8-aza-benzocycloheptenyl, 5,5-dioxo-6,7,8,9-tetrahydro-5-thia-8-aza-benzocycloheptenyl, and 2,3,4,5-tetrahydro-benzo[f][1,4]oxazepinyl. Preferably, the heteroaryl group contains 5, 6, or 8-15 ring atoms. More preferably, the heteroaryl group contains 5 to 10 ring atoms, such as 5, 6, 9, or 10 ring atoms.
“Heteroarylalkyl” or “heteroarylalkyl group” refers to an alkyl group in which a hydrogen atom is replaced by a heteroaryl group, wherein alkyl group and heteroaryl group are as previously defined (i.e., heteroarylalkyl-). Heteroarylalkyl groups can be substituted or unsubstituted. Examples include, but are not limited to, the pyridinylmethyl isomers

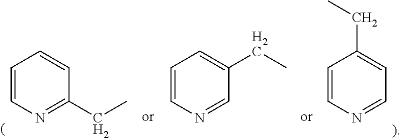

“Substituted” refers to a derivative of a compound or chemical group in which a hydrogen atom is replaced by another atom or group. An example of substituted benzene is bromobenzene. An example of a substituted bromobenzene is 2-bromophenol. When lists of alternative substituents include members which, owing to valency requirements, chemical stability, or other reasons, cannot be used to substitute a particular group, the list is intended to be read in context to include those members of the list that are suitable for substituting the particular group. When a compound or chemical group herein is “substituted” it may have up to the full valance of substitution, provided the resulting compound or chemical group is a stable compound or stable chemical group; for example, a methyl group may be substituted by 1, 2, or 3 substituents, an ethyl group may be substituted by 1, 2, 3, 4, or 5 substituents, a phenyl group may be substituted by 1, 2, 3, 4, or 5 substituents, and the like. Atoms and groups with which a compound or chemical group may be substituted include, but are not limited to, halogen, nitro, hydroxy, alkoxy, aryloxy, carbonyl, hydroxycarbonyl, alkoxycarbonyl, aminocarbonyl, alkylaminocarbonyl, amino, alkylamino, alkyl, alkoxyalkyl, aminoalkyl, haloalkyl, alkenyl, alkynyl, aryl, arylalkyl, heteroaryl, heteroarylalkyl, cycloalkyl, cycloalkylalkyl, heterocycloalkyl, heterocycloalkylalkyl, pseudohalogen, alkylthio, sulfonyl, alkylsulfonyl, alkylaminosulfonyl, alkylcarbonyloxy, aminocarbonyloxy, alkylaminocarbonyloxy, alkylcarbonylamino, alkoxycarbonylamino, alkylsulfonylamino, aminocarbonylamino, and alkylaminocarbonylamino. Further examples of atoms and groups with which a compound or chemical group may be substituted include, but are not limited to, C₁₋₆alkyl optionally substituted by 1-13 R⁴⁹, C₂₋₆alkenyl optionally substituted by 1-11 R⁴⁹, C₂₋₆alkynyl optionally substituted by 1-9 R⁴⁹, C₆₋₁₁aryl optionally substituted by 1-11 R⁴⁹, C₇₋₁₆arylalkyl optionally substituted by 1-19 R⁴⁹, C₃₋₁₁cycloalkyl optionally substituted by 1-21 R⁴⁹, C₄₋₁₇cycloalkylalkyl optionally substituted by 1-32 R⁴⁹, 3-15 membered heterocycloalkyl optionally substituted by 1-28 R⁴⁹, 4-21 membered heterocycloalkylalkyl optionally substituted by 1-40 R⁴⁹, 5-15 membered heteroaryl optionally substituted by 1-15 R⁴⁹, 6-21 membered heteroarylalkyl optionally substituted by 1-27 R⁴⁹, halogen, —CN, —C(═O)R¹⁰⁰, —C(═O)OR¹⁰⁰, —C(═O)NR¹⁰²R¹⁰³, —C(═O)C(═O)R¹⁰⁰, —C(═NR¹⁰⁵)R¹⁰⁰, —C(═NR¹⁰⁵)NR¹⁰²R¹³, —C(═NOH)NR¹⁰²R¹⁰³, —C(═NOR¹⁰⁶)R¹⁰⁰, —C(═NNR¹⁰²R¹⁰³)R¹⁰⁰, —C(═NNR¹⁰⁴C(═O)R¹⁰¹)R¹⁰⁰, —C(═NNR¹⁰⁴C(═O)OR¹⁰¹)R¹⁰⁰, —C(═S)NR¹⁰²R¹⁰³, —NC, —NO₂, —NR¹⁰²R¹⁰³, —NR¹⁰⁴NR¹⁰²R¹⁰³, —N═NR¹⁰⁴, ═NR¹⁰⁰, ═NOR¹⁰⁰, —NR¹⁰⁴OR¹⁰⁶, —NR¹⁰⁴C(═O)R¹⁰⁰, —NR¹⁰⁴C(═O)C(═O)R¹⁰⁰, —NR¹⁰⁴C(═O)OR¹⁰¹¹, —NR¹⁰⁴C(═O)C(═O)OR¹⁰¹, —NR¹⁰⁴C(═O)NR¹⁰²R¹⁰³, —NR¹⁰⁴C(═O)NR¹⁰⁴C(═O)R¹⁰⁰, —NR¹⁰⁴C(═O)NR¹⁰⁴C(═O)OR¹⁰¹, —NR¹⁰⁴C(═NR¹⁰⁵)NR¹⁰²R¹⁰³, —NR¹⁰⁴C(═O)C(═O)NR¹⁰²R¹⁰³, —NR¹⁰⁴C(═S)R¹⁰⁰, —NR¹⁰⁴C(═S)OR¹⁰⁰, —NR¹⁰⁴C(═S)NR¹⁰²R¹⁰³, —NR¹⁰⁴S(═O)₂R¹⁰¹, —NR¹⁰⁴S(═O)₂NR¹⁰²R¹⁰³, —NR¹⁰⁴P(═O)R¹⁰⁸R¹⁰⁸, —NR¹⁰⁴P(═O)(NR¹⁰²R¹⁰³)(NR¹⁰²R¹⁰³), —NR¹⁰⁴P(═O)(OR¹⁰⁰)(OR¹⁰⁰), —NR¹⁰⁴P(═O)(SR¹⁰⁰)(SR¹⁰⁰), —OR¹⁰⁰, ═O, —OCN, —OC(═O)R¹⁰⁰, —OC(═O)NR¹⁰²R¹⁰³, —OC(═O)OR¹⁰⁰, —OC(═NR¹⁰⁵)NR¹⁰²R¹⁰³, —OS(═O)R¹⁰⁰, —OS(═O)₂R¹⁰⁰, —OS(═O)₂OR¹⁰⁰, —OS(═O)₂NR¹⁰²R¹⁰³, —OP(═O)R¹⁰⁸R¹⁰⁸, —OP(═O)(NR¹⁰²R¹⁰³)(NR¹⁰²R¹⁰³), —OP(═O)(OR¹⁰⁰)(OR¹⁰⁰), —OP(═O)(SR¹⁰⁰)(SR¹⁰⁰), —SCN, ═S, —S(═O)ₙR¹⁰⁰, —S(═O)₂OR¹⁰⁰, —SO₃R¹⁰⁷, —S(═O)₂NR¹⁰²R¹⁰³, —S(═O)NR¹⁰²R¹⁰³, —SP(═O)R¹⁰⁸R¹⁰⁸, —SP(═O)(NR¹⁰²R¹⁰³)(NR¹⁰²R¹⁰³), —SP(═O)(OR¹⁰⁰)(OR¹⁰⁰), —SP(═O)(SR¹⁰⁰)(SR¹⁰⁰), —P(═O)R¹⁰⁸R¹⁰⁸, —P(═O)(NR¹⁰²R¹⁰³)(NR¹⁰²R¹⁰³), —P(═O)(OR¹⁰⁰)(OR¹⁰⁰), or —P(═O)(SR¹⁰⁰)(SR¹⁰⁰); wherein
   R⁴⁹ at each occurrence is independently chosen from C₁₋₆alkyl optionally substituted by 1-13 R¹⁷⁹, C₂₋₆alkenyl optionally substituted by 1-11 R¹⁷⁹, C₂₋₆alkynyl optionally substituted by 1-9 R¹⁷⁹, C₆₋₁₁aryl optionally substituted by 1-11 R¹⁷⁹, C₇₋₁₆arylalkyl optionally substituted by 1-19 R¹⁷⁹, C₃₋₁₁cycloalkyl optionally substituted by 1-21 R¹⁷⁹, C₄₋₁₇cycloalkylalkyl optionally substituted by 1-32 R¹⁷⁹, 3-15 membered heterocycloalkyl optionally substituted by 1-28 R¹⁷⁹, 4-21 membered heterocycloalkylalkyl optionally substituted by 1-40 R¹⁷⁹, 5-15 membered heteroaryl optionally substituted by 1-15 R¹⁷⁹, 6-21 membered heteroarylalkyl optionally substituted by 1-27 R¹⁷⁹, halogen, —CN, —C(═O)R¹⁷⁰, —C(═O)OR¹⁷⁰, —C(═O)NR¹⁷²R¹⁷³, —C(═O)C(═O)R¹⁷⁰, —C(═NR¹⁷⁵)R¹⁷⁰, —C(═NR¹⁷⁵)NR¹⁷²R¹⁷³, —C(═NOH)NR¹⁷²R¹⁷³, —C(═NOR¹⁷⁶)R¹⁷⁰, —C(═NNR¹⁷²R¹⁷³)R¹⁷⁰, —C(═NNR¹⁷⁴C(═O)R¹⁷¹)R¹⁷⁰, —C(═NNR¹⁷⁴C(═O)OR¹⁷¹)R¹⁷⁰, —C(═S)NR¹⁷²R¹⁷³, —NC, —NO₂, —NR¹⁷²R¹⁷³, —NR¹⁷⁴NR¹⁷²R¹⁷³, —N═NR¹⁷⁴, ═NR¹⁷⁰, ═NOR¹⁷⁰, —NR¹⁷⁴OR¹⁷⁶, —NR¹⁷⁴C(═O)R¹⁷⁰, —NR¹⁷⁴C(═O)C(═O)R¹⁷⁰, —NR¹⁷⁴C(═O)OR¹⁷¹, —NR¹⁷⁴C(═O)C(═O)OR¹⁷¹, —NR¹⁷⁴C(═O)NR¹⁷²R¹⁷³, —NR¹⁷⁴C(═O)NR¹⁷⁴C(═O)R¹⁷⁰, —NR¹⁷⁴C(═O)NR¹⁷⁴C(═O)OR¹⁷⁰, —NR¹⁷⁴C(═NR¹⁷⁵)NR¹⁷²R¹⁷³, —NR¹⁷⁴C(═O)C(═O)NR¹⁷²R¹⁷³, —NR¹⁷⁴C(═S)R¹⁷⁰, —NR¹⁷⁴C(═S)OR¹⁷⁰, —NR¹⁷⁴C(═S)NR¹⁷²R¹⁷³, —NR¹⁷⁴S(═O)₂R¹⁷¹, —NR¹⁷⁴S(═O)₂NR¹⁷²R¹⁷³, —NR¹⁷⁴P(═O)R¹⁷⁸R¹⁷⁸, —NR¹⁷⁴P(═O)(NR¹⁷²R¹⁷³)(NR¹⁷²R¹⁷³), —NR¹⁷⁴P(═O)(OR¹⁷⁰)(OR¹⁷⁰), —NR¹⁷⁴P(═O)(SR¹⁷⁰)(SR¹⁷⁰), —OR¹⁷⁰, ═O, —OCN, —OC(═O)R¹⁷⁰, —OC(═O)NR¹⁷²R¹⁷³, —OC(═O)OR¹⁷⁰, —OC(═NR¹⁷⁵)NR¹⁷²R¹⁷³, —OS(═O)R¹⁷⁸R¹⁷⁸, —OS(═O)₂R¹⁷⁰, —OS(═O)₂OR¹⁷⁰, —OS(═O)₂NR¹⁷²R¹⁷³, —OP(═O)R¹⁷⁸R¹⁷⁸, —OP(═O)(NR¹⁷²R¹⁷³)(NR¹⁷²R¹⁷³), —OP(═O)(OR¹⁷⁰)(OR¹⁷), —OP(═O)(SR¹⁷⁰)(SR¹⁷⁰), —SCN, ═S, —S(═O)ₙR¹⁷⁰, —S(═O)₂OR¹⁷⁰, —SO₃R¹⁷⁷, —S(═O)₂NR¹⁷²R¹⁷³, —S(═O)NR¹⁷²R¹⁷³, —SP(═O)R¹⁷⁸R¹⁷⁸, —SP(═O)(NR¹⁷²R¹⁷³)(NR¹⁷²R¹⁷³), —SP(═O)(OR¹⁷⁰)(OR¹⁷⁰), —SP(═O)(SR¹⁷⁰)(SR¹⁷⁰), —P(═O)R¹⁷⁸R¹⁷⁸, —P(═O)(NR¹⁷²R¹⁷³)(NR¹⁷²R¹⁷³), —P(═O)(OR¹⁷⁰)(OR¹⁷⁰), and —P(═O)(SR¹⁷⁰)(SR¹⁷⁰);
   R¹⁰⁰, R¹⁰¹, R¹⁰⁴, R¹⁰⁵, R¹⁰⁶, R¹⁰⁷, R¹⁷⁰, R¹⁷¹, R¹⁷⁴, R¹⁷⁵, R¹⁷⁶ and R¹⁷⁷ at each occurrence is independently chosen from H, C₁₋₆alkyl optionally substituted by 1-13 R¹⁸⁹, C₂₋₆alkenyl optionally substituted by 1-11 R¹⁸⁹, C₂₋₆alkynyl optionally substituted by 1-9 R¹⁸⁹, C₆₋₁₁aryl optionally substituted by 1-11 R¹⁸⁹, C₇₋₁₆arylalkyl optionally substituted by 1-19 R¹⁸⁹, C₃₋₁₁cycloalkyl optionally substituted by 1-21 R¹⁸⁹, C₄₋₁₇cycloalkylalkyl optionally substituted by 1-32 R¹⁸⁹, 3-15 membered heterocycloalkyl optionally substituted by 1-28 R¹⁸⁹, 4-21 membered heterocycloalkylalkyl optionally substituted by 1-40 R¹⁸⁹, 5-15 membered heteroaryl optionally substituted by 1-15 R¹⁸⁹, and 6-21 membered heteroarylalkyl optionally substituted by 1-27 R¹⁸⁹;
   R¹⁰⁸ and R¹⁷⁸ at each occurrence is independently chosen from C₁₋₆alkyl optionally substituted by 1-13 R¹⁸⁹, C₂₋₆alkenyl optionally substituted by 1-11 R¹⁸⁹, C₂₋₆alkynyl optionally substituted by 1-9 R¹⁸⁹, C₆₋₁₁aryl optionally substituted by 1-11 R¹⁸⁹, C₇₋₁₆arylalkyl optionally substituted by 1-19 R¹⁸⁹, C₃₋₁₁cycloalkyl optionally substituted by 1-21 R¹⁸⁹, C₄₋₁₇cycloalkylalkyl optionally substituted by 1-32 R¹⁸⁹, 3-15 membered heterocycloalkyl optionally substituted by 1-28 R¹⁸⁹, 4-21 membered heterocycloalkylalkyl optionally substituted by 1-40 R¹⁸⁹, 5-15 membered heteroaryl optionally substituted by 1-15 R¹⁸⁹, and 6-21 membered heteroarylalkyl optionally substituted by 1-27 R¹⁸⁹;
   R¹⁰², R¹⁰³, R¹⁷² and R¹⁷³ at each occurrence is independently chosen from H, C₁₋₆alkyl optionally substituted by 1-13 R¹⁹⁹, C₂₋₆alkenyl optionally substituted by 1-11 R¹⁹⁹, C₂₋₆alkynyl optionally substituted by 1-9 R¹⁹⁹, C₆₋₁₁aryl optionally substituted by 1-11 R¹⁹⁹, C₇₋₁₆arylalkyl optionally substituted by 1-19 R¹⁹⁹, C₃₋₁₁cycloalkyl optionally substituted by 1-21 R¹⁹⁹, C₄₋₁₇cycloalkylalkyl optionally substituted by 1-32 R¹⁹⁹, 3-15 membered heterocycloalkyl optionally substituted by 1-28 R¹⁹⁹, 4-21 membered heterocycloalkylalkyl optionally substituted by 1-40 R¹⁹⁹, 5-15 membered heteroaryl optionally substituted by 1-15 R¹⁹⁹, and 6-21 membered heteroarylalkyl optionally substituted by 1-27 R¹⁹⁹;
   or any R¹⁰² and R¹⁰³, or R¹⁷² and R¹⁷³ may form, together with the nitrogen atom to which they are attached, a 3-15 membered heterocycloalkyl optionally substituted by 1-28 R²⁰⁹ or a 5-15 membered heteroaryl optionally substituted by 1-15 R²⁰⁹;
   R¹⁷⁹, R¹⁸⁹, R¹⁹⁹ and R²⁰⁹ at each occurrence is independently chosen from C₁₋₆alkyl optionally substituted by 1-13 R²¹⁹, C₂₋₆alkenyl optionally substituted by 1-11 R²¹⁹, C₂₋₆alkynyl optionally substituted by 1-9 R²¹⁹, C₆₋₁₁aryl optionally substituted by 1-11 R²¹⁹, C₇₋₁₆arylalkyl optionally substituted by 1-19 R²¹⁹, C₃₋₁₁cycloalkyl optionally substituted by 1-21 R²¹⁹, C₄₋₁₇cycloalkylalkyl optionally substituted by 1-32 R²¹⁹, 3-15 membered heterocycloalkyl optionally substituted by 1-28 R²¹⁹, 4-21 membered heterocycloalkylalkyl optionally substituted by 1-40 R²¹⁹, 5-15 membered heteroaryl optionally substituted by 1-15 R²¹⁹, 6-21 membered heteroarylalkyl optionally substituted by 1-27 R²¹⁹, halogen, —CN, —C(═O)R²¹⁰, —C(═O)OR²¹, —C(═O)NR²¹²R²¹³, —C(═O)C(═O)R²¹⁰, —C(═NR²¹⁵)R²¹⁰, —C(═NR²¹⁵)NR²¹²R²¹³, C(═NOH)NR²¹²R²¹³, —C(═NOR²¹⁶)R²¹⁰, —C(═NNR²¹²R²¹³)R²¹⁰, —C(═NNR²¹⁴C(═O)R²¹¹)R²¹⁰, —C(═NNR²¹⁴C(═O)OR²¹¹)R²¹⁰, —C(═S)NR²¹²R²¹³, —NC, —NO₂, —NR²¹²R²¹³, —NR²¹⁴NR²¹²R²¹³, —N═NR²¹⁴, ═NR²¹⁰, ═NOR²¹⁰, —NR²¹⁴OR²¹⁶, —NR²¹⁴C(═O)R²¹⁰, —NR²¹⁴C(═O)C(═O)R²¹⁰, —NR²¹⁴C(═O)OR²¹¹, —NR²¹⁴C(═O)C(═O)OR²¹¹, —NR²¹⁴C(═O)NR²¹²R²¹³, —NR²¹⁴C(═O)NR²⁴C(═O)R²¹⁰, —NR²¹⁴C(═O)NR²¹⁴C(═O)OR²¹⁰, —NR²¹⁴C(═NR²¹⁵)NR²¹²R²¹³, —NR²¹⁴C(═O)C(═O)NR²¹²R²¹³, —NR²¹⁴C(═S)R²¹⁰, —NR²¹⁴C(═S)OR²¹⁰, —NR²¹⁴C(═S)NR²¹²R²¹³, —NR²¹⁴S(═O)₂R²¹¹, —NR²¹⁴S(═O)₂NR²¹²R²¹³, —NR²¹⁴P(═O)R²¹⁸R²¹⁸, —NR²¹⁴P(═O)(NR²¹²R²¹³)(NR²¹²R²¹³), —NR²¹⁴P(═O)(OR²¹⁰)(OR²¹⁰), —NR²¹⁴P(═O)(SR²¹⁰)(SR²¹⁰), —OR²¹⁰, ═O, —OCN, —OC(═O)R²¹⁰, —OC(═O)NR²¹²R²¹³, —OC(═O)OR²¹⁰, —OC(═NR²¹⁵)NR²¹²R²¹³, —OS(═O)R²¹⁰, —OS(═O)₂R²¹, —OS(═O)₂OR²¹⁰, —OS(═O)₂NR²¹²R²¹³, —OP(═O)R²¹⁸R²¹⁸, —OP(═O)(NR²¹²R²¹³)(NR²¹²R²¹³), —OP(═O)(OR²¹⁰)(OR²¹⁰), —OP(═O)(SR²¹⁰)(SR²¹⁰), —SCN, ═S, —S(═O)ₙR²¹⁰, —S(═O)₂OR²¹⁰, —SO₃R²¹⁷, —S(═O)₂NR²¹²R²¹³, —S(═O)NR²¹²R²¹³, —SP(═O)R²¹⁸R²¹⁸, —SP(═O)(NR²¹²R²¹³)(NR²¹²R²¹³), —SP(═O)(OR²¹⁰)(OR²¹⁰), —SP(═O)(SR²¹⁰)(SR²¹⁰), —P(═O)R²¹⁸R²¹⁸, —P(═O)(NR²¹²R²¹³)(NR²¹²R²¹³), —P(═O)(OR²¹⁰)(OR²¹⁰), and —P(═O)(SR²¹⁰)(SR²¹⁰);
   R²¹⁰, R²¹¹, R²¹⁴, R²¹⁵, R²¹⁶ and R²¹⁷ at each occurrence is independently chosen from H, C₁₋₆alkyl optionally substituted by 1-13 R²²⁹, C₂₋₆alkenyl optionally substituted by 1-11 R²²⁹, C₂₋₆alkynyl optionally substituted by 1-9 R²²⁹, C₆₋₁₁aryl optionally substituted by 1-11 R²²⁹, C₇₋₁₆arylalkyl optionally substituted by 1-19 R²²⁹, C₃₋₁₁cycloalkyl optionally substituted by 1-21 R²²⁹, C₄₋₁₇cycloalkylalkyl optionally substituted by 1-32 R²²⁹, 3-15 membered heterocycloalkyl optionally substituted by 1-28 R²²⁹, 4-21 membered heterocycloalkylalkyl optionally substituted by 1-40 R²²⁹, 5-15 membered heteroaryl optionally substituted by 1-15 R²²⁹, and 6-21 membered heteroarylalkyl optionally substituted by 1-27 R²²⁹;
   R²¹⁸ at each occurrence is independently chosen from C₁₋₆alkyl optionally substituted by 1-13 R²²⁹, C₂₋₆alkenyl optionally substituted by 1-11 R²²⁹, C₂₋₆alkynyl optionally substituted by 1-9 R²²⁹, C₆₋₁₁aryl optionally substituted by 1-11 R²²⁹, C₇₋₁₆arylalkyl optionally substituted by 1-19 R²²⁹, C₃₋₁₁cycloalkyl optionally substituted by 1-21 R²²⁹, C₄₋₁₇cycloalkylalkyl optionally substituted by 1-32 R²²⁹, 3-15 membered heterocycloalkyl optionally substituted by 1-28 R²²⁹, 4-21 membered heterocycloalkylalkyl optionally substituted by 1-40 R²²⁹, 5-15 membered heteroaryl optionally substituted by 1-15 R²²⁹, and 6-21 membered heteroarylalkyl optionally substituted by 1-27 R²²⁹;
   R²¹² and R²¹³ at each occurrence is independently chosen from H, C₁₋₆alkyl optionally substituted by 1-13 R²³⁹, C₂₋₆alkenyl optionally substituted by 1-11 R²³⁹, C₂₋₆alkynyl optionally substituted by 1-9 R²³⁹, C₆₋₁₁aryl optionally substituted by 1-11 R²³⁹, C₇₋₁₆arylalkyl optionally substituted by 1-19 R²³⁹, C₃₋₁₁cycloalkyl optionally substituted by 1-21 R²³⁹, C₄₋₁₇cycloalkylalkyl optionally substituted by 1-32 R²³⁹, 3-15 membered heterocycloalkyl optionally substituted by 1-28 R²³⁹, 4-21 membered heterocycloalkylalkyl optionally substituted by 1-40 R²³⁹, 5-15 membered heteroaryl optionally substituted by 1-15 R²³⁹, and 6-21 membered heteroarylalkyl optionally substituted by 1-27 R²³⁹;
   or any R²¹² and R²¹³ may form, together with the nitrogen atom to which they are attached, a 3-15 membered heterocycloalkyl optionally substituted by 1-28 R²⁴⁹ or a 5-15 membered heteroaryl optionally substituted by 1-15 R²⁴⁹;
   R²¹⁹, R²²⁹, R²³⁹ and R²⁴⁹ at each occurrence is independently chosen from C₁₋₆alkyl optionally substituted by 1-13 halogen, C₂₋₆alkenyl, C₂₋₆alkynyl, C₆₋₁₁aryl, C₇₋₁₆arylalkyl, C₃₋₁₁cycloalkyl, C₄₋₁₇cycloalkylalkyl, 3-15 membered heterocycloalkyl, 4-21 membered heterocycloalkylalkyl, 5-15 membered heteroaryl, 6-21 membered heteroarylalkyl, halogen, —CN, —C(═O)R²⁵⁰, —C(═O)OR²⁵⁰, —C(═O)NR²⁵⁰R²⁵⁰, —C(═O)C(═O)R²⁵⁰, —C(═NR²⁵⁰)R²⁵⁰, —C(═NR²⁵⁰)NR²⁵⁰R²⁵⁰, —C(═NOH)NR²⁵⁰R²⁵⁰, —C(═NOR²⁵⁰)R²⁵⁰, —C(═NNR²⁵⁰R²⁵⁰)R²⁵⁰, —C(═NNR²⁵⁰C(═O)R²⁵⁰)R²⁵⁰, —C(═NNR²⁵⁰C(═O)OR²⁵⁰)R²⁵⁰, —C(═S)NR²⁵⁰R²⁵⁰, —NC, —NO₂, —NR²⁵⁰R²⁵⁰, —NR²⁵⁰NR²⁵⁰R²⁵⁰, —N═NR²⁵⁰, ═NR²⁵⁰, ═NOR²⁵⁰, —NR²⁵⁰OR²⁵⁰, —NR²⁵⁰C(═O)R²⁵⁰, —NR²⁵⁰C(═O)C(═O)R²⁵⁰, —NR²⁵⁰C(═O)OR²⁵⁰, —NR²⁵⁰C(═O)O)C(═O)OR²⁵⁰, —NR²⁵⁰C(═O)NR²⁵⁰R²⁵⁰, —NR²⁵⁰C(═O)NR²⁵⁰C(═O)R²⁵⁰, —NR²⁵⁰C(═O)NR²⁵⁰C(═O)OR²⁵⁰, —NR²⁵⁰C(═NR²⁵⁰)NR²⁵⁰R²⁵⁰, —NR²⁵⁰C(═O)C(═O)NR²⁵⁰R²⁵, —NR²⁵⁰C(═S)R²⁵⁰, —NR²⁵⁰C(═S)OR²⁵⁰, —NR²⁵⁰C(═S)NR²⁵⁰R²⁵⁰, —NR²⁵⁰S(═O)₂R²⁵⁰, —NR²⁵⁰S(═O)₂NR²⁵⁰R²⁵⁰, —NR²⁵⁰P(═O)R²⁵¹R²⁵¹, —NR²⁵⁰P(═O)(NR²⁵⁰R²⁵⁰)(NR²⁵⁰R²⁵), —NR²⁵⁰P(═O)(OR²⁵⁰)(OR²⁵⁰), —NR²⁵⁰P(═O)(SR²⁵⁰)(SR²⁵⁰), —OR²⁵⁰, ═O, —OCN, —OC(═O)R²⁵⁰, —OC(═O)NR²⁵⁰R²⁵⁰, —OC(═O)OR²⁵⁰, —OC(═NR²⁵⁰)NR²⁵⁰R²⁵⁰R²⁵⁰, —OS(═O)R²⁵⁰, —OS(═O)₂R²⁵⁰, —OS(═O)₂OR²⁵⁰, —OS(═O)₂NR²⁵⁰R²⁵⁰, —OP(═O)R²⁵¹R²⁵¹, —OP(═O)(NR²⁵⁰R²⁵⁰)(NR²⁵⁰R²⁵⁰), —OP(═O)(OR²⁵⁰)(OR²⁵⁰), —OP(═O)(SR²⁵)(SR²⁵⁰), —SCN, ═S, —S(═O)ₙR²⁵⁰, —S(═O)₂OR²⁵⁰, —SO₃R²⁵⁰, —S(═O)₂NR²⁵⁰R²⁵⁰, —S(═O)NR²⁵⁰R²⁵⁰, —SP(═O)R²⁵¹R²⁵¹, —SP(═O)(NR²⁵⁰R²⁵⁰)(NR²⁵⁰R²⁵⁰), —SP(═O)(OR²⁵⁰)(OR²⁵⁰), —SP(═O)(SR²⁵⁰)(SR²⁵⁰), —P(═O)R²⁵¹R²⁵¹, —P(═O)(NR²⁵⁰R²⁵⁰)(NR²⁵⁰R²⁵), —P(═O)(OR²⁵⁰)(OR²⁵⁰), and —P(═O)(SR²⁵⁰)(SR²⁵⁰);
   R²⁵⁰ at each occurrence is independently chosen from H, C₁₋₆alkyl and C₁₋₆-haloalkyl;
   R²⁵¹ at each occurrence is independently chosen from C₁₋₆alkyl and C₁₋₆-haloalkyl; and
   n at each occurrence is independently chosen from 0, 1, and 2. Further examples of atoms and groups with which a compound or chemical group may be substituted include, but are not limited to, C₁₋₆alkyl optionally substituted by 1-5 R⁴⁹, C₂₋₆alkenyl optionally substituted by 1-5 R⁴⁹, C₂₋₆alkynyl optionally substituted by 1-5 R⁴⁹, C₆₋₁₁aryl optionally substituted by 1-5 R⁴⁹, C₇₋₁₆arylalkyl optionally substituted by 1-5 R⁴⁹, C₃₋₁₁cycloalkyl optionally substituted by 1-5 R⁴⁹, C₄₋₁₇cycloalkylalkyl optionally substituted by 1-5 R⁴⁹, 3-15 membered heterocycloalkyl optionally substituted by 1-5 R⁴⁹, 4-21 membered heterocycloalkylalkyl optionally substituted by 1-5 R⁴⁹, 5-15 membered heteroaryl optionally substituted by 1-5 R⁴⁹, 6-21 membered heteroarylalkyl optionally substituted by 1-5 R⁴⁹, halogen, —CN, —C(═O)R¹⁰⁰, —C(═O)OR¹⁰⁰, —C(═O)NR¹⁰²R¹⁰³, —NC, —NO₂, —NR¹⁰²R¹⁰³, —NR¹⁰⁴OR¹⁰⁶, —NR¹⁰⁴C(═O)R¹⁰⁰, —NR¹⁰⁴C(═O)OR¹⁰¹, —NR¹⁰⁴C(═O)NR¹⁰²R¹⁰³, —NR¹⁰⁴S(═O)₂R¹⁰¹, —NR¹⁰⁴S(═O)₂NR¹⁰²R¹⁰³, —OR¹⁰⁰, ═O, —OC(═O)R¹⁰⁰, —OC(═O)NR¹⁰²R¹⁰³, —S(═O)ₙR¹⁰⁰, or —S(═O)₂NR¹⁰²R¹⁰³; wherein
   R⁴⁹ at each occurrence is independently chosen from C₁₋₆alkyl, C₁₋₆haloalkyl, C₂₋₆alkenyl, C₂₋₆alkynyl, C₆₋₁₁aryl, C₇₋₁₆arylalkyl, C₃₋₁₁cycloalkyl, C₄₋₁₇cycloalkylalkyl, 3-15 membered heterocycloalkyl, 4-21 membered heterocycloalkylalkyl, 5-15 membered heteroaryl, 6-21 membered heteroarylalkyl, halogen, —CN, —C(═O)R¹⁷⁰, —C(═O)OR¹⁷⁰, —C(═O)NR¹⁷²R¹⁷³, —NC, —NO₂, —NR¹⁷²R¹⁷³, —NR¹⁷⁴C(═O)R¹⁷⁰, —NR¹⁷⁴C(═O)OR¹⁷¹, —NR¹⁷⁴C(═O)NR¹⁷²R¹⁷³, —NR¹⁷⁴S(═O)₂R¹⁷¹, —NR¹⁷⁴S(═O)₂NR¹⁷²R¹⁷³, —OR¹⁷⁰, ═O, —OC(═O)R¹⁷⁰, —OC(═O)NR¹⁷²R¹⁷³, —SCN, ═S, —S(═O)ₙR¹⁷⁰, and —S(═O)₂NR¹⁷²R¹⁷³;
   R¹⁰⁰, R¹⁰¹, R¹⁰², R¹⁰³, R¹⁰⁴, R¹⁰⁶, R¹⁷⁰, R¹⁷¹, R¹⁷², R¹⁷³, and R¹⁷⁴ at each occurrence is independently chosen from H, C₁₋₆alkyl, and C₁₋₆haloalkyl;
   or any R¹⁰² and R¹⁰³, or R¹⁷² and R¹⁷³ may form, together with the nitrogen atom to which they are attached, a 3-15 membered heterocycloalkyl or a 5-15 membered heteroaryl; and
   n at each occurrence is independently chosen from 0, 1, and 2. Further examples of atoms and groups with which a compound or chemical group may be substituted include, but are not limited to, C₁₋₆alkyl optionally substituted by 1-5 R⁴⁹, C₆₋₁₁ aryl optionally substituted by 1-5 R⁴⁹, C₃₋₁₁cycloalkyl optionally substituted by 1-5 R⁴⁹, 3-15 membered heterocycloalkyl optionally substituted by 1-5 R⁴⁹, 5-15 membered heteroaryl optionally substituted by 1-5 R⁴⁹, halogen, —CN, —C(═O)R¹⁰⁰, —C(═O)OR¹⁰⁰, —C(═O)NR¹⁰²R¹⁰³, —NO₂, —NR¹⁰²R¹⁰³, —NR¹⁰⁴C(═O)R¹⁰⁰, —NR¹⁰⁴C(═O)OR¹⁰¹, —NR¹⁰⁴C(═O)NR¹⁰²R¹⁰³, —NR¹⁰⁴S(═O)₂R¹⁰¹, —NR¹⁰⁴S(═O)₂NR¹⁰²R¹⁰³, —OR¹⁰⁰, ═O, —OC(═O)R¹⁰⁰, —OC(═O)NR¹⁰²R¹⁰³, —S(═O)ₙR¹⁰⁰, or —S(═O)₂NR¹⁰²R¹⁰³; wherein
   R⁴⁹ at each occurrence is independently chosen from C₁₋₆alkyl, C₁₋₆haloalkyl, C₆₋₁₁aryl, C₇₋₁₆arylalkyl, C₃₋₁₁cycloalkyl, 3-15 membered heterocycloalkyl, 5-15 membered heteroaryl, halogen, —CN, —C(═O)R¹⁷⁰, —C(═O)OR¹⁷⁰, —C(═O)NR¹⁷²R¹⁷³, —NO₂, —NR¹⁷²R¹⁷³, —NR¹⁷⁴C(═O)R⁷⁰, —NR¹⁷⁴C(═O)OR¹⁷¹, —NR¹⁷⁴C(═O)NR¹⁷²R¹⁷³, —NR¹⁷⁴S(═O)₂R¹⁷¹, —NR¹⁷⁴S(═O)₂NR¹⁷²R¹⁷³, —OR¹⁷⁰, ═O, —OC(═O)R¹⁷⁰, —OC(═O)NR¹⁷²R¹⁷³, —S(═O)ₙR¹⁷⁰, and —S(═O)₂NR¹⁷²R¹⁷³; R¹⁰⁰, R¹⁰¹, R¹⁰², R¹⁰³, R¹⁰⁴, R¹⁷⁰, R¹⁷¹, R¹⁷², R¹⁷³, and R¹⁷⁴ at each occurrence is independently chosen from H, C₁₋₆alkyl, and C₁₋₆haloalkyl;
   or any R¹⁰² and R¹⁰³, or R¹⁷² and R¹⁷³ may form, together with the nitrogen atom to which they are attached, a 3-6 membered heterocycloalkyl or a 5-10 membered heteroaryl; and
   n at each occurrence is independently chosen from 0, 1, and 2. Further examples of atoms and groups with which a compound or chemical group may be substituted include, but are not limited to, C₁₋₆alkyl optionally substituted by 1-5 R⁴⁹, halogen, —CN, —C(═O)R¹⁰⁰, —C(═O)OR¹⁰⁰, —C(═O)NR¹⁰²R¹⁰³, —NO₂, —NR¹⁰²R¹⁰³, —OR¹⁰⁰, ═O, —OC(═O)R¹⁰⁰, —OC(═O)NR¹⁰²R¹⁰³, —S(═O)ₙR¹⁰⁰, or —S(═O)₂NR¹⁰²R¹⁰³; wherein
   R⁴⁹ at each occurrence is independently chosen from C₆₋₁₁aryl, 5-15 membered heteroaryl, halogen, —CN, —C(═O)R¹⁷⁰, —C(═O)OR¹⁷⁰, —C(═O)NR¹⁷²R¹⁷³, —NO₂, —NR¹⁷²R¹⁷³, —OR¹⁷⁰, ═O, —OC(═O)R¹⁷⁰, —OC(═O)NR¹⁷²R¹⁷³, —S(═O)ₙR¹⁷⁰, and —S(═O)₂NR¹⁷²R¹⁷³;
   R¹⁰⁰, R¹⁰², R¹⁰³, R¹⁷⁰, R¹⁷², and R¹⁷³ at each occurrence is independently chosen from H, C₁₋₆alkyl, and C₁₋₆haloalkyl;
   or any R¹⁰² and R¹⁰³, or R¹⁷² and R¹⁷³ may form, together with the nitrogen atom to which they are attached, a 3-6 membered heterocycloalkyl or a 5-10 membered heteroaryl; and
   n at each occurrence is independently chosen from 0, 1, and 2. Further examples of atoms and groups with which a compound or chemical group may be substituted include, but are not limited to, C₁₋₆alkyl, C₁₋₆haloalkyl, C₇₋₁₅arylalkyl, halogen, and hydroxy.

### Process for Preparation

The present invention provides a process for preparing a boronic ester of Formula I

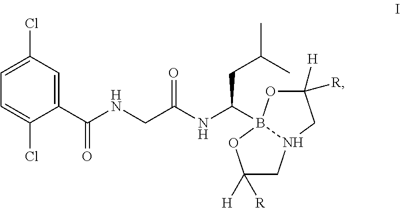

wherein R is H or methyl;
comprising the steps of:
(a) preparing an amide of Formula IV

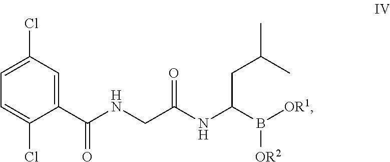

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

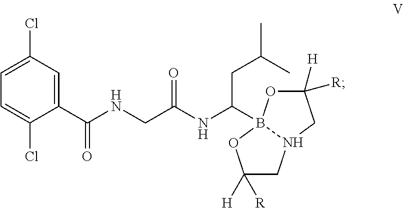

and
(c) crystallizing the boronic ester of Formula I from a solution of the boronic ester of Formula V.

In one embodiment, R is H. In another embodiment, R is methyl.

The manner of preparing the amide of Formula IV in step (a) is not critical. Preferably, the amide of Formula IV is prepared by coupling a compound of Formula II

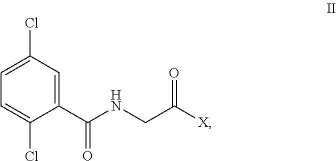

with an amine of Formula III

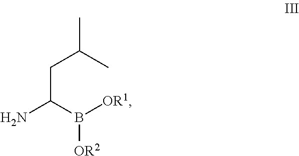

to form an amide of Formula IV, wherein X is OH or a leaving group. Thus, in a preferred embodiment the present invention provides a process for preparing a boronic ester of Formula I

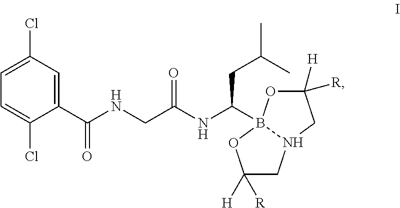

wherein R is H or methyl;
comprising the steps of:
(a) coupling a compound of Formula II

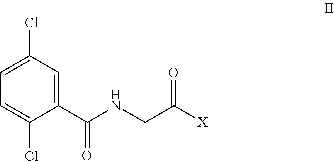

with an amine of Formula III

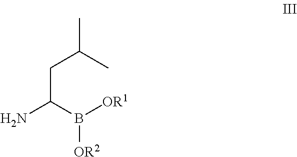

to form an amide of Formula IV

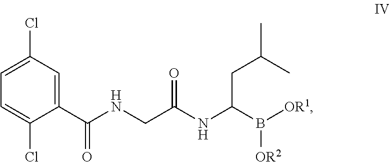

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur, and
X is OH or a leaving group;
(b) if the amide of Formula IV is not a boronic ester of Formula V, converting the amide of Formula IV into a boronic ester of Formula V

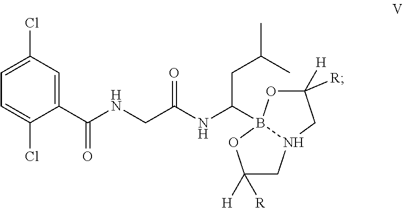

and
(c) crystallizing the boronic ester of Formula I from a solution of the boronic ester of Formula V.

The coupling reaction in step (a) can be performed using any suitable conditions, such as standard peptide coupling conditions well known to those of ordinary skill in the art. The leaving group X is any group capable of nucleophilic displacement by the amino group of the amine of Formula III. In some embodiments, the moiety —C(O)—X in the compound of Formula II is an acid chloride or an activated ester, such as an O—(N-hydroxysuccinimide) ester. Preferably, the acid chloride or activated ester is generated in situ, such as by contacting an acid of formula R¹C(═O)OH with a chloride donor such as thionyl chloride or oxalyl chloride, or by contacting an acid of formula R¹C(═O)OH, with a peptide coupling reagent. In one embodiment, an activated ester is generated in situ by contacting a compound of Formula II, wherein X is OH, with a peptide coupling reagent. Examples of suitable peptide coupling reagents include, without limitation, carbodiimide reagents, e.g., dicyclohexylcarbodiimide (DCC) or 1-(3-dimethylaminopropyl)-3-ethylcarbodiimide (EDC); phosphonium reagents, e.g., benzotriazol-1-yloxytris(dimethylamino)phosphonium hexafluorophosphate (BOP reagent); and uronium reagents, e.g., O-(1H-benzotriazol-1-yl)-N,N,N′,N′-tetramethyluronium tetrafluoroborate (TBTU) or 2-(7-aza-1H-benzotriazole-1-yl)-1,1,3,3-tetramethyluronium hexafluorophosphate (HATU). In some embodiments, the coupling reaction is carried out in the presence of a coupling agent and a base, such as an amine base, for example, diisopropylethylamine, diethyl amine, NMM (N-methylmorpholine), DIPEA (N,N-diisopropylethylamine, Hunig's base), or a mixture thereof. The coupling reaction is typically carried out in an organic solvent such as, for example, DMF (N,N-dimethylformamide), DMA (N,N-dimethylacetamide), toluene, dichloromethane, dichloroethane, or a mixture thereof. Suitable methods for preparing the amide of formula IV are described in the '830 and '662 patents, and in US Patent Application No. 2009/0325903.

The compound of Formula II may be prepared using any suitable conditions, such as standard peptide coupling conditions well known to those of ordinary skill in the art, such as Schotten-Baumann conditions. For example, the compound of Formula II may be prepared by coupling a compound of formula

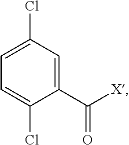

wherein X′ is OH or a leaving group, with glycine. Suitable methods for preparing the compound of Formula II are described in the '830 and '662 patents, and in US Patent Application No. 2009/0325903.

The leaving group X′ is any group capable of nucleophilic displacement by the amino group of glycine. In some embodiments, the moiety —C(O)—X′ is an acid chloride or an activated ester, such as an O—(N-hydroxysucccinimide) ester. In one embodiment, the acid chloride or activated ester is generated in situ, such as by contacting an acid of formula

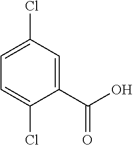 [SMILES: O=C(O)c1cc(Cl)ccc1Cl]

with a chloride donor such as thionyl chloride or oxalyl chloride, or with a peptide coupling reagent. Examples of suitable peptide coupling reagents include, without limitation, carbodiimide reagents, e.g., dicyclohexylcarbodiimide (DCC) or 1-(3-dimethylaminopropyl)-3-ethylcarbodiimide (EDC); phosphonium reagents, e.g., benzotriazol-1-yloxytris(dimethylamino)phosphonium hexafluorophosphate (BOP reagent); and uronium reagents, e.g., O-(1H-benzotriazol-1-yl)-N,N,N′,N′-tetramethyluronium tetrafluoroborate (TBTU) or 2-(7-aza-1H-benzotriazole-1-yl)-1,1,3,3-tetramethyluronium hexafluorophosphate (HATU). In some embodiments, the coupling reaction is carried out in the presence of a coupling agent and a base, such as an aqueous base, for example an aqueous carbonate solution such as aqueous potassium carbonate solution, or an amine base, for example, diisopropylethylamine, diethyl amine, NMM (N-methylmorpholine), DIPEA (N,N-diisopropylethylamine, Hunig's base), or a mixture thereof. The coupling reaction may be carried out in any suitable solvent, such as an aqueous solvent (e.g., aqueous THF), or an organic solvent such as DMF, DMA, toluene, dichloromethane, dichloroethane, or a mixture thereof.

The identities of R¹ and R² in the amine of Formula III are not critical. All that is required in the choice of R¹ and R² is that the

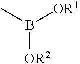

moiety of the amide of Formula IV be convertible into the

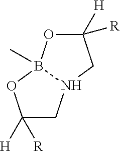

moiety of the boronic ester of Formula V during step (b). Therefore, essentially any combination of R¹ and R² can be used. Preferably, R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl, or R¹ and R² together with the boron and oxygen atoms to which they are attached form an optionally substituted 5-10 membered carbon-containing ring having 0-2 additional heteroatoms chosen from nitrogen, oxygen and sulfur. Preferably, R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl, or R¹ and R² together with the boron and oxygen atoms to which they are attached form a cyclic boronic ester having, in addition to the boron and oxygen atoms and without counting the hydrogen atoms, from 2 to 20 additional atoms chosen from carbon, nitrogen, oxygen and sulfur. Preferably, R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted 3-15 membered heterocycloalkyl, optionally substituted 5-15 membered heteroaryl, and optionally substituted 6-21 membered heteroarylalkyl, or R¹ and R² together with the boron and oxygen atoms to which they are attached form an optionally substituted 5-10 membered carbon-containing ring having 0-2 additional heteroatoms chosen from nitrogen, oxygen and sulfur. Preferably, R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted 3-15 membered heterocycloalkyl, optionally substituted 5-15 membered heteroaryl, and optionally substituted 6-21 membered heteroarylalkyl, or R¹ and R² together with the boron and oxygen atoms to which they are attached form a cyclic boronic ester having, in addition to the boron and oxygen atoms and without counting the hydrogen atoms, from 2 to 20 additional atoms chosen from carbon, nitrogen, oxygen and sulfur. Preferably, R¹ and R², together with the boron and oxygen atoms to which they are attached, form an optionally substituted 5-10 membered carbon-containing ring having 0-2 additional heteroatoms chosen from nitrogen, oxygen and sulfur. Preferably, R¹ and R², together with the boron and oxygen atoms to which they are attached, form a cyclic boronic ester having, in addition to the boron and oxygen atoms and without counting the hydrogen atoms, from 2 to 20 additional atoms chosen from carbon, nitrogen, oxygen and sulfur. In embodiments in which R¹ and R², together with the boron and oxygen atoms to which they are attached, form a cyclic boronic ester, it is preferred that 2-5 of the additional atoms are ring atoms. Preferably, no more than 2 of the additional ring atoms are N, O, or S atoms. Preferably, R¹ and R², together with the boron and oxygen atoms to which they are attached, form an optionally substituted 5-8 membered carbon-containing ring having 0-2 additional heteroatoms chosen from nitrogen, oxygen, and sulfur. Preferably, R¹ and R², together with the boron and oxygen atoms to which they are attached, form an optionally substituted 5-8 membered carbon-containing ring having 0-1 additional nitrogen atoms. Preferably, R¹ and R², together with the boron and oxygen atoms to which they are attached, form an optionally substituted 5-8 membered carbon-containing ring having 0-1 additional nitrogen atoms, wherein the ring atoms other than the boron atom are derived from a chiral diol such as 2,3-butanediol, preferably (2R,3R)-(−)-2,3-butanediol or (2S,3S)-(+)-2,3-butanediol; pinanediol, preferably (1R,2R,3R,5S)-(−)-pinanediol or (1S,2S,3S,5R)-(+)-pinanediol; 1,2-cyclopentanediol, preferably (1S,2S)-(+)-trans-1,2-cyclopentanediol or (1R,2R)-(−)-trans-1,2-cyclopentanediol; 2,5-hexanediol, preferably (2S,5S)-2,5-hexanediol or (2R,5R)-2,5-hexanediol; 1,2-dicyclohexyl-1,2-ethanediol, preferably (1R,2R)-1,2-dicyclohexyl-1,2-ethanediol or (1S,2S)-1,2-dicyclohexyl-1,2-ethanediol; hydrobenzoin, preferably (S,S)-(−)-hydrobenzoin or (R,R)-(+)-hydrobenzoin; 2,4-pentanediol, preferably (R,R)-(−)-2,4-pentanediol or (S,S,)-(+)-2,4-pentanediol; erythronic y-lactone, preferably D-erythronic y-lactone; or a carbohydrate, such as a 1,2,5,6-symmetrically protected mannitol. Preferably, R¹ and R², together with the boron and oxygen atoms to which they are attached, form an optionally substituted 5 membered carbon-containing ring, wherein the ring atoms other than the boron atom are derived from (1S,2S,3S,5R)-(+)-pinanediol (i.e., a compound of Formula III that is (1R)-1-[(3aS,4S,6S,7aR)-hexahydro-3a,5,5-trimethyl-4,6-methano-1,3,2-benzodioxaborol-2-yl]-3-methylbutylamine,

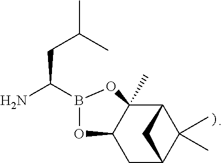 [SMILES: CC(C)C[C@H](N)B1O[C@@H]2C[C@@H]3C[C@@H](C3(C)C)[C@]2(C)O1]

The amine of Formula III may be prepared by any suitable method. In certain embodiments, the amine of Formula III may be prepared from a corresponding protected amine of Formula IIIa

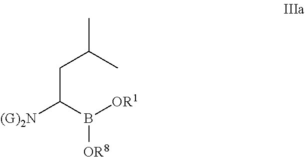

wherein G is an amine protecting group. In such embodiments, the protected amine of Formula IIIa is deprotected to form the amine of Formula III. The deprotection may be accomplished by any suitable method, such as by reacting the amine of Formula IIIa with an acid such as hydrochloric acid to form the corresponding acid salt of the amine of Formula IIIa. The acid salt is optionally converted to the amine of Formula III by neutralization with a base. The neutralization may be performed in situ during coupling step (a) in the process of the present invention. Suitable amine protecting groups are well known to those of ordinary skill in the art (see, for example, Gross and Mienhoffer, eds., The Peptides, Vol. 3, Academic Press, New York, 1981, pp. 3-88; Green and Wuts, Protective Groups in Organic Synthesis, 3^{rd} edition, John Wiley and Sons, Inc., New York, 1999). Silyl protecting groups are particularly suited for generating the amine of Formula III in situ. G may be a silyl protecting group of formula (R)₃Si—, wherein each R is independently chosen from alkyl, arylalkyl, and aryl, where the aryl and/or the aryl portion of the arylalkyl is optionally substituted. Each G may be a trimethylsilyl protecting group ((CH₃)₃Si—). The amines of Formula III or Formula IIIa may be prepared by any suitable method, including the methods disclosed in U.S. Pat. No. 7,576,206 and U.S. Patent Application No. 2005/0240047. A preferred amine of Formula III for use in the present invention is (1R)-1-[(3aS,4S,6S,7aR)-hexahydro-3a,5,5-trimethyl-4,6-methano-1,3,2-benzodioxaborol-2-yl]-3-methylbutylamine. A preferred amine of Formula IIIa for use in the present invention is N,N-bis(trimethylsilyl)-(1R)-1-[(3aS,4S,6S,7aR)-hexahydro-3a,5,5-trimethyl-4,6-methano-1,3,2-benzodioxaborol-2-yl]-3-methylbutylamine. (1R)-1-[(3aS,4S,6S,7aR)-hexahydro-3a,5,5-trimethyl-4,6-methano-1,3,2-benzodioxaborol-2-yl]-3-methylbutylamine may be formed in situ in coupling step (a) of the present invention from N,N-bis(trimethylsilyl)-(1R)-1-[(3aS,4S,6S,7aR)-hexahydro-3a,5,5-trimethyl-4,6-methano-1,3,2-benzodioxaborol-2-yl]-3-methylbutylamine.

The amine of Formula III contains a stereogenic center at the carbon to which the boron atom is attached. Therefore, two isomers of the amine of Formula III are possible (IIIb and IIIc):

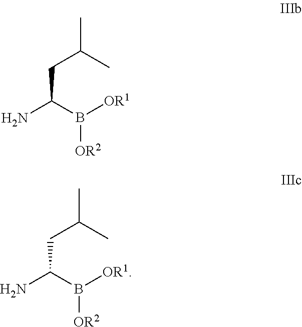

The isomer of Formula IIIb contains the desired stereochemistry present in the boronic ester of Formula I. Therefore, the amine of Formula III must contain at least some of the isomer of Formula IIIb. Although the chiral purity of the amine of Formula III is not critical, it is preferred that the chiral purity of the amine of Formula III is at least 0% ee (i.e., ratio of IIIb to IIIc is ≧50/50 (racemic)). More preferably, the chiral purity of the amine of Formula III is at least 50% ee (i.e., ratio of IIIb to IIIc is ≧75/25). More preferably, the chiral purity of the amine of Formula III is at least 70% ee (i.e., ratio of IIIb to IIIc is ≧85/15). More preferably, the chiral purity of the amine of Formula III is at least 80% ee (i.e., ratio of IIIb to IIIc is ≧90/10). More preferably, the chiral purity of the amine of Formula III is at least 90% ee (i.e., ratio of IIIb to IIIc is ≧95/5). More preferably, the chiral purity of the amine of Formula III is at least 94% ee (i.e., ratio of IIIb to IIIc is ≧97/3). More preferably, the chiral purity of the amine of Formula III is at least 98% ee (i.e., ratio of IIIb to IIIc is ≧99/1). More preferably, the chiral purity of the amine of Formula III is at least 99% ee (i.e., ratio of IIIb to IIIc is ≧99.5/0.5).

In a preferred subset of the previously described embodiments the chiral purity of the amine of Formula III is greater than 0% ee and the invention provides a process for preparing a boronic ester of Formula I

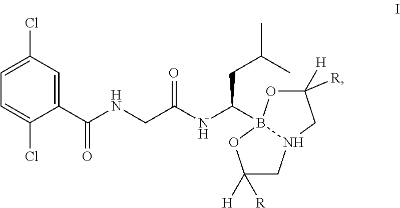

wherein R is H or methyl;
comprising the steps of:
(a) coupling a compound of Formula II

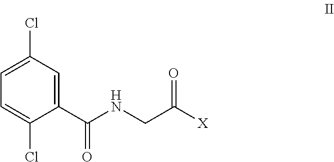

with an amine of Formula IIIb having a chiral purity of greater than 0% ee

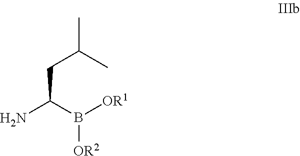

to form an amide of Formula VI

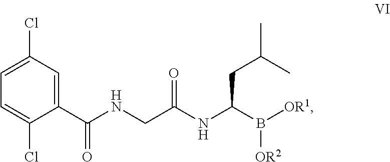

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur, and
X is OH or a leaving group;
(b) if the amide of Formula VI is not a boronic ester of Formula I, converting the amide of Formula VI into a boronic ester of Formula I

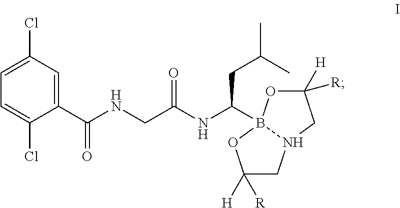

and
(c) crystallizing the boronic ester of Formula I from a solution.

And in a more general sense, the invention provides a process for preparing a boronic ester of Formula I

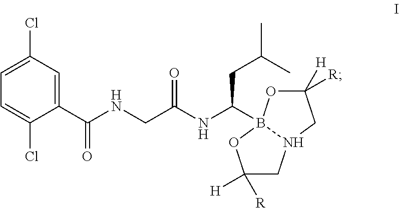

wherein R is H or methyl;
comprising the steps of:
(a) preparing an amide of Formula VI

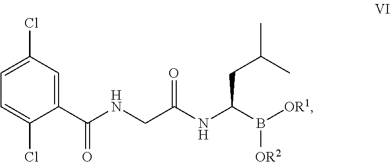

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula VI is not a boronic ester of Formula I, converting the amide of Formula VI into a boronic ester of Formula I

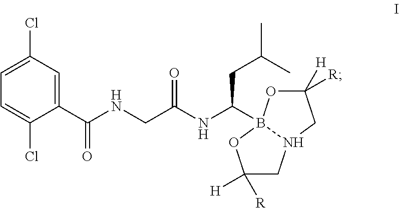

and
(c) crystallizing the boronic ester of Formula I from a solution.

In embodiments in which R¹ and R², together with the boron and oxygen atoms to which they are attached, form an 8 membered ring in which the ring atoms other than boron are derived from diethanolamine or diisopropanolamine, then the amide of Formula IV is the same as the boronic ester of Formula V and it is not necessary to perform step (b) in the process of the present invention. In such embodiments, the present invention provides a process for preparing a boronic ester of Formula I

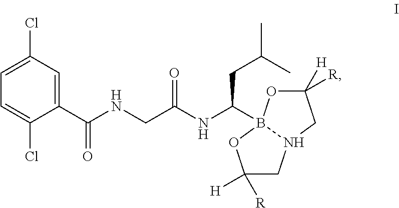

wherein R is H or methyl;
comprising the steps of:
(a) preparing a boronic ester of Formula V

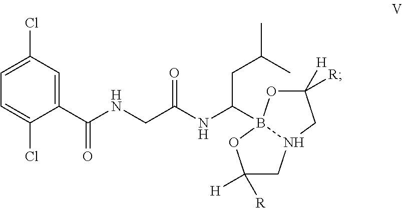

and
(b) crystallizing the boronic ester of Formula I from a solution of the boronic ester of Formula V. And in a preferred subset of the previous embodiment, when the chiral purity of the boronic ester of Formula V is greater than 0% e.e., the invention provides a process for preparing a boronic ester of Formula I

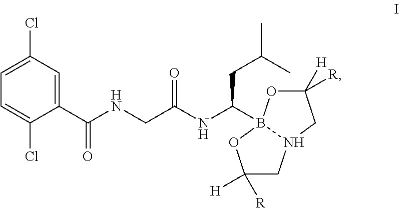

wherein R is H or methyl;
comprising the steps of:

(a) preparing a boronic ester of Formula Vc having a chiral purity of greater than 0% ee

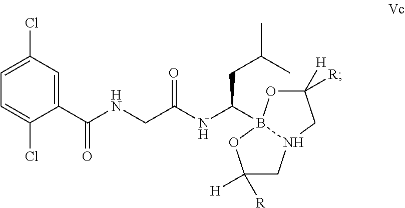

and

(b) crystallizing the boronic ester of Formula I from a solution;

wherein the chiral purity of the boronic ester of Formula I is greater than the chiral purity of the boronic ester of Formula Vc.

In embodiments in which R¹ and R², together with the boron and oxygen atoms to which they are attached, do not form an 8 membered ring in which the ring atoms other than boron are derived from diethanolamine or diisopropanolamine, the amide of Formula IV is different from the boronic ester of Formula V, and it is therefore necessary to convert the amide of Formula IV into the boronic ester of Formula V in step (b) of the process of the present invention. The amide of Formula IV can be converted into the boronic ester of Formula V in step (b) using esterification conditions well known to those of ordinary skill in the art. In certain embodiments, the amide of Formula IV is directly reacted with diethanolamine (R³, R⁴, ═H) or diisopropanolamine (R³, R⁴=methyl). Optionally, this direct reaction is conducted in the presence of an acid catalyst. Suitable acid catalysts include, but are not limited to, inorganic acids such as hydrochloric, hydrobromic, sulfuric, sulfamic, phosphoric, nitric and the like, and organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, toluenesulfonic, methanesulfonic, ethane disulfonic, oxalic, isethionic, and the like. A preferred acid is methanesulfonic acid. Preferably, the direct reaction is performed with diethanolamine.

The amide of Formula IV also may be indirectly converted to the boronic ester of Formula V by first converting the amide of Formula IV to the corresponding free boronic acid (i.e., R¹, R²═H) and then converting the free boronic acid to the boronic ester of Formula V. The free boronic acid may be prepared in situ and reacted with diethanolamine (R═H) or diisopropanolamine (R=methyl) to provide the boronic ester of Formula V. The free boronic acid may be prepared by transesterification of a boronic ester of Formula IV (R¹, R²≠H) with a C₁-C₆alkylboronic acid, such as 2-methylpropylboronic acid. This transesterification reaction may be conducted in the presence of an acid catalyst. Suitable acid catalysts include, but are not limited to the mineral acids and organic acids mentioned above. Mineral acids are preferred. A preferred mineral acid is hydrochloric acid. In certain embodiments, the transesterification reaction is conducted using biphasic conditions such that the free boronic acid of Formula IV and the C₁-C₆alkylboronic acid ester reaction products are phase separated. Suitable solvents for the biphasic reaction include methanol/heptane, with the free boronic acid being present in the methanol layer, and the C₁-C₆alkylboronic acid ester present in the heptane layer. The free boronic acid of Formula IV (R¹, R²═H) is then separated, neutralized, transferred to a suitable solvent (e.g., ethyl acetate or another solvent for step (c)), and reacted with diethanolamine or diisopropanolamine to provide the boronic ester of Formula V.

In step (c), the boronic ester of Formula I is crystallized from a solution of the boronic ester of Formula V. Any suitable solvent can be used for the crystallization. Suitable solvents include, but are not limited to, ethyl acetate, methyl tert-butyl ether, n-propanol, isopropanol, ethanol, isopropyl acetate, n-propyl acetate, acetonitrile, n-butyl acetate, isobutyl methyl ketone, acetone, 2-butanone, water, and mixtures thereof. Ethanol, ethyl acetate, n-propanol, isopropanol, and methyl tert-butyl ether may be used. Ethyl acetate is a suitable solvent. Suitable alcohols include ethanol, n-propanol, and isopropanol. Also useful are mixtures of an organic solvent and water, such as ethanol/water. Water may be used as an antisolvent to help precipitate the boronic ester of Formula I. Suitable crystallization methods are well known to those of ordinary skill in the art. Suitable crystallization methods include, but are not limited to, concentrating (e.g., by heating to remove solvent), cooling, precipitating with an antisolvent, seeding, and/or slurrying the solution. Cooling is preferred. The crystalline boronic ester of Formula I can be isolated by any suitable method, such as filtration, decantation, or centrifugation. Filtration is preferred.

In certain embodiments, the crystallization solution used in step (c) is the reaction mixture resulting from step (b), and the boronic ester of Formula I simply crystallizes from the step (b) reaction mixture. This is unexpected and highly advantageous because many amides of Formula IV are not crystalline as their free boronic acids (e.g., Compound 1). Therefore, purification of these compounds can typically only be accomplished using some form of chromatography, which is time consuming, expensive, and limited in terms of the ultimate purity obtainable. This is an important aspect of the present invention because chemical purification is accomplished by simple crystallization, and the obtained crystalline boronic ester of Formula I is readily converted to Compound 1 without diminishing chemical or chiral purity.

The boronic ester of Formula I may be converted to Compound 1. Thus, in one aspect the present invention provides a process for preparing Compound 1

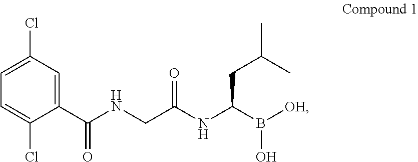 [SMILES: CC(C)C[C@H](NC(=O)CNC(=O)c1cc(Cl)ccc1Cl)B(O)O]

comprising the steps of:
(a) preparing an amide of Formula IV

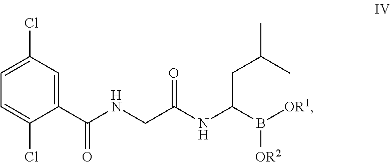

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

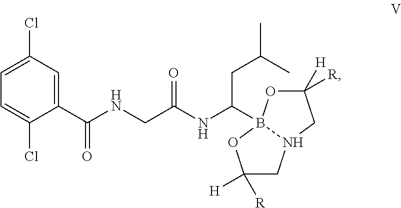

wherein R is H or methyl;
(c) crystallizing the boronic ester of Formula I from a solution of the boronic ester of Formula V

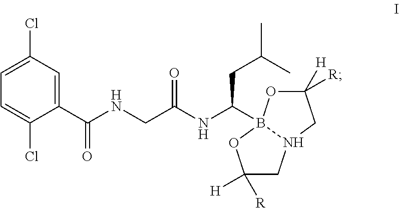

and
(d) converting the boronic ester of Formula I into Compound 1.
   In this aspect of the invention, when R¹ and R², together with the boron and oxygen atoms to which they are attached, form an 8 membered ring in which the ring atoms other than boron are derived from diethanolamine or diisopropanolamine, then the amide of Formula IV is the same as the boronic ester of Formula V and the invention provides a process for preparing Compound 1

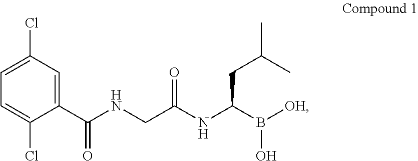 [SMILES: CC(C)C[C@H](NC(=O)CNC(=O)c1cc(Cl)ccc1Cl)B(O)O]

comprising the steps of:
(a) preparing a boronic ester of Formula V

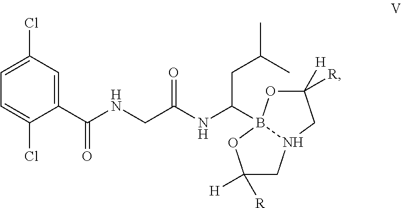

wherein R is H or methyl;
(b) crystallizing the boronic ester of Formula I from a solution of the boronic ester of Formula V

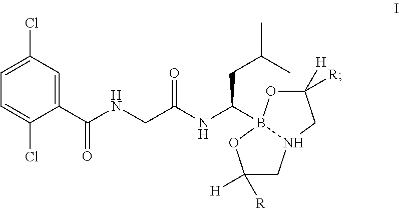

(c) converting the boronic ester of Formula I into Compound 1.

And in a preferred embodiment, the invention provides a process for preparing Compound 1

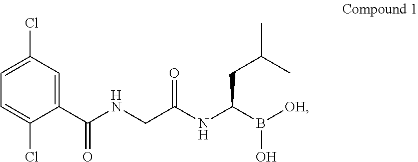 [SMILES: CC(C)C[C@H](NC(=O)CNC(=O)c1cc(Cl)ccc1Cl)B(O)O]

comprising the steps of:
(a) coupling a compound of Formula II

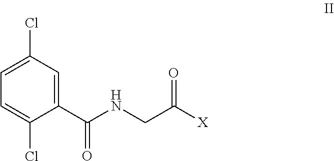

with an amine of Formula III

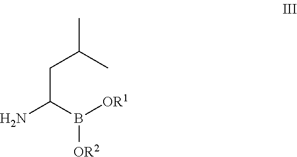

to form an amide of Formula IV

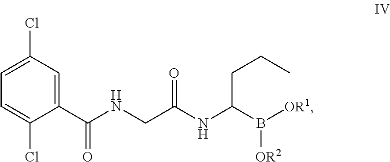

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

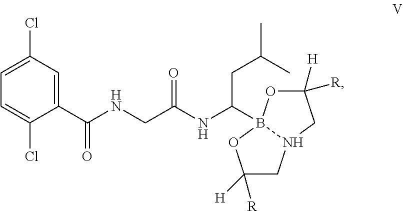

wherein R is H or methyl;
(c) crystallizing the boronic ester of Formula I from a solution of the boronic ester of Formula V

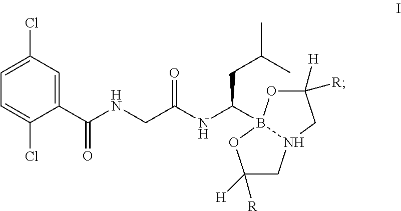

and
(d) converting the boronic ester of Formula I into Compound 1.

And when the chiral purity of the boronic ester of Formula IV is greater than 0% e.e., the present invention provides a process for preparing Compound 1

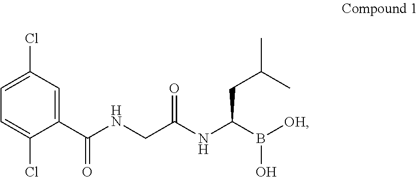 [SMILES: CC(C)C[C@H](NC(=O)CNC(=O)c1cc(Cl)ccc1Cl)B(O)O]

comprising the steps of:
(a) preparing an amide of Formula VI

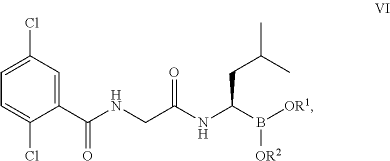

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula VI is not a boronic ester of Formula I, converting the amide of Formula VI into a boronic ester of Formula I

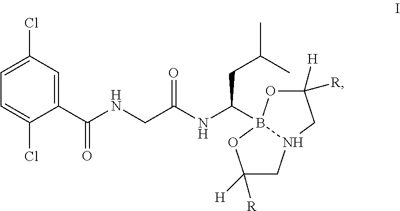

wherein R is H or methyl;
(c) crystallizing the boronic ester of Formula I from a solution; and
(d) converting the boronic ester of Formula I into Compound 1.
   Likewise, the invention provides a process for preparing Compound 1

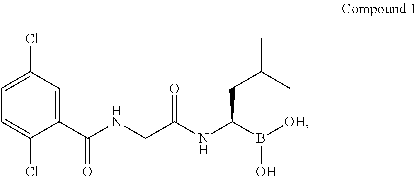 [SMILES: CC(C)C[C@H](NC(=O)CNC(=O)c1cc(Cl)ccc1Cl)B(O)O]

comprising the steps of:
(a) preparing a boronic ester of Formula I

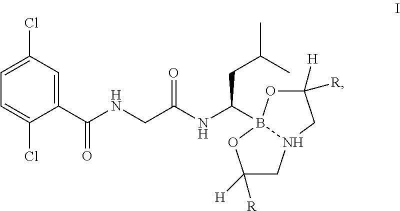

wherein R is H or methyl;
(b) crystallizing the boronic ester of Formula I from a solution; and
(c) converting the boronic ester of Formula I into Compound 1.

And in a preferred embodiment, the invention provides a process for preparing Compound 1

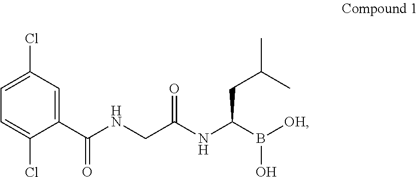 [SMILES: CC(C)C[C@H](NC(=O)CNC(=O)c1cc(Cl)ccc1Cl)B(O)O]

comprising the steps of:
(a) coupling a compound of Formula II

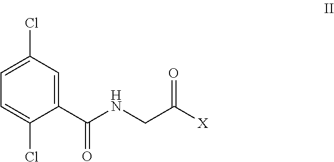

with an amine of Formula IIIb

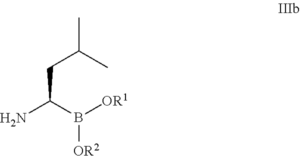

to form an amide of Formula VI

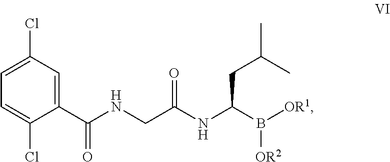

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula VI is not a boronic ester of Formula I, converting the amide of Formula VI into a boronic ester of Formula I

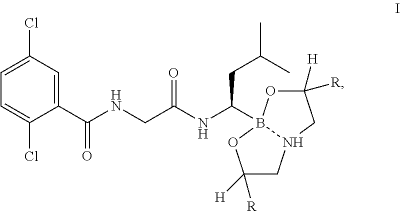

wherein R is H or methyl;
(c) crystallizing the boronic ester of Formula I from a solution; and
(d) converting the boronic ester of Formula I into Compound 1.

The most important step in the process is crystallization step (c), because the crystallization step provides extremely pure material rapidly and conveniently. Thus, in another aspect, the present invention provides a process for preparing Compound 1

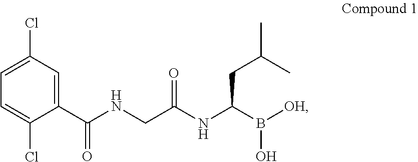 [SMILES: CC(C)C[C@H](NC(=O)CNC(=O)c1cc(Cl)ccc1Cl)B(O)O]

comprising the steps of
(a) crystallizing a boronic ester of Formula I from a solution of a boronic ester of Formula V

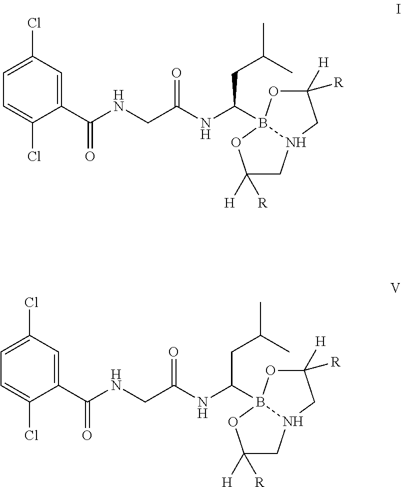

wherein R is H or methyl; and
(b) converting the boronic ester of Formula I into Compound 1.

The present invention provides a process for preparing Compound 1

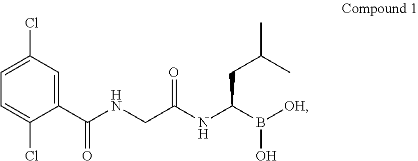 [SMILES: CC(C)C[C@H](NC(=O)CNC(=O)c1cc(Cl)ccc1Cl)B(O)O]

comprising the steps of
(a) crystallizing a boronic ester of Formula I from a solution

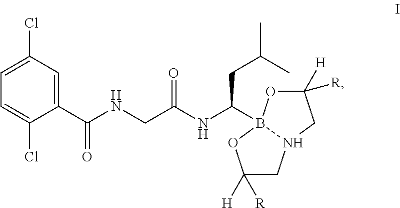

wherein R is H or methyl; and
(b) converting the boronic ester of Formula I into Compound 1.
   In one embodiment, R is H. In another embodiment, R is methyl.

The boronic ester of Formula I can be converted to Compound 1 using any suitable method. For example, the boronic ester of Formula I can be simply be exposed to water, preferably in the presence of an acid catalyst, to prepare Compound 1. Optionally, the hydrolysis may be carried out in the presence of an organic solvent, for example, ethyl acetate, methanol, or methyl t-butyl ether. Acid catalysts include mineral acids, for example, hydrochloric acid, hydrobromic acid, phosphoric acid, nitric acid, and the like. The acid may be aqueous hydrochloric acid. Therefore, the present invention provides a simple process to obtain Compound 1 in high purity even if the purity of one or more starting reagents is low. This represents a significant improvement over the prior art synthetic methods, which produce Compound 1 in amorphous form prone to degradation. Furthermore, the method of the present invention is advantageous because it proceeds in high overall yield from commercially available reagents and the intermediates produced are crystalline, easy to handle, and are obtained in high chemical purity by crystallization alone, without the need to perform any other purification method.

The chemical and chiral purity of the boronic ester of Formula I obtained in the crystallization step is often sufficiently high, such that the Compound 1 obtained in the conversion step may be directly used in pharmaceutical preparations without further purification. Preferably, the boronic ester of Formula I obtained in the crystallization step has a chemical purity of at least 90%. More preferably, the boronic ester of Formula I obtained in the crystallization step has a chemical purity of at least 95%. More preferably, the boronic ester of Formula I obtained in the crystallization step has a chemical purity of at least 97%. More preferably, the boronic ester of Formula I obtained in the crystallization step has a chemical purity of at least 98%. More preferably, the boronic ester of Formula I obtained in the crystallization step has a chemical purity of at least 98.5%. More preferably, the boronic ester of Formula I obtained in the crystallization step has a chemical purity of at least 99%. More preferably, the boronic ester of Formula I obtained in the crystallization step has a chemical purity of at least 99.2%. More preferably, the boronic ester of Formula I obtained in the crystallization step has a chemical purity of at least 99.3%. More preferably, the boronic ester of Formula I obtained in the crystallization step has a chemical purity of at least 99.5%. Preferably, the boronic ester of Formula I obtained in the crystallization step has a chiral purity of at least 90% ee. Preferably, the boronic ester of Formula I obtained in the crystallization step has a chiral purity of at least 92% ee. More preferably, the boronic ester of Formula I obtained in the crystallization step has a chiral purity of at least 95% ee. More preferably, the boronic ester of Formula I obtained in the crystallization step has a chiral purity of at least 97% ee. More preferably, the boronic ester of Formula I obtained in the crystallization step has a chiral purity of at least 98% ee. More preferably, the boronic ester of Formula I obtained in the crystallization step has a chiral purity of at least 98.5% ee. More preferably, the boronic ester of Formula I obtained in the crystallization step has a chiral purity of at least 99% ee. More preferably, the boronic ester of Formula I obtained in the crystallization step has a chiral purity of at least 99.3% ee. More preferably, the boronic ester of Formula I obtained in the crystallization step has a chiral purity of at least 99.5% ee. More preferably, the boronic ester of Formula I obtained in the crystallization step has a chiral purity of at least 99.7% ee. More preferably, the boronic ester of Formula I obtained in the crystallization step has a chiral purity of at least 99.8% ee.

Optionally, the boronic ester of Formula I obtained in the crystallization step may be recrystallized to increase its purity. Recrystallization techniques and conditions are known in the art and suitable conditions can be identified without undue experimentation. Suitable recrystallization solvents include, but are not limited to, ethyl acetate, methyl tert-butyl ether, n-propanol, isopropanol, ethanol, isopropyl acetate, n-propyl acetate, acetonitrile, n-butyl acetate, isobutyl methyl ketone, acetone, 2-butanone, water, and mixtures thereof. Ethanol, ethyl acetate, n-propanol, isopropanol, and methyl tert-butyl ether may be used. Ethyl acetate is a suitable solvent. Suitable alcohol solvents include ethanol, n-propanol, and isopropanol. Also useful are mixtures of an organic solvent and water, such as ethanol/water. Water may be used as an antisolvent to help precipitate the boronic ester of Formula I. An exemplary recrystallization comprises suspension of the boronic ester of Formula I in aqueous C₁-C₆alcohol, for example ethanol. The suspension can be heated, e.g., to a temperature at or near the boiling point, preferably about 75° C., for a time sufficient to dissolve impurities. The suspension is then cooled, e.g., to about 10° C. or lower, preferably about 2° C. to about 6° C., to induce crystallization of the boronic ester of Formula I. Water may be added to induce further precipitation. The crystalline boronic ester of Formula I can be isolated by any suitable method, such as filtration, decantation, or centrifugation. Filtration is preferred.

After recrystallization, the boronic ester of Formula I may be converted to Compound 1 as previously described. Preferably, the recrystallized boronic ester of Formula I has a chemical purity of at least 95%. More preferably, the recrystallized boronic ester of Formula I has a chemical purity of at least 97%. More preferably, the recrystallized boronic ester of Formula I has a chemical purity of at least 98%. More preferably, the recrystallized boronic ester of Formula I has a chemical purity of at least 98.5%. More preferably, the recrystallized boronic ester of Formula I has a chemical purity of at least 99%. More preferably, the recrystallized boronic ester of Formula I has a chemical purity of at least 99.3%. More preferably, the recrystallized boronic ester of Formula I has a chemical purity of at least 99.5%. More preferably, the recrystallized boronic ester of Formula I has a chemical purity of at least 99.7%. More preferably, the recrystallized boronic ester of Formula I has a chemical purity of at least 99.8%. More preferably, the recrystallized boronic ester of Formula I has a chemical purity of at least 99.9%. Preferably, the recrystallized boronic ester of Formula I has a chiral purity of at least 95% ee. More preferably, the recrystallized boronic ester of Formula I has a chiral purity of at least 97% ee. More preferably, the recrystallized boronic ester of Formula I has a chiral purity of at least 98% ee. More preferably, the recrystallized boronic ester of Formula I has a chiral purity of at least 98.5% ee. More preferably, the recrystallized boronic ester of Formula I has a chiral purity of at least 99% ee. More preferably, the recrystallized boronic ester of Formula I has a chiral purity of at least 99.3% ee. More preferably, the recrystallized boronic ester of Formula I has a chiral purity of at least 99.5% ee. More preferably, the recrystallized boronic ester of Formula I has a chiral purity of at least 99.7% ee. More preferably, the recrystallized boronic ester of Formula I has a chiral purity of at least 99.8% ee. More preferably, the recrystallized boronic ester of Formula I has a chiral purity of at least 99.9% ee.

### Process for Purification

In view of the remarkable improvement in purification and handling afforded by the preparation process of the present invention, the invention further provides a process for purifying an amide of Formula VI having an initial purity

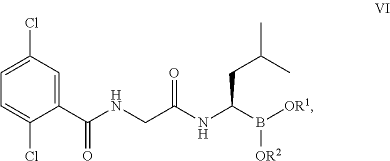

wherein R¹ and R² are independently chosen from H, optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R² together with the boron and oxygen atoms to which they are attached form an optionally substituted 5-10 membered carbon-containing ring having 0-2 additional heteroatoms chosen from nitrogen, oxygen and sulfur; comprising the steps of:
(a) if the amide of Formula VI is not a boronic ester of Formula I, converting the amide of Formula VI into the boronic ester of Formula I

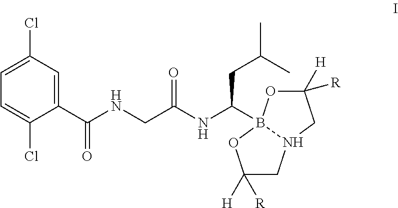

wherein R is H or methyl;
(b) crystallizing the boronic ester of Formula I from solution;
(c) isolating the crystallized boronic ester of Formula I from the solution; and
(d) if the isolated boronic ester of Formula I is not the amide of Formula VI, converting the isolated boronic ester of Formula I back into the amide of Formula VI having a purity higher than the initial purity.

In one embodiment, the chemical purity of the amide of Formula VI obtained in step (d) is higher than the initial chemical purity. In one embodiment, the chiral purity of the amide of Formula VI obtained in step (d) is higher than the initial chiral purity. In one embodiment, both the chemical purity and the chiral purity of the amide of Formula VI obtained in step (d) is higher than the initial chemical purity and chiral purity.

In one embodiment, the initial chemical purity is less than 50%. In one embodiment, the initial chemical purity is less than 60%. In one embodiment, the initial chemical purity is less than 70%. In one embodiment, the initial chemical purity is less than 80%. In one embodiment, the initial chemical purity is less than 90%. In one embodiment, the initial chemical purity is less than 95%. In one embodiment, the initial chemical purity is less than 97%. In one embodiment, the initial chemical purity is less than 98%. In one embodiment, the initial chemical purity is less than 99%. In one embodiment, the initial chemical purity is less than 99.5%. In one embodiment, the initial chiral purity is less than 50% ee. In one embodiment, the initial chiral purity is less than 60% ee. In one embodiment, the initial chiral purity is less than 70% ee. In one embodiment, the initial chiral purity is less than 80% ee. In one embodiment, the initial chiral purity is less than 90% ee. In one embodiment, the initial chiral purity is less than 95% ee. In one embodiment, the initial chiral purity is less than 97% ee. In one embodiment, the initial chiral purity is less than 98% ee. In one embodiment, the initial chiral purity is less than 99% ee. In one embodiment, the initial chiral purity is less than 99.5% ee. In one embodiment, the initial chiral purity is less than 99.7% ee.

R is as previously defined for the preparation process of the present invention. In one embodiment of the purification process, R is H. In another embodiment, R is methyl.

R¹ and R² are as previously defined for the preparation process of the present invention, except that H is also a possibility. As before, the identities of R¹ and R² are not critical in the purification process of the present invention. All that is required in the choice of R¹ and R² is that the

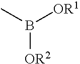

moiety of the amide of Formula VI be convertible into the

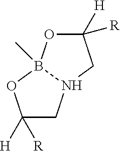

moiety of the boronic ester of Formula I during step (a) of the purification process. Therefore, essentially any combination of R¹ and R² can be used. Preferably, R¹ and R² are independently chosen from H, optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl, or R¹ and R² together with the boron and oxygen atoms to which they are attached form an optionally substituted 5-10 membered carbon-containing ring having 0-2 additional heteroatoms chosen from nitrogen, oxygen and sulfur. Preferably, R¹ and R² are independently chosen from H, optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl, or R¹ and R² together with the boron and oxygen atoms to which they are attached form a cyclic boronic ester having, in addition to the boron and oxygen atoms and without counting the hydrogen atoms, from 2 to 20 additional atoms chosen from carbon, nitrogen, oxygen and sulfur. Preferably, R¹ and R² are independently chosen from H, optionally substituted C₁₋₆alkyl, optionally substituted C₆₋₁₀aryl, optionally substituted C₇₋₁₆arylalkyl, optionally substituted C₃₋₁₁cycloalkyl, optionally substituted 3-15 membered heterocycloalkyl, optionally substituted 5-15 membered heteroaryl, and optionally substituted 6-21 membered heteroarylalkyl, or R¹ and R² together with the boron and oxygen atoms to which they are attached form an optionally substituted 5-10 membered carbon-containing ring having 0-2 additional heteroatoms chosen from nitrogen, oxygen and sulfur. Preferably, R¹ and R² are independently chosen from H, optionally substituted C₁₋₆alkyl, optionally substituted C₆₋₁₀aryl, optionally substituted C₇₋₁₆arylalkyl, optionally substituted C₃₋₁₁cycloalkyl, optionally substituted 3-15 membered heterocycloalkyl, optionally substituted 5-15 membered heteroaryl, and optionally substituted 6-21 membered heteroarylalkyl, or R¹ and R² together with the boron and oxygen atoms to which they are attached form a cyclic boronic ester having, in addition to the boron and oxygen atoms and without counting the hydrogen atoms, from 2 to 20 additional atoms chosen from carbon, nitrogen, oxygen and sulfur. Preferably, R¹ and R² are H, or R¹ and R², together with the boron and oxygen atoms to which they are attached, form an optionally substituted 5-10 membered carbon-containing ring having 0-2 additional heteroatoms chosen from nitrogen, oxygen and sulfur. Preferably, R¹ and R² are H, or R¹ and R², together with the boron and oxygen atoms to which they are attached, form a cyclic boronic ester having, in addition to the boron and oxygen atoms and without counting the hydrogen atoms, from 2 to 20 additional atoms chosen from carbon, nitrogen, oxygen and sulfur. In embodiments in which R¹ and R², together with the boron and oxygen atoms to which they are attached, form a cyclic boronic ester, it is preferred that 2-5 of the additional atoms are ring atoms. Preferably, no more than 2 of the additional ring atoms are N, O, or S atoms. Preferably, R¹ and R² are H, or R¹ and R², together with the boron and oxygen atoms to which they are attached, form an optionally substituted 5-8 membered carbon-containing ring having 0-2 additional heteroatoms chosen from nitrogen, oxygen, and sulfur. Preferably, R¹ and R² are H, or R¹ and R², together with the boron and oxygen atoms to which they are attached, form an optionally substituted 5-8 membered carbon-containing ring having 0-1 additional nitrogen atoms. Preferably, R¹ and R² are H, or R¹ and R², together with the boron and oxygen atoms to which they are attached, form an optionally substituted 5-8 membered carbon-containing ring having 0-1 additional nitrogen atoms, wherein the ring atoms other than the boron atom are derived from a chiral diol such as 2,3-butanediol, preferably (2R,3R)-(−)-2,3-butanediol or (2S,3S)-(+)-2,3-butanediol; pinanediol, preferably (1R,2R,3R,5S)-(−)-pinanediol or (1S,2S,3S,5R)-(+)-pinanediol; 1,2-cyclopentanediol, preferably (1S,2S)-(+)-trans-1,2-cyclopentanediol or (1R,2R)-(−)-trans-1,2-cyclopentanediol; 2,5-hexanediol, preferably (2S,5S)-2,5-hexanediol or (2R,5R)-2,5-hexanediol; 1,2-dicyclohexyl-1,2-ethanediol, preferably (1R,2R)-1,2-dicyclohexyl-1,2-ethanediol or (1S,2S)-1,2-dicyclohexyl-1,2-ethanediol; hydrobenzoin, preferably (S,S)-(−)-hydrobenzoin or (R,R)-(+)-hydrobenzoin; 2,4-pentanediol, preferably (R,R)-(−)-2,4-pentanediol or (S,S,)-(+)-2,4-pentanediol; erythronic y-lactone, preferably D-erythronic y-lactone; or a carbohydrate, such as a 1,2,5,6-symmetrically protected mannitol. Preferably, R¹ and R² are H, or R¹ and R², together with the boron and oxygen atoms to which they are attached, form an optionally substituted 5 membered carbon-containing ring, wherein the ring atoms other than the boron atom are derived from (1S,2S,3S,5R)-(+)-pinanediol. In preferred embodiments, R¹ and R² are H. In such embodiments, the invention provides a process for purifying Compound 1.

If necessary, step (a) of the purification process can be performed as described above for step (b) of the preparation process. In embodiments in which R¹ and R², together with the boron and oxygen atoms to which they are attached, form an 8 membered ring in which the ring atoms other than boron are derived from diethanolamine, then the amide of Formula VI is the same as the boronic ester of Formula I and it is not necessary to perform step (a) in the purification process of the present invention. In all other embodiments, the amide of Formula VI is different from the boronic ester of Formula I, and it is therefore necessary to convert the amide of Formula VI into the boronic ester of Formula I in step (a) of the purification process. The amide of Formula VI can be converted into the boronic ester of Formula I in step (a) using esterification conditions well known to those of ordinary skill in the art. In certain embodiments, the amide of Formula VI is directly reacted with diethanolamine. Optionally, this direct reaction is conducted in the presence of an acid catalyst. Suitable acid catalysts include, but are not limited to, inorganic acids such as hydrochloric, hydrobromic, sulfuric, sulfamic, phosphoric, nitric and the like, and organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, toluenesulfonic, methanesulfonic, ethane disulfonic, oxalic, isethionic, and the like. A preferred acid is methanesulfonic acid.

The amide of Formula VI also may be indirectly converted to the boronic ester of Formula I by first converting the amide of Formula VI (when R¹ and R² are not already H) to the corresponding free boronic acid (i.e., Compound 1) and then converting Compound 1 to the boronic ester of Formula I. The Compound 1 may be prepared in situ and reacted with diethanolamine to provide the boronic ester of Formula I. The Compound 1 may be prepared by transesterification of a boronic ester of Formula VI (R¹, R²≠H) with a C₁-C₆alkylboronic acid, such as 2-methylpropylboronic acid. This transesterification reaction may be conducted in the presence of an acid catalyst. Suitable acid catalysts include, but are not limited to, the mineral acids and organic acids mentioned above. Mineral acids may be used. A preferred mineral acid is hydrochloric acid. In certain embodiments, the transesterification reaction is conducted using biphasic conditions such that the Compound 1 and the C₁-C₆alkylboronic acid ester reaction products are phase separated. Suitable solvents for the biphasic reaction include methanol/heptane, with the Compound 1 being present in the methanol layer, and the C₁-C₆alkylboronic acid ester present in the heptane layer. The Compound 1 is then separated and reacted with diethanolamine to provide the boronic ester of Formula I.

In step (b) of the purification process, the boronic ester of Formula I is crystallized from solution. Any suitable solvent can be used for the crystallization. Suitable solvents include, but are not limited to, ethyl acetate, methyl tert-butyl ether, n-propanol, isopropanol, ethanol, isopropyl acetate, n-propyl acetate, acetonitrile, n-butyl acetate, isobutyl methyl ketone, acetone, 2-butanone, water, and mixtures thereof. Ethanol, ethyl acetate, n-propanol, isopropanol, and methyl tert-butyl ether may be used. Ethyl actetate is a suitable solvent. Suitable alcohol solvents include ethanol, n-propanol, and isopropanol. Also useful are mixtures of an organic solvent and water, such as ethanol/water. Water may be used as an antisolvent to help precipitate the boronic ester of Formula I, rather than as a co-solvent in the initial solubilization. Suitable crystallization methods are well known to those of ordinary skill in the art. Suitable crystallization methods include, but are not limited to, concentrating (e.g., by heating to remove solvent), cooling, precipitating with an antisolvent, seeding, and/or slurrying the solution. Cooling is preferred.

Crystallization step (b) is extremely important to the purification process because it permits substantial upgrades in chemical purity by simple crystallization alone, without the need to perform more problematic purification methods such as chromatography. It is made possible because the boronic ester of Formula I is stable and crystalline. These desirable stability, handling, and purification attributes are particularly surprising because esters of Formula VI are often difficult to purify, unstable, and/or non-crystalline. These surprising properties of the boronic ester of Formula I, which permit its ready handling, long-term storage, and high purity, are especially advantageous because the boronic ester of Formula I is readily converted to Compound 1 having the same high chemical and chiral purity.

In step (c) of the purification process, the crystalline boronic ester of Formula I can be isolated by any suitable method, such as filtration, decantation, or centrifugation. Filtration is preferred.

In step (d) of the purification process, the isolated boronic ester of Formula I is converted back into the amide of Formula VI, if necessary. In embodiments in which R¹ and R², together with the boron and oxygen atoms to which they are attached, form an 8 membered ring in which the ring atoms other than boron are derived from diethanolamine, then the boronic ester of Formula I is the same as the amide of Formula VI, and it is not necessary to perform step (d) in the purification process of the present invention. In all other embodiments, the boronic ester of Formula I is different from the amide of Formula VI, and it is therefore necessary to convert the boronic ester of Formula I back into the amide of Formula VI in step (d) of the purification process. When R¹ and R²≠H, the boronic ester of Formula I can be converted into an amide of Formula VI using the direct or indirect transesterification reactions described above for step (a). When R¹ and R² are H, the boronic ester of Formula I can be converted to Compound 1 as previously described. For example, the boronic ester of Formula I can be simply be exposed to water, preferably in the presence of an acid catalyst, to prepare Compound 1. The hydrolysis may be carried out in an organic solvent, for example, ethyl acetate, methanol, or methyl t-butyl ether in the presence of an acid catalyst. The acid may be a mineral acid, for example, hydrochloric acid, hydrobromic acid, phosphoric acid, nitric acid, and the like. In one embodiment, the acid is aqueous hydrochloric acid.

The purity of the amide of Formula VI obtained from the purification process is often sufficiently high, such that the amide of Formula VI can be directly used in pharmaceutical preparations. Preferably, the amide of Formula VI has a chemical purity of at least 90%. More preferably, the amide of Formula VI has a chemical purity of at least 95%. More preferably, the amide of Formula VI has a chemical purity of at least 97%. More preferably, the amide of Formula VI has a chemical purity of at least 98%. More preferably, the amide of Formula VI has a chemical purity of at least 98.5%. More preferably, the amide of Formula VI has a chemical purity of at least 99%. More preferably, the amide of Formula VI has a chemical purity of at least 99.5%. Preferably, the amide of Formula VI has a chiral purity of at least 90% ee. Preferably, the amide of Formula VI has a chiral purity of at least 92% ee. More preferably, the amide of Formula VI has a chiral purity of at least 95% ee. More preferably, the amide of Formula VI has a chiral purity of at least 97% ee. More preferably, the amide of Formula VI has a chiral purity of at least 98% ee. More preferably, the amide of Formula VI has a chiral purity of at least 98.5% ee. More preferably, the amide of Formula VI has a chiral purity of at least 99% ee. More preferably, the amide of Formula VI has a chiral purity of at least 99.2% ee. More preferably, the amide of Formula VI has a chiral purity of at least 99.3% ee. More preferably, the amide of Formula VI has a chiral purity of at least 99.5% ee. More preferably, the amide of Formula VI has a chiral purity of at least 99.7% ee. More preferably, the amide of Formula VI has a chiral purity of at least 99.8% ee.

Optionally, the isolated boronic ester of Formula I may be recrystallized prior to converting it back into the amide of Formula VI to increase its purity. Recrystallization techniques and conditions are known in the art and suitable conditions can be identified without undue experimentation. Suitable recrystallization solvents include, but are not limited to, organic solvents such as ethyl acetate, methyl tert-butyl ether, n-propanol, isopropanol, ethanol, isopropyl acetate, n-propyl acetate, acetonitrile, n-butyl acetate, isobutyl methyl ketone, acetone, 2-butanone, and mixtures thereof. Also suitable are mixtures of water with organic solvents, such as the organic solvents previously mentioned, with ethanol/water being a specific example. Water may be used as an antisolvent to help precipitate the boronic ester of Formula I. Ethanol, ethyl acetate, n-propanol, isopropanol, and methyl tert-butyl ether are suitable recrystallization solvents. Ethyl acetate is a suitable solvent. Suitable alcohol solvents include ethanol, n-propanol, and isopropanol. The crystalline boronic ester of Formula I can be isolated by any suitable method, such as filtration, decantation, or centrifugation. Filtration is preferred.

Preferably, the recrystallized boronic ester of Formula I has a chemical purity of at least 95%. More preferably, the recrystallized boronic ester of Formula I has a chemical purity of at least 97%. More preferably, the recrystallized boronic ester of Formula I has a chemical purity of at least 98%. More preferably, the recrystallized boronic ester of Formula I has a chemical purity of at least 98.5%. More preferably, the recrystallized boronic ester of Formula I has a chemical purity of at least 99%. More preferably, the recrystallized boronic ester of Formula I has a chemical purity of at least 99.5%. More preferably, the recrystallized boronic ester of Formula I has a chemical purity of at least 99.8%. More preferably, the recrystallized boronic ester of Formula I has a chemical purity of at least 99.9%. Preferably, the recrystallized boronic ester of Formula I has a chiral purity of at least 95% ee. More preferably, the recrystallized boronic ester of Formula I has a chiral purity of at least 97% ee. More preferably, the recrystallized boronic ester of Formula I has a chiral purity of at least 98% ee. More preferably, the recrystallized boronic ester of Formula I has a chiral purity of at least 98.5% ee. More preferably, the recrystallized boronic ester of Formula I has a chiral purity of at least 99% ee. More preferably, the recrystallized boronic ester of Formula I has a chiral purity of at least 99.5% ee. More preferably, the recrystallized boronic ester of Formula I has a chiral purity of at least 99.8% ee. More preferably, the recrystallized boronic ester of Formula I has a chiral purity of at least 99.9% ee.

After recrystallization, the boronic ester of Formula I may, if necessary, be converted in step (d) to the amide of Formula VI having the same high chemical and chiral purity as the recrystallized boronic ester of Formula I using the techniques described above.

### Compounds

The present invention further provides boronic esters of Formulas IX and X

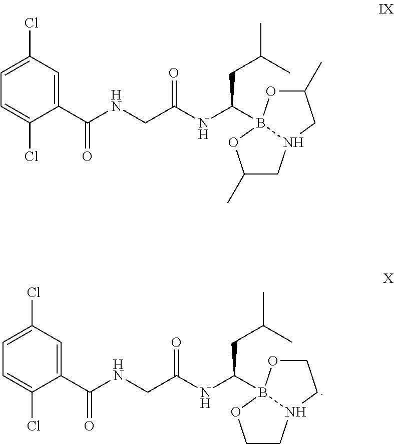

The boronic esters of Formulas IX and X are critical components of the preparation and purification processes described above. The compounds of Formulas IX and X are diisopropanolamine (IX) or diethanolamine (X) boronic ester derivatives of Compound 1, and are used in the processes of the present invention to generate Compound 1 in high purity. As discussed above, the boronic esters of Formulas IX and X are stable and crystalline. These desirable stability, handling, and purification attributes are particularly surprising because other esters of Formulas IV and VI are often difficult to form, difficult to purify, unstable, and/or non-crystalline. These surprising properties of the boronic esters of Formulas IX and X are especially advantageous because the boronic esters of Formulas IX and X are readily converted to Compound 1 having the same high chemical and chiral purity. The chemical purity of Compound 1 can be significantly upgraded using these compounds, and Compound 1 can be stored and even formulated as these esters.

A further advantage of the boronic esters of Formulas IX and X is that they are storage stable. Compound 1 is troublesome to work with because it is unstable, and can readily degrade during handling and storage. The ability to obtain and conveniently store Compound 1 (e.g., at room temperature or above) in high purity as its boronic esters IX and X constitutes a significant improvement over the prior art.

Thus, in another embodiment, the present invention provides Compound 1 having high chemical purity and high chiral purity. In one embodiment, the Compound 1 has a chemical purity of at least 98.5%. Preferably, the Compound 1 has a chemical purity of at least 98.6%. More preferably, the Compound 1 has a chemical purity of at least 98.7%. More preferably, the Compound 1 has a chemical purity of at least 98.8%. More preferably, the Compound 1 has a chemical purity of at least 98.9%. More preferably, the Compound 1 has a chemical purity of at least 99.0%. More preferably, the Compound 1 has a chemical purity of at least 99.1%. More preferably, the Compound 1 has a chemical purity of at least 99.2%. More preferably, the Compound 1 has a chemical purity of at least 99.3%. More preferably, the Compound 1 has a chemical purity of at least 99.4%. More preferably, the Compound 1 has a chemical purity of at least 99.5%. More preferably, the Compound 1 has a chemical purity of at least 99.6%. More preferably, the Compound 1 has a chemical purity of at least 99.7%. More preferably, the Compound 1 has a chemical purity of at least 99.8%. More preferably, the Compound 1 has a chemical purity of at least 99.9%. Preferably, the Compound 1 has a chiral purity of at least 98.5% ee. More preferably, the Compound 1 has a chiral purity of at least 98.6% ee. More preferably, the Compound 1 has a chiral purity of at least 98.7% ee. More preferably, the Compound 1 has a chiral purity of at least 98.8% ee. More preferably, the Compound 1 has a chiral purity of at least 98.9% ee. More preferably, the Compound 1 has a chiral purity of at least 99.0% ee. More preferably, the Compound 1 has a chiral purity of at least 99.1% ee. More preferably, the Compound 1 has a chiral purity of at least 99.2% ee. More preferably, the Compound 1 has a chiral purity of at least 99.3% ee. More preferably, the Compound 1 has a chiral purity of at least 99.4% ee. More preferably, the Compound 1 has a chiral purity of at least 99.5% ee. More preferably, the Compound 1 has a chiral purity of at least 99.6% ee. More preferably, the Compound 1 has a chiral purity of at least 99.7% ee. More preferably, the Compound 1 has a chiral purity of at least 99.8% ee. More preferably, the Compound 1 has a chiral purity of at least 99.9% ee.

In another embodiment, the present invention provides a boronic ester of Formula IX having high chemical purity and high chiral purity. In one embodiment, the boronic ester of Formula IX has a chemical purity of at least 98.5%. Preferably, the boronic ester of Formula IX has a chemical purity of at least 98.6%. More preferably, the boronic ester of Formula IX has a chemical purity of at least 98.7%. More preferably, the boronic ester of Formula IX has a chemical purity of at least 98.8%. More preferably, the boronic ester of Formula IX has a chemical purity of at least 98.9%. More preferably, the boronic ester of Formula IX has a chemical purity of at least 99.0%. More preferably, the boronic ester of Formula IX has a chemical purity of at least 99.1%. More preferably, the boronic ester of Formula IX has a chemical purity of at least 99.2%. More preferably, the boronic ester of Formula IX has a chemical purity of at least 99.3%. More preferably, the boronic ester of Formula IX has a chemical purity of at least 99.4%. More preferably, the boronic ester of Formula IX has a chemical purity of at least 99.5%. More preferably, the boronic ester of Formula IX has a chemical purity of at least 99.6%. More preferably, the boronic ester of Formula IX has a chemical purity of at least 99.7%. More preferably, the boronic ester of Formula IX has a chemical purity of at least 99.8%. More preferably, the boronic ester of Formula IX has a chemical purity of at least 99.9%. Preferably, the boronic ester of Formula IX has a chiral purity of at least 98.5% ee. More preferably, the boronic ester of Formula IX has a chiral purity of at least 98.6% ee. More preferably, the boronic ester of Formula IX has a chiral purity of at least 98.7% ee. More preferably, the boronic ester of Formula IX has a chiral purity of at least 98.8% ee. More preferably, the boronic ester of Formula IX has a chiral purity of at least 98.9% ee. More preferably, the boronic ester of Formula IX has a chiral purity of at least 99.0% ee. More preferably, the boronic ester of Formula IX has a chiral purity of at least 99.1% ee. More preferably, the boronic ester of Formula IX has a chiral purity of at least 99.2% ee. More preferably, the boronic ester of Formula IX has a chiral purity of at least 99.3% ee. More preferably, the boronic ester of Formula IX has a chiral purity of at least 99.4% ee. More preferably, the boronic ester of Formula IX has a chiral purity of at least 99.5% ee. More preferably, the boronic ester of Formula IX has a chiral purity of at least 99.6% ee. More preferably, the boronic ester of Formula IX has a chiral purity of at least 99.7% ee. More preferably, the boronic ester of Formula IX has a chiral purity of at least 99.8% ee. More preferably, the boronic ester of Formula IX has a chiral purity of at least 99.9% ee.

In another embodiment, the present invention provides a boronic ester of Formula X having high chemical purity and high chiral purity. In one embodiment, the boronic ester of Formula X has a chemical purity of at least 98.5%. Preferably, the boronic ester of Formula X has a chemical purity of at least 98.6%. More preferably, the boronic ester of Formula X has a chemical purity of at least 98.7%. More preferably, the boronic ester of Formula X has a chemical purity of at least 98.8%. More preferably, the boronic ester of Formula X has a chemical purity of at least 98.9%. More preferably, the boronic ester of Formula X has a chemical purity of at least 99.0%. More preferably, the boronic ester of Formula X has a chemical purity of at least 99.1%. More preferably, the boronic ester of Formula X has a chemical purity of at least 99.2%. More preferably, the boronic ester of Formula X has a chemical purity of at least 99.3%. More preferably, the boronic ester of Formula X has a chemical purity of at least 99.4%. More preferably, the boronic ester of Formula X has a chemical purity of at least 99.5%. More preferably, the boronic ester of Formula X has a chemical purity of at least 99.6%. More preferably, the boronic ester of Formula X has a chemical purity of at least 99.7%. More preferably, the boronic ester of Formula X has a chemical purity of at least 99.8%. More preferably, the boronic ester of Formula X has a chemical purity of at least 99.9%. Preferably, the boronic ester of Formula X has a chiral purity of at least 98.5% ee. More preferably, the boronic ester of Formula X has a chiral purity of at least 98.6% ee. More preferably, the boronic ester of Formula X has a chiral purity of at least 98.7% ee. More preferably, the boronic ester of Formula X has a chiral purity of at least 98.8% ee. More preferably, the boronic ester of Formula X has a chiral purity of at least 98.9% ee. More preferably, the boronic ester of Formula X has a chiral purity of at least 99.0% ee. More preferably, the boronic ester of Formula X has a chiral purity of at least 99.1% ee. More preferably, the boronic ester of Formula X has a chiral purity of at least 99.2% ee. More preferably, the boronic ester of Formula X has a chiral purity of at least 99.3% ee. More preferably, the boronic ester of Formula X has a chiral purity of at least 99.4% ee. More preferably, the boronic ester of Formula X has a chiral purity of at least 99.5% ee. More preferably, the boronic ester of Formula X has a chiral purity of at least 99.6% ee. More preferably, the boronic ester of Formula X has a chiral purity of at least 99.7% ee. More preferably, the boronic ester of Formula X has a chiral purity of at least 99.8% ee. More preferably, the boronic ester of Formula X has a chiral purity of at least 99.9% ee.

A further advantage of the boronic esters of Formulas IX and X is that they may be used as prodrugs of Compound 1. Whether administered orally or by injection, the boronic esters of Formulas IX and X are readily hydrolyzed to provide Compound 1. Unlike other boronic esters and acids acids such as bortezomib, the boronic ester of Formula X is orally bioavailable. Accordingly, the boronic ester of Formula X provides a feasible mechanism by which to administer Compound 1 orally. This represents a significant improvement over the prior art.

### Pharmaceutical Formulations

The present invention further provides a pharmaceutical composition comprising a compound of the present invention (i.e., a compound chosen from Compound 1 having high chemical and chiral purity, the boronic ester of Formula IX, and the boronic ester of Formula X), and a pharmaceutically acceptable excipient. In one embodiment, the pharmaceutical composition contains a compound of the present invention in an amount therapeutically effective for treating a disease or disorder. In one embodiment, the disease or disorder is multiple myeloma. In one embodiment, the disease or disorder is lupus.

In one embodiment, the present invention provides a pharmaceutical composition comprising Compound 1 having high chemical purity and high chiral purity, and a pharmaceutically acceptable excipient. In another embodiment, the present invention provides a pharmaceutical composition comprising a boronic ester of Formula IX, and a pharmaceutically acceptable excipient. In another embodiment, the present invention provides a pharmaceutical composition comprising a boronic ester of Formula X, and a pharmaceutically acceptable excipient.

The invention further provides a process for preparing a pharmaceutical composition, comprising the step of combining a compound of the present invention with a pharmaceutically acceptable excipient. In one embodiment, the invention provides a process for preparing a pharmaceutical composition, comprising the step of combining Compound 1 having high chemical and chiral purity with a pharmaceutically acceptable excipient. In another embodiment, the invention provides a process for preparing a pharmaceutical composition, comprising the step of combining a boronic ester of Formula IX with a pharmaceutically acceptable excipient. In another embodiment, the invention provides a process for preparing a pharmaceutical composition, comprising the step of combining a boronic ester of Formula X with a pharmaceutically acceptable excipient.

An advantage of the boronic esters of Formulas IX and X is that they may be used to conveniently prepare pharmaceutical compositions of Compound 1, since the esters are readily hydrolyzed to form Compound 1.

In one embodiment, the present invention provides a process for preparing a pharmaceutical composition of Compound 1

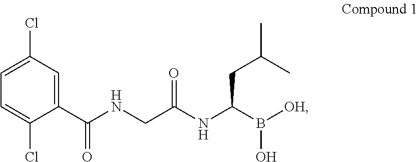 [SMILES: CC(C)C[C@H](NC(=O)CNC(=O)c1cc(Cl)ccc1Cl)B(O)O]

comprising the steps of:
(a) converting a boronic ester of Formula I into Compound 1

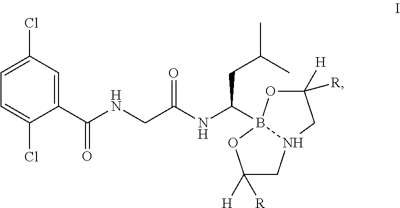

wherein R is H or methyl; and
(b) combining the Compound 1 with a pharmaceutically acceptable excipient.

In one embodiment, the invention provides a process for preparing a pharmaceutical composition of Compound 1, comprising the steps of (a) converting a boronic ester of Formula IX into Compound 1, and (b) combining the Compound 1 with a pharmaceutically acceptable excipient. In one embodiment, the invention provides a process for preparing a pharmaceutical composition of Compound 1, comprising the steps of (a) converting a boronic ester of Formula X into Compound 1, and (b) combining the Compound 1 with a pharmaceutically acceptable excipient.

The boronic esters of Formulas IX and X can be converted into Compound 1 as previously described. For example, the boronic esters of Formulas IX and X can be simply exposed to water, optionally in the presence of an acid catalyst, to directly convert the esters into Compound 1. Optionally, the hydrolysis may be carried out in an organic solvent, optionally in the presence of an acid catalyst. Suitable organic solvents include, but are not limited to, ethyl acetate, methanol, and methyl t-butyl ether. Suitable acids include, but are not limited to, mineral acids, such as hydrochloric acid, hydrobromic acid, phosphoric acid, nitric acid, and the like. A suitable acid is aqueous hydrochloric acid. Optionally, the boronic esters of Formulas IX and X may be indirectly converted into Compound 1. For example, the boronic esters of Formulas IX and X may be initially converted into a different boronic ester (e.g., a boronic ester of Formula VI as described above, wherein R¹ and R² are not H) and then that ester converted into Compound 1.

In the same way, the combining step (b) may be performed directly or indirectly. For example, Compound 1 can be directly mixed with a pharmaceutically acceptable excipient by simply adding these components together. In these direct embodiments, the boronic ester of Formula IX or X is converted to Compound 1 prior to mixing with the pharmaceutically acceptable excipient(s). Alternatively, the components may be indirectly mixed by, for example, mixing a pharmaceutically acceptable excipient with a precursor to Compound 1, and then converting the precursor to Compound 1 in the presence of the pharmaceutically acceptable excipient. In these indirect embodiments, the converting step is at least partly performed in the presence of the pharmaceutically acceptable excipient.

In one embodiment, the invention provides a process for preparing a pharmaceutical composition of Compound 1, comprising the steps of (a) combining the boronic ester of Formula IX with a pharmaceutically acceptable excipient, and (b) converting the boronic ester of Formula IX into Compound 1. In another embodiment, the invention provides a process for preparing a pharmaceutical composition of Compound 1, comprising the steps of (a) combining the boronic ester of Formula X with a pharmaceutically acceptable excipient, and (b) converting the boronic ester of Formula X into Compound 1.

In one embodiment, the invention provides a process for preparing a pharmaceutical composition of Compound 1, comprising the steps of (a) combining the boronic ester of Formula IX with water and a pharmaceutically acceptable excipient, and optionally (b) drying the combination. In another embodiment, the invention provides a process for preparing a pharmaceutical composition of Compound 1, comprising the steps of (a) combining the boronic ester of Formula X with water and a pharmaceutically acceptable excipient, and optionally (b) drying the combination. The combination obtained in these embodiments is optionally dried to remove the water used to hydrolyze the boronic ester of Formula IX or X. A preferred drying method is lyophilization.

In one embodiment, the invention provides a process for preparing a pharmaceutical composition, comprising the steps of (a) combining a compound of the present invention with a pharmaceutically acceptable excipient, and optionally (b) drying the combination. In one embodiment, the invention provides a process for preparing a pharmaceutical composition, comprising the steps of (a) combining Compound 1 having high chemical and chiral purity with a pharmaceutically acceptable excipient, and optionally (b) drying the combination. In another embodiment, the invention provides a process for preparing a pharmaceutical composition, comprising the steps of (a) combining a boronic ester of Formula IX with a pharmaceutically acceptable excipient, and optionally (b) drying the combination. In another embodiment, the invention provides a process for preparing a pharmaceutical composition, comprising the steps of (a) combining a boronic ester of Formula X with a pharmaceutically acceptable excipient, and optionally (b) drying the combination. A preferred drying method is lyophilization.

In one embodiment, the invention provides a process for preparing a pharmaceutical composition of Compound 1, comprising the steps of (a) mixing in any order (i) the boronic ester of Formula IX, (ii) water and (iii) a pharmaceutically acceptable excipient; and (b) lyophilizing the mixture. In another embodiment, the invention provides a process for preparing a pharmaceutical composition of Compound 1, comprising the steps of (a) mixing in any order (i) the boronic ester of Formula X, (ii) water and (iii) a pharmaceutically acceptable excipient; and (b) lyophilizing the mixture.

In one embodiment, the invention provides a process for preparing a pharmaceutical composition, comprising the steps of (a) mixing in any order (i) the boronic ester of Formula IX, (ii) water and (iii) a pharmaceutically acceptable excipient; and (b) lyophilizing the mixture. In another embodiment, the invention provides a process for preparing a pharmaceutical composition, comprising the steps of (a) mixing in any order (i) the boronic ester of Formula X, (ii) water and (iii) a pharmaceutically acceptable excipient; and (b) lyophilizing the mixture.

In one embodiment, the invention provides a process for preparing a pharmaceutical composition of Compound 1, comprising the steps of (a) combining the boronic ester of Formula IX with a pharmaceutically acceptable excipient, (b) mixing the combination with water, and (c) lyophilizing the mixture. In another embodiment, the invention provides a process for preparing a pharmaceutical composition of Compound 1, comprising the steps of (a) combining the boronic ester of Formula X with a pharmaceutically acceptable excipient, (b) mixing the combination with water, and (c) lyophilizing the mixture.

In one embodiment, the invention provides a process for preparing a pharmaceutical composition, comprising the steps of (a) combining the boronic ester of Formula IX with a pharmaceutically acceptable excipient, (b) mixing the combination with water, and (c) lyophilizing the mixture. In another embodiment, the invention provides a process for preparing a pharmaceutical composition, comprising the steps of (a) combining the boronic ester of Formula X with a pharmaceutically acceptable excipient, (b) mixing the combination with water, and (c) lyophilizing the mixture.

In one embodiment, the invention provides a process for preparing a pharmaceutical composition of Compound 1, comprising the steps of (a) mixing in any order (i) the boronic ester of Formula IX, (ii) water and (iii) a bulking agent; and (b) lyophilizing the mixture. In another embodiment, the invention provides a process for preparing a pharmaceutical composition of Compound 1, comprising the steps of (a) mixing in any order (i) the boronic ester of Formula X, (ii) water and (iii) a bulking agent; and (b) lyophilizing the mixture.

In one embodiment, the invention provides a process for preparing a pharmaceutical composition, comprising the steps of (a) mixing in any order (i) the boronic ester of Formula IX, (ii) water and (iii) a bulking agent; and (b) lyophilizing the mixture. In another embodiment, the invention provides a process for preparing a pharmaceutical composition, comprising the steps of (a) mixing in any order (i) the boronic ester of Formula X, (ii) water and (iii) a bulking agent; and (b) lyophilizing the mixture.

In one embodiment, the invention provides a process for preparing a pharmaceutical composition of Compound 1, comprising the steps of (a) combining the boronic ester of Formula IX with a bulking agent, (b) mixing the combination with water, and (c) lyophilizing the mixture. In another embodiment, the invention provides a process for preparing a pharmaceutical composition of Compound 1, comprising the steps of (a) combining the boronic ester of Formula X with a bulking agent, (b) mixing the combination with water, and (c) lyophilizing the mixture.

In one embodiment, the invention provides a process for preparing a pharmaceutical composition, comprising the steps of (a) combining the boronic ester of Formula IX with a bulking agent, (b) mixing the combination with water, and (c) lyophilizing the mixture. In another embodiment, the invention provides a process for preparing a pharmaceutical composition, comprising the steps of (a) combining the boronic ester of Formula X with a bulking agent, (b) mixing the combination with water, and (c) lyophilizing the mixture.

In one embodiment, the invention provides a process for preparing a pharmaceutical composition of Compound 1, comprising the steps of (a) mixing in any order (i) the boronic ester of Formula IX, (ii) water, (iii) a bulking agent, and (iv) a cyclodextrin; and (b) lyophilizing the mixture. In another embodiment, the invention provides a process for preparing a pharmaceutical composition of Compound 1, comprising the steps of (a) mixing in any order (i) the boronic ester of Formula X, (ii) water, (iii) a bulking agent, and (iv) a cyclodextrin; and (b) lyophilizing the mixture.

In one embodiment, the invention provides a process for preparing a pharmaceutical composition, comprising the steps of (a) mixing in any order (i) the boronic ester of Formula IX, (ii) water, (iii) a bulking agent, and (iv) a cyclodextrin; and (b) lyophilizing the mixture. In another embodiment, the invention provides a process for preparing a pharmaceutical composition, comprising the steps of (a) mixing in any order (i) the boronic ester of Formula X, (ii) water, (iii) a bulking agent, and (iv) a cyclodextrin; and (b) lyophilizing the mixture.

In the above embodiments, unless otherwise specified the pharmaceutical composition may be in the form of a syrup, an elixir, a suspension, a powder, a granule, a tablet, a capsule, a lozenge, a troche, an aqueous solution, a cream, an ointment, a lotion, a gel, an emulsion, etc. Solid form preparations include powders, tablets, pills, capsules, cachets, suppositories, and dispersible granules. Preferably, the pharmaceutical composition is a tablet or capsule. In one embodiment, the pharmaceutical composition is a tablet. In another embodiment, the pharmaceutical composition is a capsule. In one embodiment, the pharmaceutical composition is a lyophilized powder.

For preparing a pharmaceutical composition from a compound of the present invention, pharmaceutically acceptable excipients can be either solid or liquid. An excipient can be one or more substances which may act as, e.g., a carrier, diluent, flavoring agent, binder, preservative, tablet disintegrating agent, or an encapsulating material. The pharmaceutical composition may contain two or more compounds of the present invention (e.g., a boronic ester of Formula IX and a boronic ester of Formula X may be used together in the same pharmaceutical composition).

In powders, the excipient may be a finely divided solid in a mixture with a finely divided active component (i.e., compound of the present invention). In tablets, the active component may be mixed with an excipient having the necessary binding properties in suitable proportions and compacted in the shape and size desired. Suitable excipients include magnesium carbonate, magnesium stearate, talc, sugar, lactose, pectin, dextrin, starch, gelatin, tragacanth, methylcellulose, sodium carboxymethylcellulose, low melting wax, cocoa butter, and the like.

Pharmaceutically acceptable excipients are determined in part by the particular composition being administered, as well as by the particular method used to administer the composition. Accordingly, there is a wide variety of suitable formulations of pharmaceutical compositions of the present invention (see, e.g., Remington: The Science and Practice of Pharmacy, 20th ed., Gennaro et al. Eds., Lippincott Williams and Wilkins, 2000).

Bulking agents that have “generally regarded as safe” (GRAS) status from the United States Food and Drug Administration (FDA) are well known in the art of pharmaceutical lyophilization, tend to strengthen the structure of a lyophilized cake, and may be used in the present invention. Bulking agents include saccharides, such as monosaccharides or oligosaccharides, amino acids, sugar alcohols, and mixtures thereof. Bulking agents also include saccharides, such as monosaccharides or oligosaccharides, sugar alcohols, and mixtures thereof. Bulking agents used in the present invention may include sucrose, dextrose, maltose, lactose, sorbitol, glycine, and dextran. A suitable bulking agent is mannitol.

Suitable cyclodextrins include the naturally occurring cyclodextrins, methyl-β-cyclodextrin, dimethyl-β-cyclodextrin, trimethyl-β-cyclodextrin, 2-hydroxymethyl-β-cyclodextrin, hydroxyethyl-β-cyclodextrin, 2-hydroxypropyl-β-cyclodextrin, 3-hydroxypropyl-β-cyclodextrin, β-cyclodextrin sulfate, β-cyclodextrin sulfonate, or 3-cyclodextrin sulfobutyl ether. Most of these are commercially available from such suppliers as Aldrich Chemical Company, Milwaukee Wis. and Wacker Chemicals, New Canaan, Conn. Suitable cyclodextrins include β-cyclodextrin, hydroxypropyl-β-cyclodextrin and β-cyclodextrin sulfobutyl ether. The cyclodextrin may be hydroxypropyl P cyclodextrin, hydroxypropyl y cyclodextrin, sulfobutyl ether β-cyclodextrin, or a mixture thereof. The cyclodextrin may include hydroxypropyl-β-cyclodextrin or β-cyclodextrin sulfobutyl ether. The cyclodextrin may be hydroxypropyl-β-cyclodextrin. The cyclodextrin may be (3-cyclodextrin sulfobutyl ether. A suitable cyclodextrin is KLEPTOSE® HPB, available from Roquette Frèbres, France.

The pharmaceutical composition suitably contains from 1% to 95% (w/w) of the active compound (I.e., compound of the present invention). The pharmaceutical composition may contain from 5% to 70% (w/w) of the active compound.

The pharmaceutical composition may contain at least one unit dose of the active compound. In general, the unit dose of a compound of the present invention is from about 1 μg/m² to 10 mg/m² for a typical subject. The unit dose of a compound of the present invention may be from about 0.1 mg/m² to about 10 mg/m². The unit dose of a compound of the present invention may be from about 0.5 mg/m² to about 10 mg/m². The unit dose of a compound of the present invention may be from about 0.5 mg/m² to about 7 mg/m². The unit dose of a compound of the present invention may be from about 0.5 mg/m² to about 5 mg/m². The unit dose of a compound of the present invention may be from about 0.5 mg/m² to about 3 mg/m².

### Methods of Treatment

The present invention further provides a method of treating a disease or disorder in a subject comprising the step of administering to the subject a compound of the present invention (i.e., a compound chosen from Compound 1 having high chemical and chiral purity, the boronic ester of Formula IX, and the boronic ester of Formula X). In one embodiment, the disease or disorder is multiple myeloma. In one embodiment, the disease or disorder is lupus. In one embodiment, the compound of the present invention is Compound 1 having high chemical and chiral purity. In one embodiment, the compound of the invention is the boronic ester of Formula IX. In one embodiment, the compound of the invention is the boronic ester of Formula X.

In one embodiment, the invention provides a method of treating a disease or disorder in a subject comprising the step of administering to the subject a pharmaceutical composition comprising a compound of the present invention and a pharmaceutically acceptable excipient. In one embodiment, the disease or disorder is multiple myeloma. In one embodiment, the disease or disorder is lupus. In one embodiment, the compound of the present invention is Compound 1 having high chemical and chiral purity. In one embodiment, the compound of the invention is the boronic ester of Formula IX. In one embodiment, the compound of the invention is the boronic ester of Formula X.

The invention further provides a method of treating a disease or disorder in a subject comprising the steps of (a) combining a compound of the present invention with a pharmaceutically acceptable excipient to form a pharmaceutical composition, and (b) administering the pharmaceutical composition to the subject. In one embodiment, the disease or disorder is multiple myeloma. In one embodiment, the disease or disorder is lupus. In one embodiment, the compound of the present invention is Compound 1 having high chemical and chiral purity. In one embodiment, the compound of the invention is the boronic ester of Formula IX. In one embodiment, the compound of the invention is the boronic ester of Formula X.

In one embodiment, the present invention provides a method of treating a disease or disorder in a subject comprising the steps of

(a) converting a boronic ester of Formula I

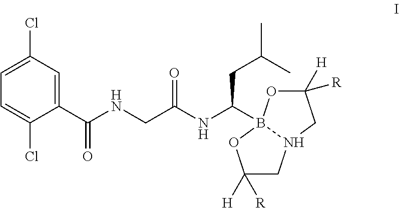

into Compound 1, wherein R is H or methyl;

(b) combining the Compound 1 with a pharmaceutically acceptable excipient to form a pharmaceutical composition; and

(c) administering the pharmaceutical composition to the subject.

In one embodiment, R is H. In one embodiment, R is methyl. In one embodiment, the disease or disorder is multiple myeloma. In one embodiment, the disease or disorder is lupus.

In one embodiment, the invention provides a method of treating a disease or disorder in a subject comprising the steps of (a) converting a boronic ester of Formula IX into Compound 1, (b) combining the Compound 1 with a pharmaceutically acceptable excipient to form a pharmaceutical composition, and (c) administering the pharmaceutical composition to the subject. In one embodiment, the invention provides a method of treating a disease or disorder in a subject comprising the steps of (a) converting a boronic ester of Formula X into Compound 1, (b) combining the Compound 1 with a pharmaceutically acceptable excipient to form a pharmaceutical composition, and (c) administering the pharmaceutical composition to the subject. The boronic esters of Formulas IX and X can be converted into Compound 1 in step (a) as previously described. In the same way, the combining step (b) may be performed directly or indirectly as previously described. In one embodiment, the disease or disorder is multiple myeloma. In one embodiment, the disease or disorder is lupus.

Determination of the proper dosage for a particular situation is within the skill of the practitioner. Generally, treatment is initiated with smaller dosages which are less than the optimum dose of the compound. Thereafter, the dosage is increased by small increments until the optimum effect under the circumstances is reached. For convenience, the total daily dosage may be divided and administered in portions during the day, if desired. A typical dose is about 1 mg to about 1,000 mg per day, such as about 5 mg to about 500 mg per day. In one embodiment, the dose is about 10 mg to about 300 mg per day, such as about 25 mg to about 250 mg per day.

### PREFERRED EMBODIMENTS OF THE PRESENT INVENTION

Preferred embodiments of the present invention include those listed below.

### Embodiment 1

### A Process for Preparing Compound 1

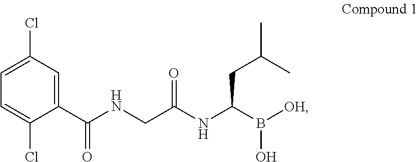 [SMILES: CC(C)C[C@H](NC(=O)CNC(=O)c1cc(Cl)ccc1Cl)B(O)O] [0266] comprising the steps of:
(a) coupling a compound of Formula II

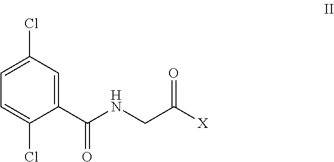

with an amine of Formula III

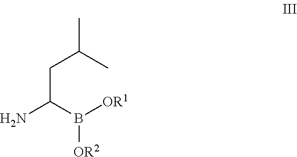

to form an amide of Formula IV

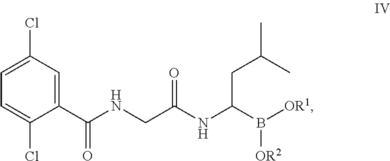

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula Va

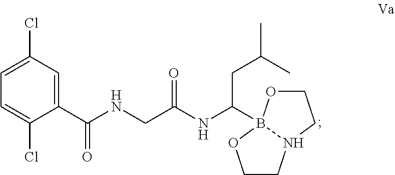

(c) crystallizing the boronic ester of Formula X from a solution of the boronic ester of Formula Va

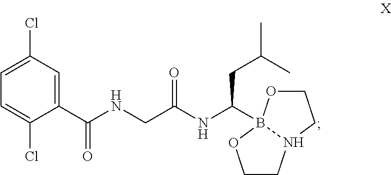

and
(d) converting the boronic ester of Formula X into Compound 1.

### Embodiment 2

A process for preparing Compound 1

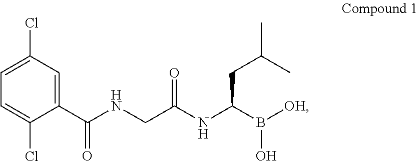 [SMILES: CC(C)C[C@H](NC(=O)CNC(=O)c1cc(Cl)ccc1Cl)B(O)O]

comprising the steps of:
(a) coupling a compound of Formula II

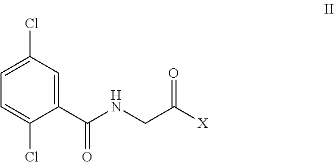

with an amine of Formula III

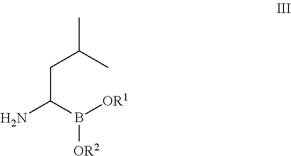

to form an amide of Formula IV

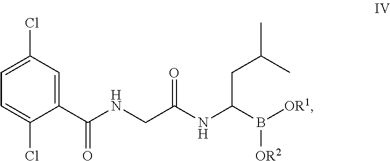

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula Vb, converting the amide of Formula IV into a boronic ester of Formula Vb

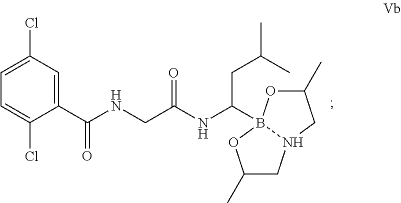

(c) crystallizing the boronic ester of Formula IX from a solution of the boronic ester of Formula Vb

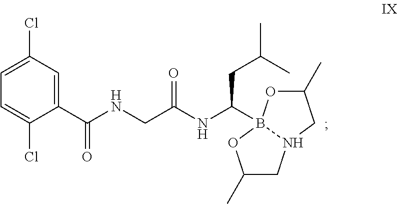

(d) converting the boronic ester of Formula IX into Compound 1.

### Embodiment 3

The process of Embodiment 1, further comprising the step of recrystallizing the boronic ester of Formula X after step (c) before performing step (d).

### Embodiment 4

The process of Embodiment 2, further comprising the step of recrystallizing the boronic ester of Formula IX after step (c) before performing step (d).

### Embodiment 5

The process of any of Embodiments 1 to 4, wherein R¹ and R², together with the boron and oxygen atoms to which they are attached, form an optionally substituted 5-8 membered carbon-containing ring having 0-2 additional heteroatoms chosen from nitrogen, oxygen, and sulfur.

### Embodiment 6

The process of Embodiment 5, wherein R¹ and R², together with the boron and oxygen atoms to which they are attached, form an optionally substituted 5-8 membered carbon-containing ring having 0-1 additional nitrogen atoms, wherein the atoms other than the ring boron atom are derived from a chiral diol.

### Embodiment 7

The process of Embodiment 6, wherein the atoms other than the ring boron atom are derived from (1S,2S,3S,5R)-(+)-pinanediol, so that the amine of Formula III has the following structure

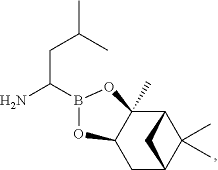 [SMILES: CC(C)CC(N)B1O[C@@H]2C[C@@H]3C[C@@H](C3(C)C)[C@]2(C)O1]

and the amide of Formula IV has the following structure

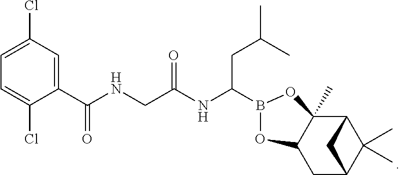

### Embodiment 8

A process for preparing Compound 1

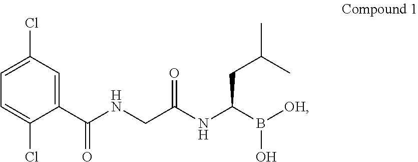 [SMILES: CC(C)C[C@H](NC(=O)CNC(=O)c1cc(Cl)ccc1Cl)B(O)O]

comprising the steps of:
(a) coupling a compound of Formula II

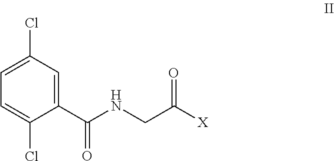

with an amine of Formula III

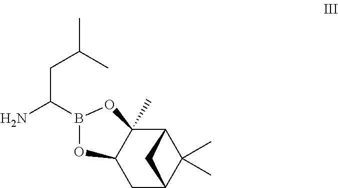 [SMILES: CC(C)CC(N)B1O[C@@H]2C[C@@H]3C[C@@H](C3(C)C)[C@]2(C)O1]

to form an amide of Formula IVa

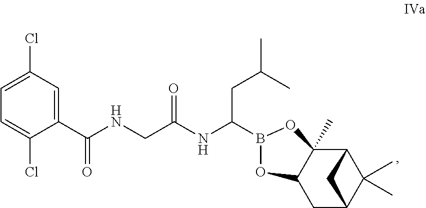

wherein X is OH or a leaving group;
(b) converting the amide of Formula IVa into a boronic ester of Formula Va

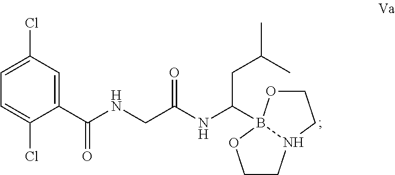

(c) crystallizing the boronic ester of Formula X from a solution of the boronic ester of Formula Va

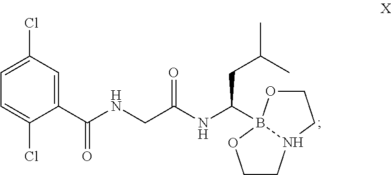

and
(d) converting the boronic ester of Formula X into Compound 1.

### Embodiment 9

A process for preparing Compound 1

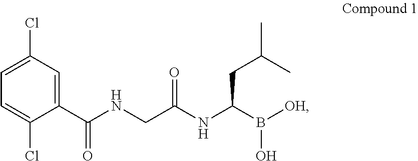 [SMILES: CC(C)C[C@H](NC(=O)CNC(=O)c1cc(Cl)ccc1Cl)B(O)O]

comprising the steps of:
(a) coupling a compound of Formula II

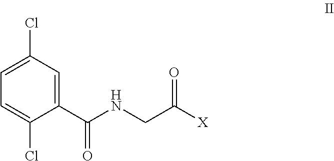

with an amine of Formula III

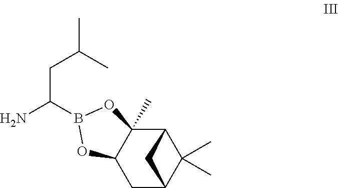 [SMILES: CC(C)CC(N)B1O[C@@H]2C[C@@H]3C[C@@H](C3(C)C)[C@]2(C)O1]

to form an amide of Formula IVa

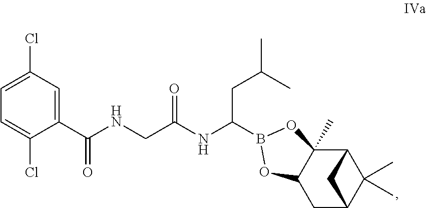

wherein X is OH or a leaving group;
(b) converting the amide of Formula IVa into a boronic ester of Formula Vb

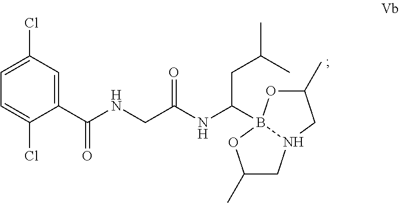

(c) crystallizing the boronic ester of Formula IX from a solution of the boronic ester of Formula Vb

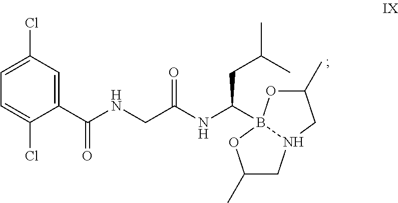

and
(d) converting the boronic ester of Formula IX into Compound 1.

### Embodiment 10

A process for purifying Compound 1

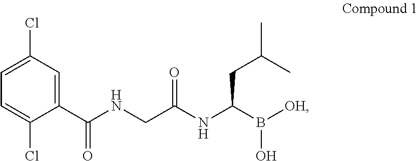 [SMILES: CC(C)C[C@H](NC(=O)CNC(=O)c1cc(Cl)ccc1Cl)B(O)O]

comprising the steps of:
(a) converting the Compound 1 into a boronic ester of Formula X

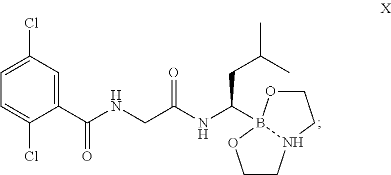

(b) crystallizing the boronic ester of Formula X from solution;
(c) isolating the crystallized boronic ester of Formula X from the solution; and
(d) converting the isolated boronic ester of Formula X into Compound 1.

### Embodiment 11

The process of Embodiment 10, further comprising the step of recrystallizing the boronic ester of Formula X after step (c) before performing step (d).

### Embodiment 12

A process for purifying Compound 1

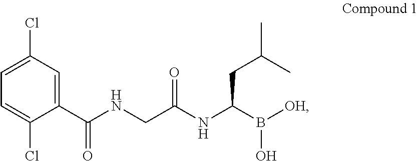 [SMILES: CC(C)C[C@H](NC(=O)CNC(=O)c1cc(Cl)ccc1Cl)B(O)O]

comprising the steps of:
(a) converting the Compound 1 into a boronic ester of Formula I×

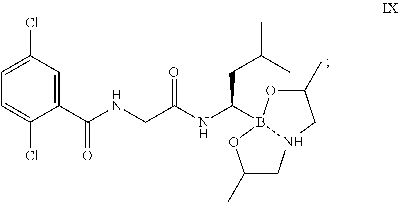

(b) crystallizing the boronic ester of Formula IX from solution;
(c) isolating the crystallized boronic ester of Formula IX from the solution; and
(d) converting the isolated boronic ester of Formula IX into Compound 1.

### Embodiment 13

The process of Embodiment 12, further comprising the step of recrystallizing the boronic ester of Formula IX after step (c) before performing step (d).

### Embodiment 14

A process for preparing a pharmaceutical composition of Compound 1

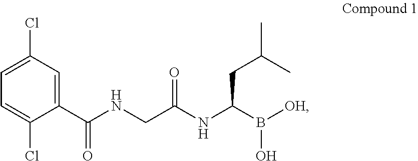 [SMILES: CC(C)C[C@H](NC(=O)CNC(=O)c1cc(Cl)ccc1Cl)B(O)O]

comprising the steps of:
(a) mixing in any order:
   (i) a boronic ester of Formula I

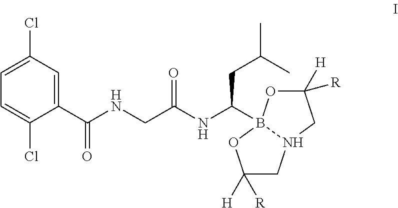

wherein R is H or methyl;
(ii) water, and
(iii) a bulking agent; and
(b) lyophilizing the mixture.

### Embodiment 15

A process for preparing a pharmaceutical composition of Compound 1

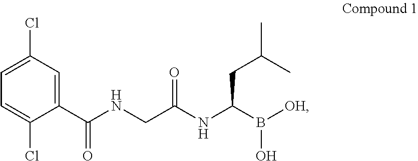 [SMILES: CC(C)C[C@H](NC(=O)CNC(=O)c1cc(Cl)ccc1Cl)B(O)O]

comprising the steps of:
(a) converting a boronic ester of Formula I,

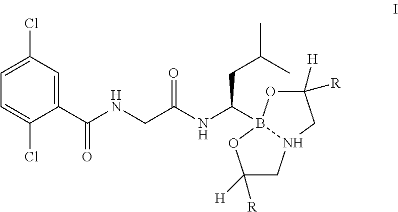

wherein R is H or methyl,
into Compound 1; and
(b) combining the Compound 1 with a pharmaceutically acceptable excipient.

### Embodiment 16

A process for preparing a pharmaceutical composition of Compound 1

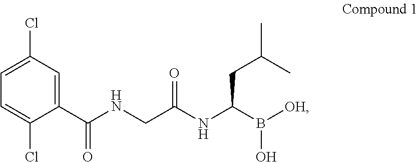 [SMILES: CC(C)C[C@H](NC(=O)CNC(=O)c1cc(Cl)ccc1Cl)B(O)O]

comprising the steps of:
(a) combining a boronic ester of Formula I,

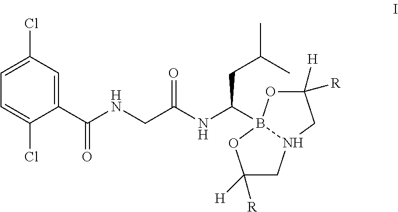

wherein R is H or methyl,
with a pharmaceutically acceptable excipient; and
(b) converting the boronic ester of Formula I into Compound 1.

### Embodiment 17

A process for preparing a pharmaceutical composition of Compound 1

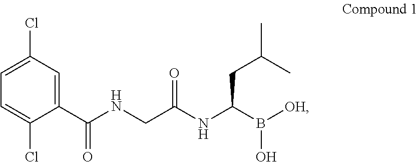 [SMILES: CC(C)C[C@H](NC(=O)CNC(=O)c1cc(Cl)ccc1Cl)B(O)O]

comprising the steps of:
(a) converting a boronic ester of Formula I,

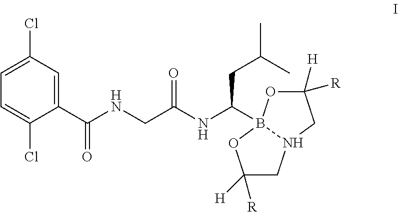

wherein R is H or methyl,
into Compound 1; and
(b) combining the Compound 1 with a bulking agent.

### Embodiment 18

A process for preparing a pharmaceutical composition of Compound 1

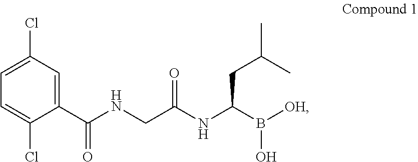 [SMILES: CC(C)C[C@H](NC(=O)CNC(=O)c1cc(Cl)ccc1Cl)B(O)O]

comprising the steps of:
(a) combining a boronic ester of Formula I,

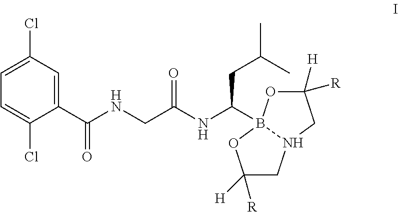

wherein R is H or methyl,
with a bulking agent; and
(b) converting the boronic ester of Formula I into Compound 1.

### Embodiment 19

The process of any of Embodiments 14, 17, or 18, wherein the bulking agent comprises mannitol.

### Embodiment 20

The process of any of Embodiments 14 to 19, wherein R is H.

### Embodiment 21

The process of any of Embodiments 14 to 19, wherein R is methyl.

### Embodiment 22

The process of any of Embodiments 14 to 21, wherein the pharmaceutical composition comprises a cyclodextrin.

### Embodiment 23

The process of Embodiment 22, wherein the pharmaceutical composition comprises hydroxypropyl-β-cyclodextrin.

### Embodiment 23a

The process of Embodiment 22, wherein the pharmaceutical composition comprises (3-cyclodextrin sulfobutyl ether.

### Embodiment 24

A process for preparing Compound 1

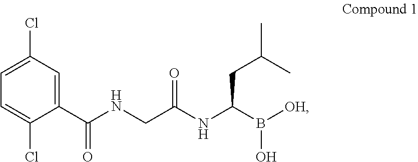 [SMILES: CC(C)C[C@H](NC(=O)CNC(=O)c1cc(Cl)ccc1Cl)B(O)O]

comprising the step of converting a boronic ester of Formula I into Compound 1

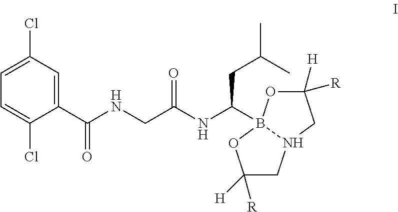

wherein R is H or methyl.

### Embodiment 25

The process of Embodiment 24, wherein R is H.

### Embodiment 26

The process of Embodiment 24, wherein R is methyl.

### Embodiment 27

A process for preparing Compound 1

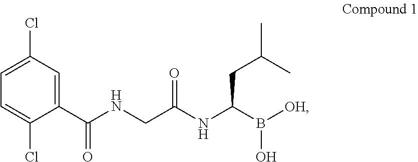 [SMILES: CC(C)C[C@H](NC(=O)CNC(=O)c1cc(Cl)ccc1Cl)B(O)O]

comprising the step of converting a boronic ester of Formula X into Compound 1

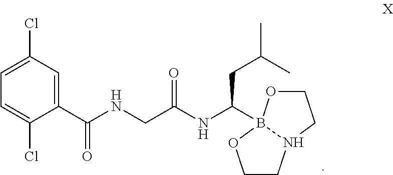

### Embodiment 28

A process for preparing Compound 1

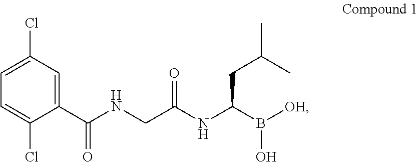 [SMILES: CC(C)C[C@H](NC(=O)CNC(=O)c1cc(Cl)ccc1Cl)B(O)O]

comprising the steps of
(a) crystallizing a boronic ester of Formula I from a solution of a boronic ester of Formula V

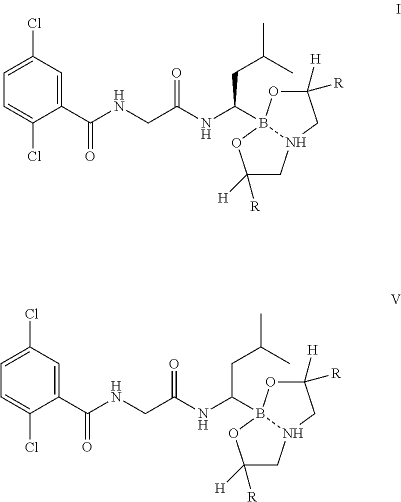

wherein R is H or methyl; and
(b) converting the boronic ester of Formula I into Compound 1.

### Embodiment 29

The process of Embodiment 28, wherein R is H.

### Embodiment 30

The process of Embodiment 28, wherein R is methyl.

### Embodiment 31

A process for preparing Compound 1

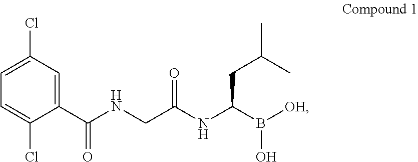 [SMILES: CC(C)C[C@H](NC(=O)CNC(=O)c1cc(Cl)ccc1Cl)B(O)O]

comprising the steps of:
(a) preparing an amide of Formula IV

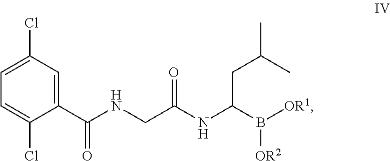

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula Va, converting the amide of Formula IV into a boronic ester of Formula Va

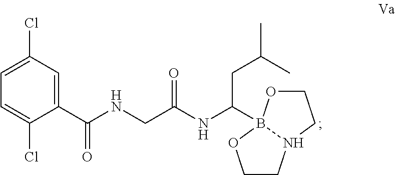

(c) crystallizing the boronic ester of Formula X from a solution of the boronic ester of Formula Va

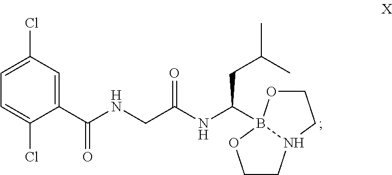

and
(d) converting the boronic ester of Formula X into Compound 1.

### Embodiment 32

A process for preparing Compound 1

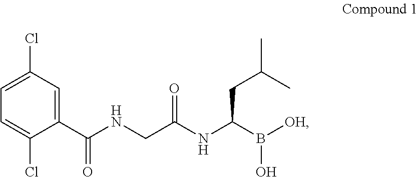 [SMILES: CC(C)C[C@H](NC(=O)CNC(=O)c1cc(Cl)ccc1Cl)B(O)O]

comprising the steps of:
(a) preparing an amide of Formula IV

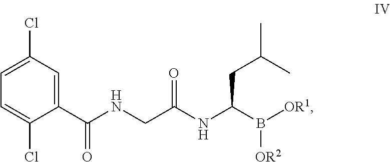

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula Vb, converting the amide of Formula IV into a boronic ester of Formula Vb

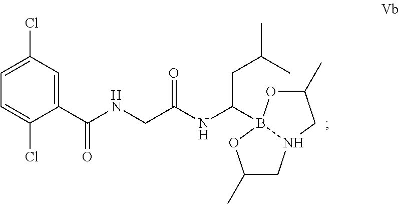

(c) crystallizing the boronic ester of Formula IX from a solution of the boronic ester of Formula VA

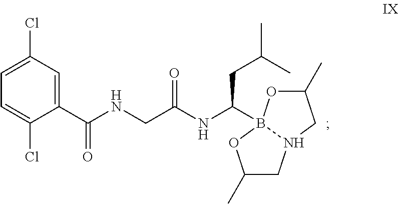

and
(d) converting the boronic ester of Formula IX into Compound 1.

### Embodiment 33

The process of Embodiment 31, further comprising the step of recrystallizing the boronic ester of Formula X after step (c) before performing step (d).

### Embodiment 34

The process of Embodiment 32, further comprising the step of recrystallizing the boronic ester of Formula IX after step (c) before performing step (d).

### Embodiment 35

The process of any of Embodiments 31 to 34, wherein R¹ and R², together with the boron and oxygen atoms to which they are attached, form an optionally substituted 5-8 membered carbon-containing ring having 0-2 additional heteroatoms chosen from nitrogen, oxygen, and sulfur.

### Embodiment 36

The process of Embodiment 35, wherein R¹ and R², together with the boron and oxygen atoms to which they are attached, form an optionally substituted 5-8 membered carbon-containing ring having 0-1 additional nitrogen atoms, wherein the atoms other than the ring boron atom are derived from a chiral diol.

### Embodiment 37

The process of Embodiment 36, wherein the atoms other than the ring boron atom are derived from (1S,2S,3S,5R)-(+)-pinanediol, so that the amide of Formula IV has the following structure

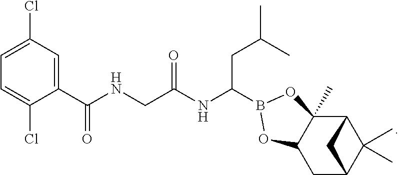

### Embodiment 38

A process for preparing Compound 1

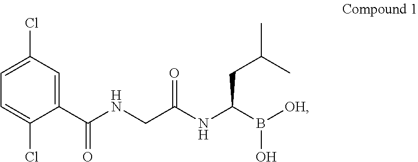 [SMILES: CC(C)C[C@H](NC(=O)CNC(=O)c1cc(Cl)ccc1Cl)B(O)O]

comprising the steps of:
(a) preparing an amide of Formula IVa

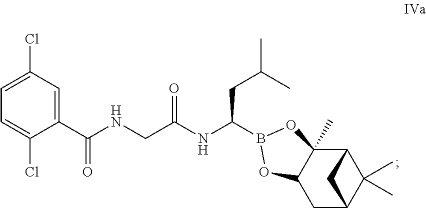

(b) converting the amide of Formula IVa into a boronic ester of Formula Va

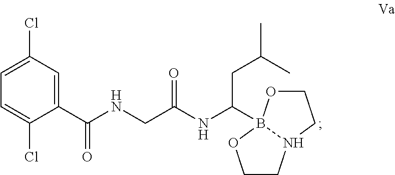

(c) crystallizing the boronic ester of Formula X from a solution of the boronic ester of Formula Va

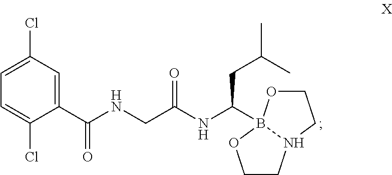

and
(d) converting the boronic ester of Formula X into Compound 1.

### Embodiment 39

A process for preparing Compound 1

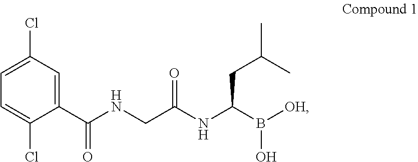 [SMILES: CC(C)C[C@H](NC(=O)CNC(=O)c1cc(Cl)ccc1Cl)B(O)O]

comprising the steps of:
(a) preparing an amide of Formula IVa

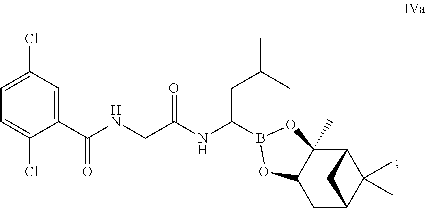

(b) converting the amide of Formula IVa into a boronic ester of Formula Vb

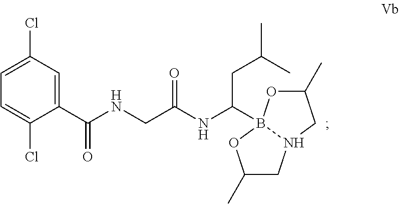

(c) crystallizing the boronic ester of Formula IX from a solution of the boronic ester of Formula Vb

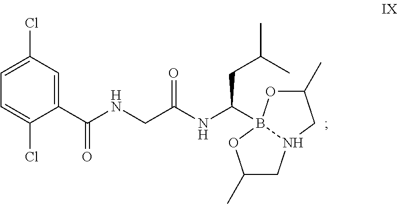

and
(d) converting the boronic ester of Formula IX into Compound 1.

### Embodiment 40

A process for preparing a boronic ester of Formula I

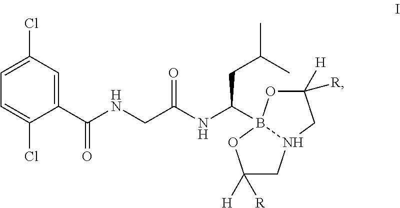

wherein R is H or methyl,
comprising the steps of:
(a) preparing an amide of Formula IV

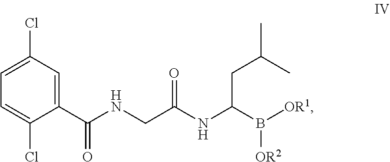

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

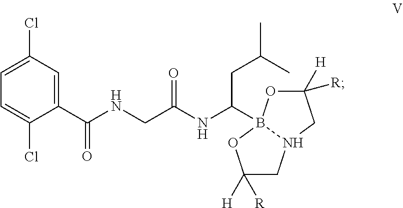

and
(c) crystallizing the boronic ester of Formula I from a solution of the boronic ester of Formula V.

### Embodiment 41

A process for preparing a boronic ester of Formula I

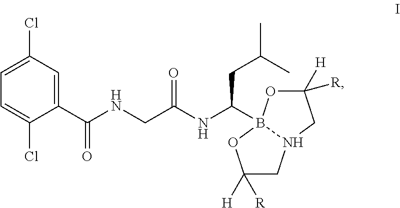

wherein R is H or methyl,
comprising the steps of:
(a) coupling a compound of Formula II

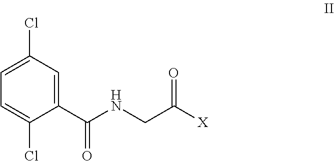

with an amine of Formula III

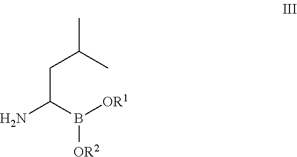

to form an amide of Formula IV

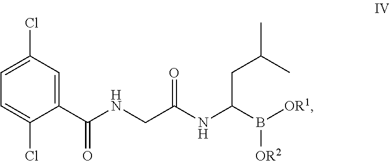

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

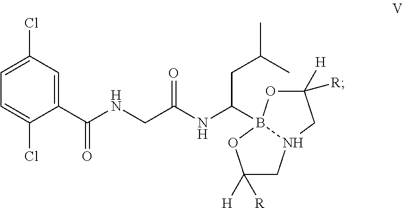

and
(c) crystallizing the boronic ester of Formula I from a solution of the boronic ester of Formula V.

### Embodiment 42

A process for preparing a boronic ester of Formula I

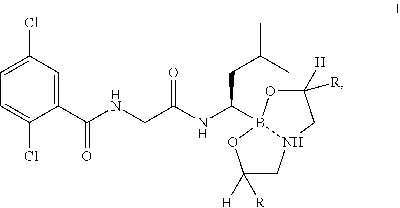

wherein R is H or methyl,
comprising the steps of:
(a) preparing a boronic ester of Formula V

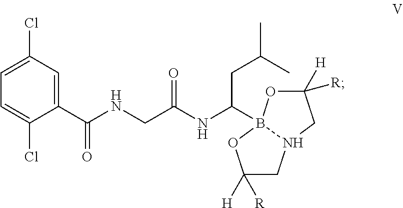

and
(b) crystallizing the boronic ester of Formula I from a solution of the boronic ester of Formula V.

### Embodiment 43

A process for preparing Compound 1

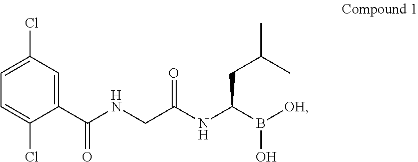 [SMILES: CC(C)C[C@H](NC(=O)CNC(=O)c1cc(Cl)ccc1Cl)B(O)O]

comprising the steps of:
(a) preparing an amide of Formula IV

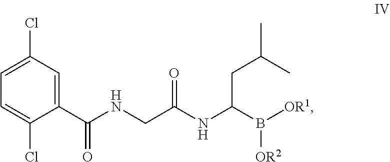

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

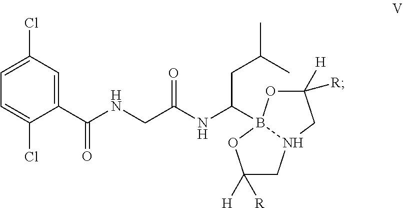

(c) crystallizing the boronic ester of Formula I from a solution of the boronic ester of Formula V

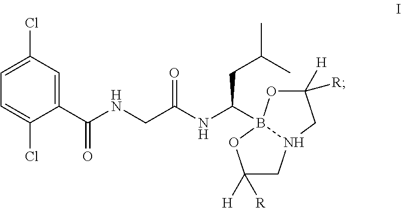

and
(d) converting the boronic ester of Formula I into Compound 1.

### Embodiment 44

A process for preparing Compound 1

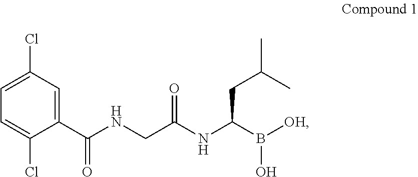 [SMILES: CC(C)C[C@H](NC(=O)CNC(=O)c1cc(Cl)ccc1Cl)B(O)O]

comprising the steps of:
(a) preparing a boronic ester of Formula V

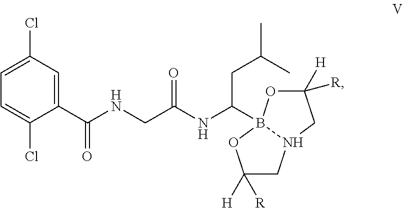

wherein R is H or methyl;
(b) crystallizing the boronic ester of Formula I from a solution of the boronic ester of Formula V

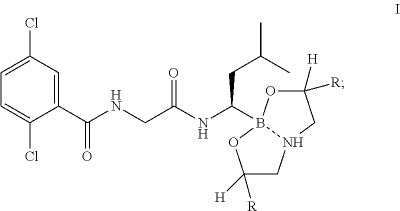

and
(c) converting the boronic ester of Formula I into Compound 1.

### Embodiment 45

A process for preparing Compound 1

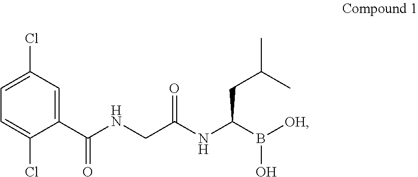 [SMILES: CC(C)C[C@H](NC(=O)CNC(=O)c1cc(Cl)ccc1Cl)B(O)O]

comprising the steps of:
(a) coupling a compound of Formula II

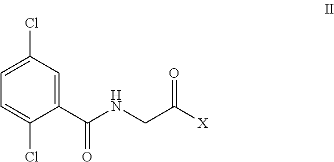

with an amine of Formula III

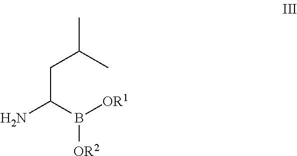

to form an amide of Formula IV

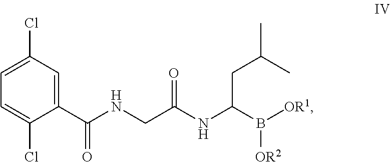

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula IV is not a boronic ester of Formula V, converting the amide of Formula IV into a boronic ester of Formula V

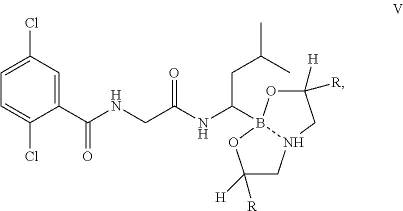

wherein R is H or methyl;
(c) crystallizing the boronic ester of Formula I from a solution of the boronic ester of Formula V

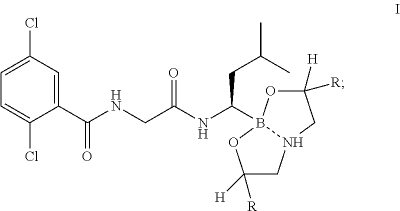

and
(d) converting the boronic ester of Formula I into Compound 1.

### Embodiment 46

A process for preparing Compound 1

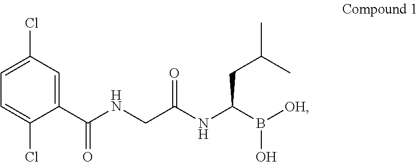 [SMILES: CC(C)C[C@H](NC(=O)CNC(=O)c1cc(Cl)ccc1Cl)B(O)O]

comprising the steps of
(a) crystallizing a boronic ester of Formula I from a solution of a boronic ester of Formula V

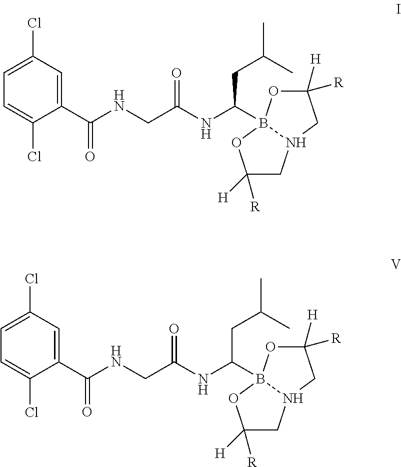

wherein R is H or methyl; and
(b) converting the boronic ester of Formula I into Compound 1.

### Embodiment 47

The process of any of Embodiments 40 to 46, wherein R is H.

### Embodiment 48

The process of any of Embodiments 40 to 46, wherein R is methyl.

### Embodiment 49

A process for purifying an amide of Formula VI

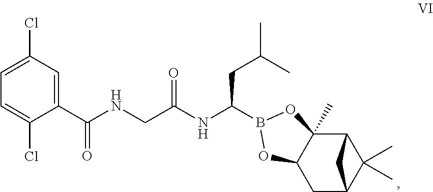 [SMILES: CC(C)C[C@H](NC(=O)CNC(=O)c1cc(Cl)ccc1Cl)B1O[C@@H]2C[C@@H]3C[C@@H](C3(C)C)[C@]2(C)O1]

comprising the steps of:
(a) converting the amide of Formula VI into the boronic ester of Formula X

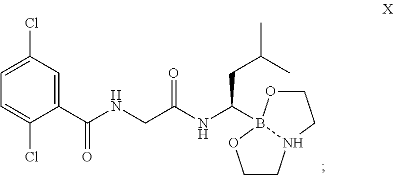

(b) crystallizing the boronic ester of Formula X from solution;
(c) isolating the crystallized boronic ester of Formula X from the solution; and
(d) converting the isolated boronic ester of Formula X back into the amide of Formula VI.

### Embodiment 66

A process for purifying an amide of Formula VI

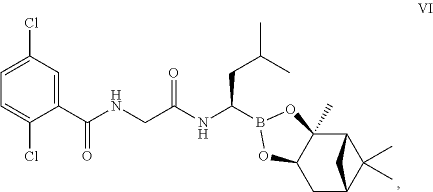 [SMILES: CC(C)C[C@H](NC(=O)CNC(=O)c1cc(Cl)ccc1Cl)B1O[C@@H]2C[C@@H]3C[C@@H](C3(C)C)[C@]2(C)O1]

comprising the steps of:
(a) converting the amide of Formula VI into the boronic ester of Formula IX

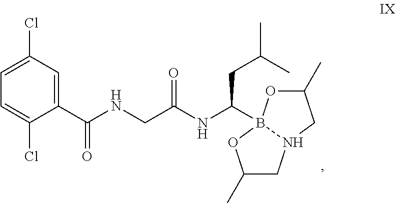

(b) crystallizing the boronic ester of Formula IX from solution;
(c) isolating the crystallized boronic ester of Formula IX from the solution; and
(d) converting the isolated boronic ester of Formula IX back into the amide of Formula VI.

### Embodiment 67

A boronic ester of Formula IX

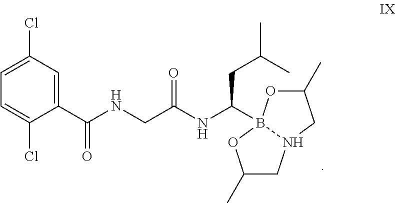

### Embodiment 68

A boronic ester of Formula X

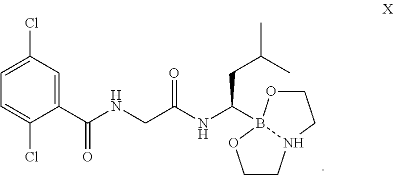

### Embodiment 69

A process for preparing a boronic ester of Formula I

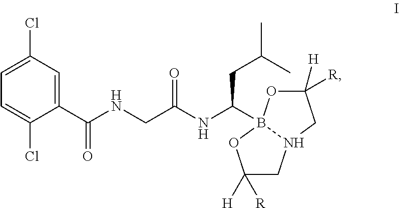

wherein R is H or methyl;
comprising the steps of:
(a) coupling a compound of Formula II

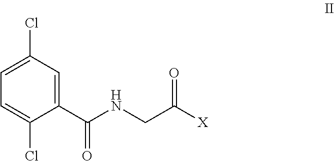

with an amine of Formula IIIb

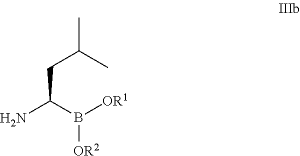

to form an amide of Formula VI

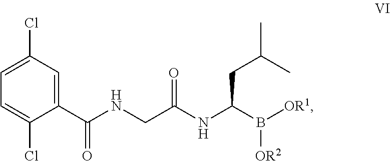

wherein
X is OH or a leaving group; and
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula VI is not a boronic ester of Formula I, converting the amide of Formula VI into a boronic ester of Formula I

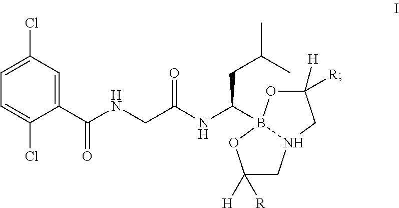

and
(c) crystallizing the boronic ester of Formula I.

### Embodiment 70

A process for preparing a boronic ester of Formula I

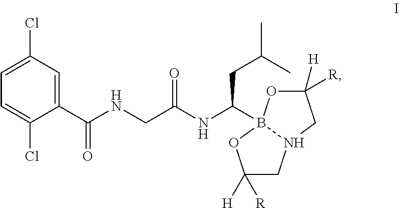

wherein R is H or methyl;
comprising the steps of:
(a) preparing an amide of Formula VI

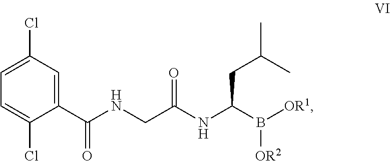

wherein
R¹ and R² are independently chosen from optionally substituted C₁₋₆alkyl, optionally substituted C₆₋₁₀aryl, optionally substituted C₇₋₁₆arylalkyl, optionally substituted C₃₋₁₁cycloalkyl, optionally substituted C₄₋₁₇cycloalkylalkyl, optionally substituted 3-15 membered heterocycloalkyl, optionally substituted 4-21 membered heterocycloalkylalkyl, optionally substituted 5-15 membered heteroaryl, and optionally substituted 6-21 membered heteroarylalkyl,
or R¹ and R², together with the boron and oxygen atoms to which they are attached, form an optionally substituted 5-10 membered carbon-containing ring having 0-2 additional heteroatoms chosen from nitrogen, oxygen and sulfur;
(b) if the amide of Formula VI is not a boronic ester of Formula I, converting the amide of Formula VI into a boronic ester of Formula I

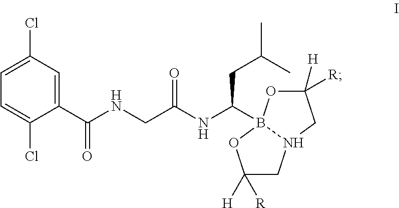

and
(c) crystallizing the boronic ester of Formula I.

### Embodiment 71

The process of Embodiments 69 or 70, wherein R is H.

### Embodiment 72

The process of Embodiments 69 or 70, wherein R is methyl.

### Embodiment 73

The process of any of Embodiments 69 to 72, wherein R¹ and R², together with the boron and oxygen atoms to which they are attached, form an optionally substituted 5-8 membered carbon-containing ring having 0-2 additional heteroatoms chosen from nitrogen, oxygen, and sulfur.

### Embodiment 74

The process of Embodiment 73, wherein R¹ and R², together with the boron and oxygen atoms to which they are attached, form an optionally substituted 5-8 membered carbon-containing ring having 0-1 additional nitrogen atoms, wherein the atoms other than the ring boron atom are derived from a chiral diol.

### Embodiment 75

The process of Embodiment 74, wherein the atoms other than the ring boron atom are derived from (1S,2S,3S,5R)-(+)-pinanediol, so that the amide of Formula VI has the following structure

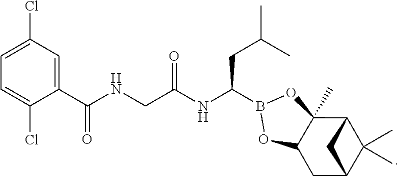

### EXAMPLES

### Preparation 1. Preparation of Compound 1

Compound 1 is obtained as a non-crystalline solid using the process set forth in US 2009/0325903. Compound 1 is obtained as a mixture of monomer and the trimer anhydride N,N′,N″-boroxin-2,4,6-triyltris {{(1R)-3-methylbutane-1,1-diyl]imino(2-oxoethane-2,1-diyl)]}tris(2,5-dichlorobenzamide) (H NMR analysis). The Compound 1 is stable when stored in the freezer, but is not storage stable under ambient conditions.

### Preparation 2. Preparation of Citric Acid Ester of Compound 1

The citric acid ester of Compound 1 (4-(R,S)-(carboxymethyl)-2-((R)-1-(2-(2,5-dichlorobenzamido)acetamido)-3-methylbutyl)-6-oxo-1,3,2-dioxaborinane-4-carboxylic acid) is obtained as a crystalline solid (Form 1 or Form 2) using the process set forth in US 2009/0325903. The citric acid ester of Compound 1 is stable when stored in the freezer.

### Example 1

### Preparation of 2,5-Dichloro-N—[(R)-1-[1,3,6,2]dioxazaborocan-2-yl-3-methyl-butylcarbamoyl)methyl]-benzamide (i.e., boronic ester of Formula X)

A 100 mL three neck round bottom flask equipped with a stir bar, thermocouple and nitrogen inlet is charged with 6.0 g (16.6 mmol) of Compound 1 (98.5A % purity) and 60 mL of ethyl acetate then stirred for five minutes at room temperature to dissolve the solids. Diethanol amine (1.68 g, 16.0 mmol) is charged and solids begin to form when addition is only ⅔ complete. The white slurry is stirred at room temperature for two hours and then the solids are collected by vacuum filtration, washed with 50 mL of ethyl acetate and dried overnight in a vacuum oven at 40° C. A quantitative yield of the desired product is obtained as a crystalline solid with an HPLC purity of 99.7A %. After storing for approximately one (1) year at ambient indoor temperature and humidity (in a vial at the rear of a fume hood), the HPLC purity was 99.9A %. ¹H NMR (d₆-DMSO, 400 MHz) δ 8.8 (t, 1H, J=5.88 Hz), 7.55 (s, 2H), 7.52 (s, 1H), 6.99 (d, 1H, J=8.36 Hz), 6.57 (s, b, 1H), 3.85 (dq, 1H, J=16.1, 5.92 Hz), 3.69 (m, 2H), 3.57 (m, 1H), 3.14 (m, 1H), 2.99 (m, 2H), 2.75 (m, 1H), 2.69 (m, 1H), 1.59 (m, 1H), 1.31 (m, 1H), 1.22 (m, 1H), 0.824 (d, 3H, J=6.64 Hz), 0.797 (D, 3 h, J=6.48 Hz)

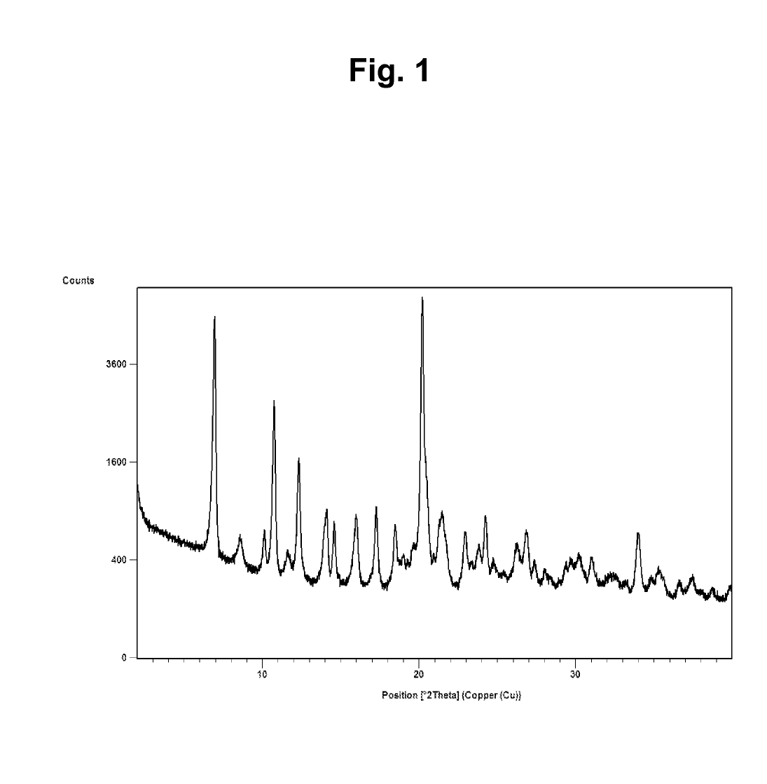

The diethanolamine ester of Compound 1 (i.e., boronic ester of Formula X) is a crystalline solid having an x-ray powder diffraction (XRPD) pattern as shown in FIG. 1. Representative peaks are provided in Table 1.

TABLE 1
XRPD peaks of diethanolamine ester of Compound 1 (boronic ester of
Formula X).

| | | FWHM | | |
|---|---|---|---|---|
| Pos. [°2Th.] | Height [cts] | Left [°2Th.] | d-spacing [Å] | Rel. Int. [%] |
| 6.931843 | 4177.605000 | 0.163200 | 12.74172 | 82.48 |
| 8.584069 | 218.165400 | 0.230400 | 10.29260 | 4.31 |
| 10.162190 | 352.837500 | 0.172800 | 8.69750 | 6.97 |
| 10.754760 | 2464.081000 | 0.067200 | 8.21957 | 48.65 |
| 11.604730 | 165.471300 | 0.153600 | 7.61938 | 3.27 |
| 12.331190 | 1372.129000 | 0.172800 | 7.17209 | 27.09 |
| 14.139950 | 588.367900 | 0.134400 | 6.25845 | 11.62 |
| 14.598650 | 512.961900 | 0.134400 | 6.06282 | 10.13 |
| 15.972880 | 590.662200 | 0.076800 | 5.54416 | 11.66 |
| 17.285960 | 708.912200 | 0.192000 | 5.12586 | 14.00 |
| 18.496360 | 475.972400 | 0.172800 | 4.79306 | 9.40 |
| 19.026600 | 199.125100 | 0.153600 | 4.66067 | 3.93 |
| 19.576140 | 254.389900 | 0.230400 | 4.53106 | 5.02 |
| 20.202150 | 5065.073000 | 0.086400 | 4.39204 | 100.00 |
| 20.250900 | 4800.745000 | 0.048000 | 4.38158 | 94.78 |
| 21.307590 | 523.986700 | 0.134400 | 4.16661 | 10.35 |
| 21.512290 | 626.538300 | 0.192000 | 4.12742 | 12.37 |
| 22.967340 | 408.682600 | 0.268800 | 3.86913 | 8.07 |
| 23.854970 | 263.288500 | 0.268800 | 3.72713 | 5.20 |
| 24.245260 | 570.679300 | 0.192000 | 3.66801 | 11.27 |
| 24.718470 | 93.328460 | 0.192000 | 3.59885 | 1.84 |
| 26.288420 | 245.297400 | 0.345600 | 3.38738 | 4.84 |
| 26.811420 | 368.972700 | 0.153600 | 3.32248 | 7.28 |
| 27.398940 | 125.787300 | 0.230400 | 3.25255 | 2.48 |
| 28.039270 | 71.986620 | 0.192000 | 3.17971 | 1.42 |

### Example 2

### Preparation of 2,5-Dichloro-N—[(R)-1-[1,3,6,2]dioxazaborocan-2-yl-3-methyl-butylcarbamoyl)methyl]-benzamide (i.e., boronic ester of Formula X)

A 25 mL three neck round bottom flask equipped with a stir bar, thermocouple and nitrogen inlet is charged with 1.5 g (4.15 mmol) of Compound 1 (98.17A % purity) and 15 mL of ethyl acetate then stirred for five minutes at room temperature to dissolve the solids. Diethanol amine (0.44 g, 4.15 mmol) is charged and solids begin to form when addition is only ⅔ complete. The white slurry is stirred at room temperature for two hours and then the solids are collected by vacuum filtration, washed with 50 mL of ethyl acetate and dried overnight in a vacuum oven at 40° C. A total of 1.79 g (4.16 mmol, 100%) of the desired product is obtained with an HPLC purity of 99.2A %. XRPD and NMR are consistent with the sample prepared in Example 1.

### Example 3

### Preparation of 2,5-Dichloro-N-{[(R)-1-(4,8-dimethyl-[1,3,6,2]dioxazaborocan-2-yl)-3-methyl-butylcarbamoyl]-methyl}benzamide (i.e., boronic ester of Formula IX)

A 15 mL one neck round bottom flask equipped with a stir bar and nitrogen inlet is charged with 0.5 g (1.39 mmol) of Compound 1 (98.5A % purity) and 5 mL of ethyl acetate then stirred for five minutes at room temperature to dissolve the solids. Diisopropanolamine (185 mg, 1.39 mmol) is charged and stirred at room temperature. The white precipitate is collected by vacuum filtration, washed with 5 mL of ethyl acetate and dried overnight under nitrogen on the filter to give 410 mg (0.895 mmol, 64%) of the desired product with an HPLC purity of 99.4A %. After storing for approximately one (1) year at ambient indoor temperature and humidity (in a vial at the rear of a fume hood), the HPLC purity was 99.8A %. ¹H NMR (d₆-DMSO, 400 MHz) δ 8.8 (m, 1H), 7.54 (t, 2H, J=1.08 Hz), 7.52 (s, 1H), 7.2 (m, 0.25H), 6.8 (m, 0.75H), 6.7 (m, 0.75H), 6.5 (m, 0.25H), 3.9 (m, b, 4H), 2.9 (m, b, 2H), 2.5 (m, b, 2H), 2.0 (m, 1H), 1.6 (m, 1H), 1.3 (m, 1H), 1.2 (m, 1H), 1.1 (d, 3H, J=6.04 Hz), 1.0 (d, 3H, J=5.92 Hz), 0.82 (d, 3H, J=6.6 Hz), 0.79 (d, 3H, J=6.6 Hz).

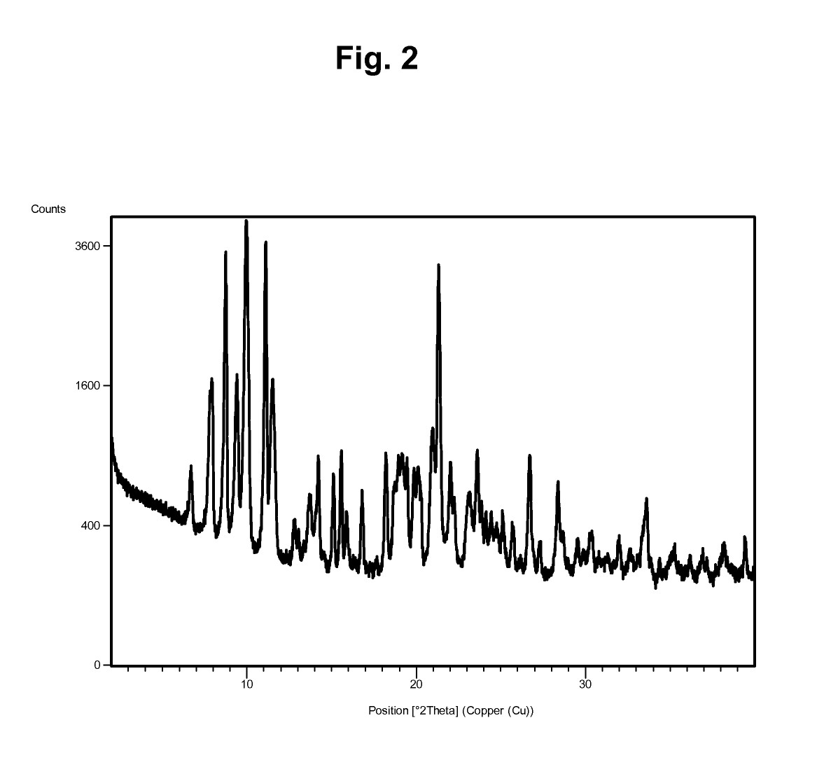

The diisopropanolamine ester of Compound 1 (i.e., boronic ester of Formula IX) is a crystalline solid having an x-ray powder diffraction (XRPD) pattern as shown in FIG. 2. Representative peaks are provided in Table 2.

TABLE 2
XRPD peaks of diisopropanolamine ester of Compound 1 (boronic ester
of Formula IX).

| | | | FWHM | |
|---|---|---|---|---|
| Rel. Int. [%] | Pos. [°2Th.] | Height [cts] | Left [°2Th.] | d-spacing [Å] |
| 10.6 | 6.702 | 395 | 0.154 | 13.1778 |
| 29.9 | 7.807 | 1119 | 0.115 | 11.3147 |
| 34.1 | 7.964 | 1275 | 0.038 | 11.0920 |
| 86.3 | 8.747 | 3227 | 0.077 | 10.1010 |
| 60.6 | 8.793 | 2265 | 0.038 | 10.0482 |
| 37.2 | 9.403 | 1392 | 0.086 | 9.3978 |
| 100.0 | 9.951 | 3738 | 0.269 | 8.8813 |
| 89.5 | 11.132 | 3344 | 0.134 | 7.9416 |
| 30.7 | 11.438 | 1149 | 0.096 | 7.7299 |
| 37.9 | 11.534 | 1415 | 0.134 | 7.6658 |
| 5.0 | 12.849 | 188 | 0.154 | 6.8840 |
| 4.0 | 13.045 | 149 | 0.096 | 6.7813 |
| 10.1 | 13.732 | 377 | 0.269 | 6.4432 |
| 18.7 | 14.226 | 700 | 0.077 | 6.2207 |
| 15.1 | 15.115 | 566 | 0.077 | 5.8569 |
| 18.4 | 15.588 | 687 | 0.154 | 5.6800 |
| 7.3 | 15.893 | 273 | 0.154 | 5.5720 |
| 11.9 | 16.800 | 443 | 0.154 | 5.2731 |
| 1.1 | 17.672 | 43 | 0.154 | 5.0146 |
| 18.9 | 18.241 | 708 | 0.154 | 4.8595 |

### Example 4

### Preparation of 2,5-Dichloro-N—[(R)-3-methyl-1-(6-methyl-[1,3,6,2]dioxazaborocan-2-yl)-butylcarbamoyl]-methylbenzamide (i.e., N-methyldiethanol amine ester of Compound 1)

A 15 mL one neck round bottom flask equipped with a stir bar and nitrogen inlet is charged with 0.5 g (1.39 mmol) of Compound 1 (98.5A % purity) and 5 mL of ethyl acetate then stirred for five minutes at room temperature to dissolve the solids. N-Methyldiethanol amine (166 mg, 1.39 mmol) is charged and stirred at room temperature overnight. The white precipitate is collected by vacuum filtration, washed with 5 mL of ethyl acetate and dried overnight under nitrogen on the filter to give 410 mg (0.92 mmol, 66%) of the desired product with an HPLC purity of 97.9A %. After storing for approximately one (1) year at ambient indoor temperature and humidity (in a vial at the rear of a fume hood), the HPLC purity was 99.6A %. ¹H NMR (d₆-DMSO, 400 MHz) δ 8.95 (t, 1H, J=5.96 Hz), 7.56 (s, 2H), 7.49 (s, 1H), 6.5 (d, 1H, J=9.88 Hz), 3.77 (d, 2H, J=6.08 Hz), 3.72 (m, 3H), 3.62 (m, 1H), 3.2 (m, 3H), 3.1 (m, 1H), 2.9 (m, 1H), 2.59 (s, 3H), 1.51 (m 1H), 1.23 (dq, 2H, J=8.92, 4.28 Hz), 0.835 (d, 3H, J=6.48 Hz), 0.803 (d, 3H, J=6.68 Hz).

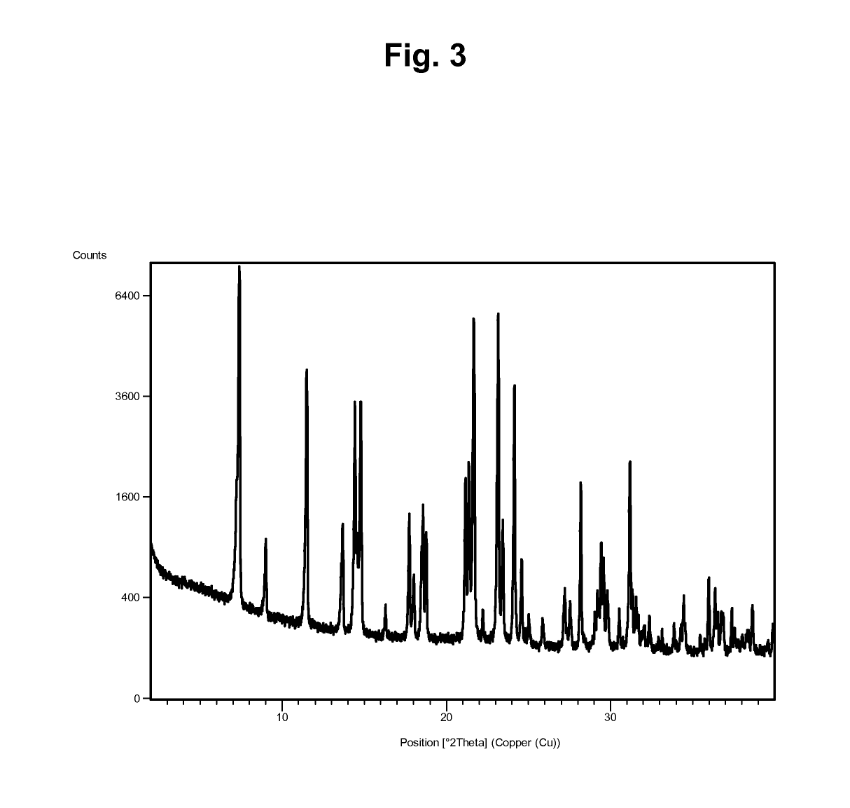

The N-methyldiethanol amine ester of Compound 1 is a crystalline solid having an x-ray powder diffraction (XRPD) pattern as shown in FIG. 3. Representative peaks are provided in Table 3.

TABLE 3
XRPD peaks of N-methyldiethanol amine ester of Compound 1.

| | | | FWHM | |
|---|---|---|---|---|
| Rel. Int. [%] | Pos. [°2Th.] | Height [cts] | Left [°2Th.] | d-spacing [Å] |
| 21.5 | 7.216 | 1427 | 0.058 | 12.2406 |
| 100.0 | 7.403 | 6631 | 0.096 | 11.9315 |
| 10.9 | 9.002 | 720 | 0.077 | 9.8153 |
| 61.6 | 11.502 | 4086 | 0.086 | 7.6870 |
| 11.9 | 13.712 | 789 | 0.067 | 6.4528 |
| 50.5 | 14.433 | 3349 | 0.077 | 6.1321 |
| 14.0 | 14.556 | 928 | 0.058 | 6.0805 |
| 50.6 | 14.794 | 3352 | 0.086 | 5.9832 |
| 2.7 | 16.293 | 178 | 0.077 | 5.4359 |
| 18.3 | 17.748 | 1216 | 0.077 | 4.9935 |
| 7.1 | 18.021 | 468 | 0.086 | 4.9184 |
| 10.5 | 18.485 | 697 | 0.058 | 4.7960 |
| 19.4 | 18.568 | 1288 | 0.067 | 4.7747 |
| 14.2 | 18.775 | 943 | 0.106 | 4.7225 |
| 26.5 | 21.179 | 1754 | 0.086 | 4.1917 |
| 31.5 | 21.363 | 2086 | 0.086 | 4.1559 |
| 84.9 | 21.678 | 5633 | 0.134 | 4.0963 |
| 2.5 | 22.224 | 168 | 0.077 | 3.9968 |
| 86.3 | 23.162 | 5721 | 0.086 | 3.8371 |
| 16.1 | 23.448 | 1070 | 0.077 | 3.7909 |

### Example 5

### Preparation of 2,5-Dichloro-N—{[(R)-3-methyl-1-(6-methyl-4,8-dioxo-[1,3,6,2]dioxazaborocan-2-yl)-butylcarbamoyl]-methyl}benzamide (i.e., N-methylimino diacetic acid ester of Compound 1)

A 250 mL three neck round bottom flask equipped with a stir bar, thermocouple, Dean-Stark trap, condenser, nitrogen outlet, heating mantle and controller is charged with 1.0 g (2.77 mmol) of Compound 1 (97.9A % purity), 50 mL of toluene, 10 mL of DMSO and 0.42 g (2.77 mmol) of N-methylimino diacetic acid. The reaction is heated to reflux and agitated for 18 hours while removing water via the Dean-Stark trap. After cooling to room temperature the solvent is removed in vacuo and the residue is partitioned between dichloromethane (50 mL) and DI water (50 mL). After separating the layers, the organic phase is washed with water (2×50 mL), dried over sodium sulfate, filtered and concentrated to dryness in vacuo to give the desired product as a white solid. A total of 1.09 g (2.3 mmol, 83.4%) is isolated with an HPLC purity of 98.4A %. After storing for approximately one (1) year at ambient indoor temperature and humidity (in a vial at the rear of a fume hood), the HPLC purity was 84.4A %. ¹H NMR (d₆-DMSO, 400 MHz) δ 8.8 (t, b, 1H), 7.64 (s, 2H), 7.63 (s, 1H), 7.34 (d, 1H, J=1.8 Hz), 4.15 (dd, 2H, J=16.72, 5.84), 3.9 (ddd, 2H, J=16.56, 16.51 Hz), 3.89 (m, 1H), 3.8 (dd, 1H), 3.77 (dt, 1H), 3.9 (s, 3H), 1.57 (m, b, 1H), 1.42 (t, b, 1H), 1.24 (t, b, 1H), 0.90 (d, 3H, J=6.44 Hz), 0.87 (d, 3H, J=6.56 Hz).

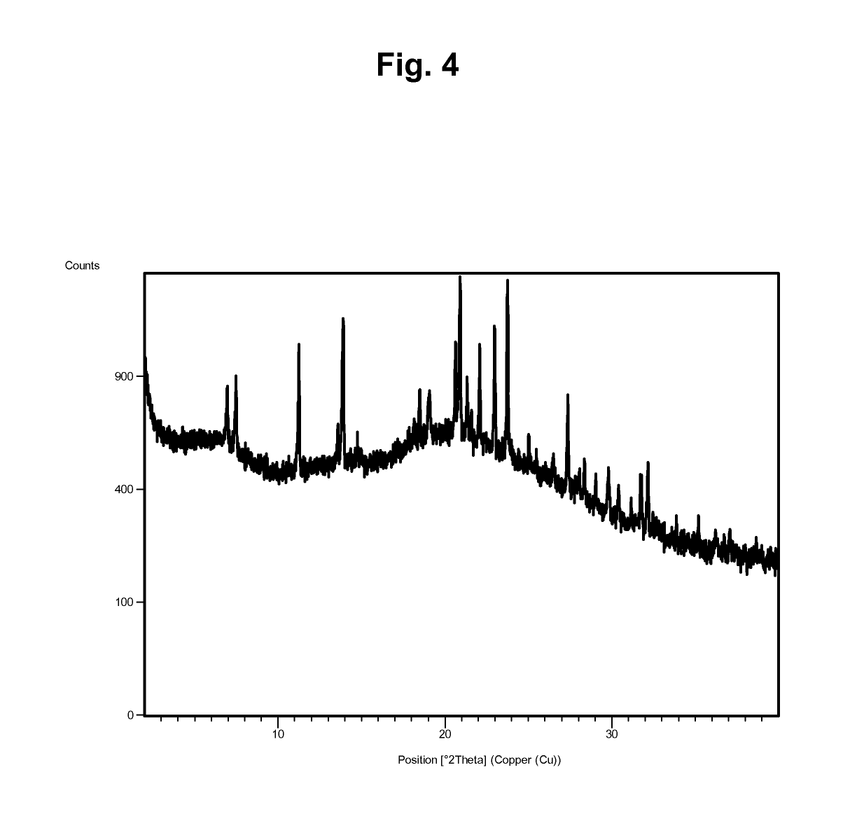

The N-methylimino diacetic acid ester of Compound 1 has an x-ray powder diffraction (XRPD) pattern as shown in FIG. 4. Representative peaks are provided in Table 4.

TABLE 4
XRPD peaks of N-methylimino diacetic acid ester of Compound 1.

| | | | FWHM | |
|---|---|---|---|---|
| Rel. Int. [%] | Pos. [°2Th.] | Height [cts] | Left [°2Th.] | d-spacing [Å] |
| 27.5 | 6.957 | 267 | 0.058 | 12.6961 |
| 34.3 | 7.491 | 333 | 0.048 | 11.7918 |
| 64.0 | 11.260 | 621 | 0.058 | 7.8519 |
| 16.9 | 13.591 | 164 | 0.058 | 6.5101 |
| 73.9 | 13.922 | 717 | 0.067 | 6.3559 |
| 10.2 | 18.177 | 99 | 0.115 | 4.8767 |
| 24.1 | 18.483 | 233 | 0.077 | 4.7964 |
| 18.8 | 19.059 | 183 | 0.154 | 4.6529 |
| 50.9 | 20.644 | 494 | 0.067 | 4.2991 |
| 88.2 | 20.921 | 856 | 0.067 | 4.2427 |
| 30.3 | 21.334 | 294 | 0.077 | 4.1615 |
| 14.5 | 21.591 | 141 | 0.058 | 4.1125 |
| 53.7 | 22.082 | 521 | 0.077 | 4.0223 |
| 66.8 | 22.982 | 648 | 0.067 | 3.8667 |
| 100.0 | 23.758 | 971 | 0.077 | 3.7421 |
| 13.9 | 25.022 | 135 | 0.096 | 3.5559 |
| 5.4 | 25.455 | 53 | 0.230 | 3.4964 |
| 9.8 | 26.504 | 95 | 0.115 | 3.3603 |
| 42.7 | 27.360 | 414 | 0.067 | 3.2571 |
| 9.2 | 28.064 | 90 | 0.115 | 3.1770 |

### Example 6

### Comparative Bioavailability of Citric Acid Ester of Compound 1 and Boronic Ester of Formula X)

General Methods.

Three adult male Sprague Dawley rats are used in each treatment group. The rats are fasted overnight prior to oral dose administration. Intravenous (IV) administration is via the lateral tail vein and oral doses are administered by gavage. The compound is administered iv or orally in a vehicle of phosphate buffered saline.

For blood collection, each rat (unanesthetized) is placed in a clear Plexiglas® restraining tube, and blood samples (approximately 0.25 mL) are drawn from a lateral tail vein into heparinized collection tubes at predetermined sampling times (0.083, 0.25, 0.5, 1, 2, 4, and 6 hours post dose). No pre-dose samples are obtained. The exception to this procedure is the last sampling time in which the animals are sacrificed by decapitation and trunk blood is obtained rather than blood via a tail vein. The blood samples are placed on wet ice until centrifuged to separate plasma. The whole blood and the plasma fraction are transferred into clean dry tubes, frozen on dry ice and stored at approximately −20° C. pending analysis.

Blood or plasma is prepared for high performance liquid chromatography (HPLC)/mass spectrometric analysis according to standard protocol following protein precipitation with acetonitrile containing an internal standard. The blood or plasma samples are then analyzed for Compound 1 and alprenolol (internal standard) via HPLC coupled with tandem mass spectrometry.

The blood and plasma concentration data for all rats are entered into Excel spreadsheets in preparation for pharmacokinetic analysis. Pharmacokinetic parameters for Compound 1 are estimated for each rat by non-compartmental analysis (Gibaldi M, Perrier D. Pharmacokinetics, 2^{nd} edition, Marcel Dekker, New York, Chapter 11, 1982) of the blood or plasma concentration versus time data using WinNonlin software (Professional Version 4.1a, Pharsight Corporation, Palo Alto, Calif., 2003).

The maximum blood or plasma concentration (Cmax) is the highest observed concentration after an oral dose; tₘₐₓ is the corresponding time when Cmax is observed. The terminal rate constant for elimination from blood or plasma (β) is estimated by linear regression of the terminal portion of the semi-logarithmic plasma concentration versus time curve. The apparent terminal half-life (t_{1/2}) is calculated as 0.693 divided by β. The area under the blood or plasma concentration versus time curve from time zero to the time of the last measurable concentration (AUC₀₋ₜ) after a single dose is determined by the linear trapezoidal rule. The area from zero to infinity (AUC_{0-∞}) is calculated as the sum of AUC₀₋ₜ and the area extrapolated from the last measurable concentration to infinity (Cₗₐₛₜ/β). Concentrations pre dose are all assumed to be zero for the purpose of calculation of the AUC. Oral bioavailability is determined by dividing the dose normalized oral AUC_{0-∞} by the AUC_{1-∞} from iv dosing and multiplying by 100 to express the ratio as a percent.

Results.

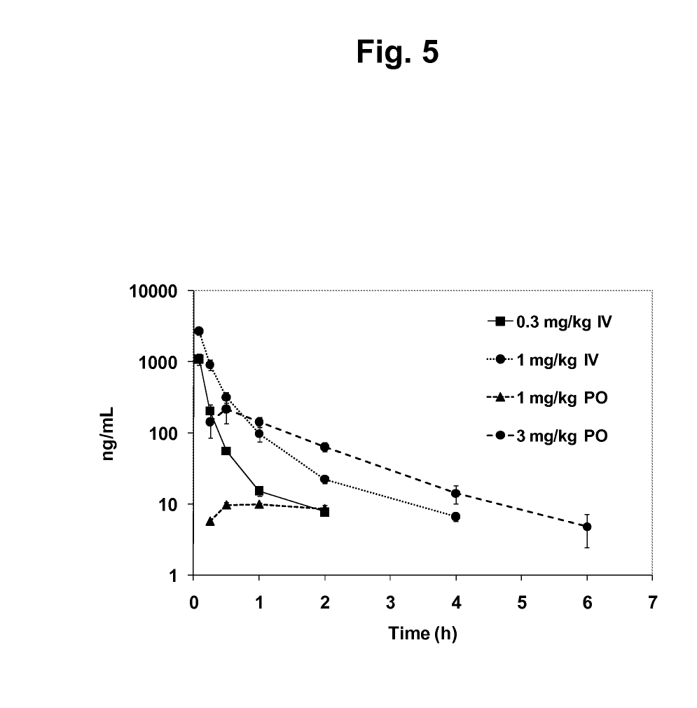

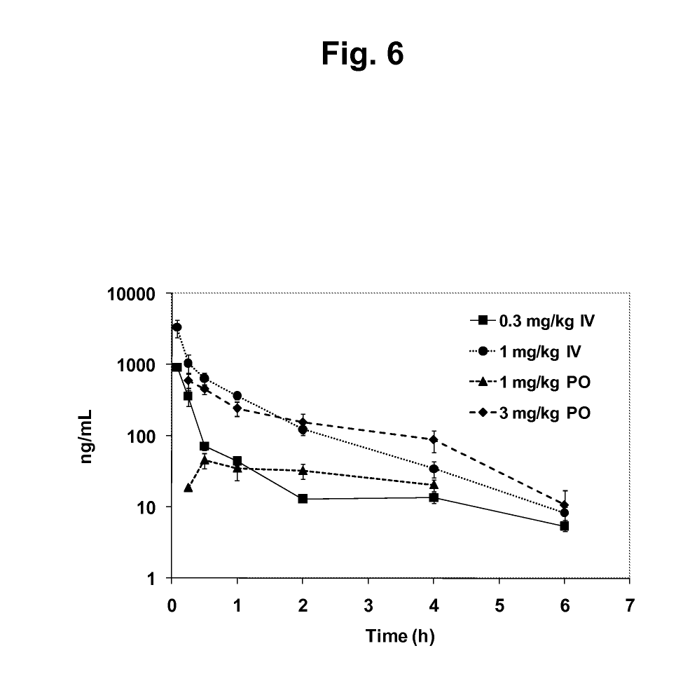

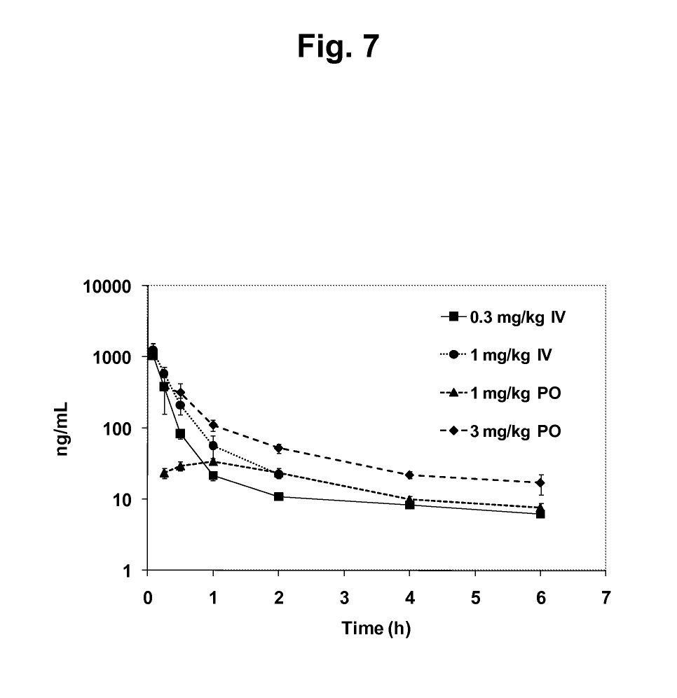

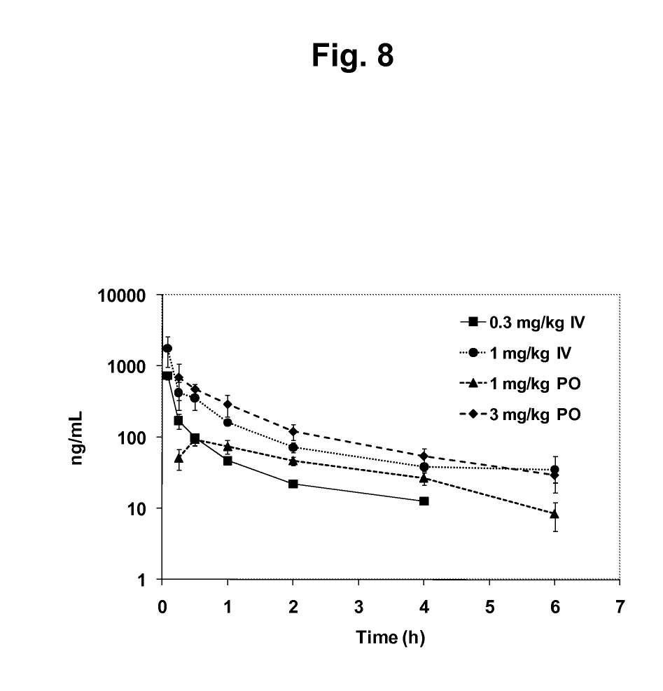

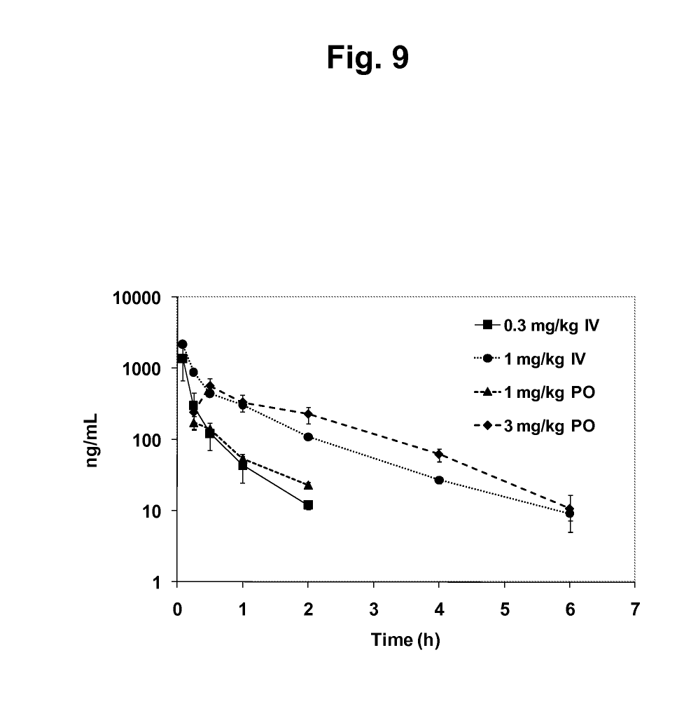

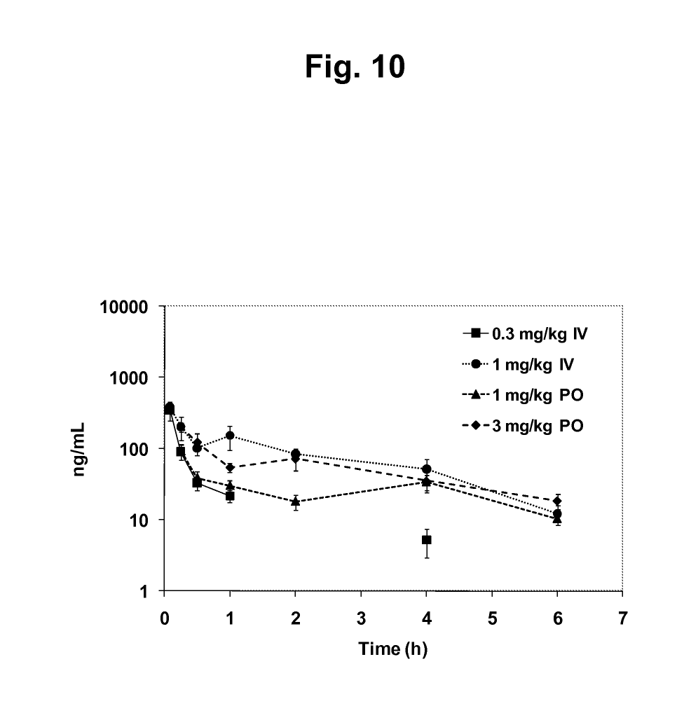

The mean±SEM. pharmacokinetic parameters for Compound 1 in male Sprague Dawley rats administered as single iv and oral doses of the citric acid ester of Compound 1 (“Form 1” or “Form 2”) or the diethanolamine ester of Compound 1 (“DEA Adduct”; i.e., boronic ester of Formula X) are shown in Tables 5-10 and corresponding FIGS. 5-10.

TABLE 5
Plasma parameters for Compound 1 dosed as citric acid ester of
Compound 1, Form 1

| | 0.3 mg/ | 1 mg/ | | |
|---|---|---|---|---|
| Form 1 Dosed | kg IV | kg IV | 1 mg/kg PO | 3 mg/kg PO |
| t½, h | 0.7 ± 0.1 | 1.1 ± 0.2 | — | 1.1 ± 0.1 |
| AUC₀₋ₜ, ng * h/mL | 341 ± 59 | 966 ± 117 | 22 ± 5 | 349 ± 94 |
| AUC_{0-∞}, ng * h/mL | 348 ± 57 | 975 ± 116 | 34 ± 5 | 366 ± 89 |
| Vd, L/kg | 0.9 ± 0.2 | 1.7 ± 0.6 | — | — |
| CL, mL/min/kg | 15 ± 3 | 18 ± 2 | — | — |
| Cₘₐₓ, ng/mL | — | — | 11 ± 0 | 231 ± 81 |
| Tₘₐₓ, h | — | — | 1.0 ± 0.5 | 0.6 ± 0.2 |
| Oral Bioavailability | — | — | 3 ± 1 | 12 ± 3 |

TABLE 6
Blood parameters for Compound 1 dosed as citric acid ester of Compound
1, Form 1

| | 0.3 mg/ | | 1 mg/ | |
|---|---|---|---|---|
| Form 1 Dosed | kg IV | 1 mg/kg IV | kg PO | 3 mg/kg PO |
| t½, h | 2.1 ± 0.4 | 0.9 ± 0.1 | 2.0 | 1.2 ± 0.2 |
| AUC₀₋ₜ, ng * h/mL | 369 ± 8 | 1672 ± 352 | 117 ± 25 | 915 ± 167 |
| AUC_{0-∞}, ng * h/mL | 385 ± 6 | 1684 ± 348 | 168 ± 23 | 952 ± 179 |
| Vd, L/kg | 2.3 ± 0.5 | 1.0 ± 0.4 | — | — |
| CL, mL/min/kg | 13 ± 0 | 11 ± 3 | — | — |
| Cₘₐₓ, ng/mL | — | — | 47 ± 12 | 674 ± 120 |
| Tₘₐₓ, h | — | — | 1.7 ± 1.2 | 0.3 ± 0.1 |
| Oral Bioavailability | — | — | 8 ± 1 | 11 ± 2 |

TABLE 7
Plasma parameters for Compound 1 dosed as citric acid ester of
Compound 1, Form 2

| | 0.3 mg/ | 1 mg/ | | |
|---|---|---|---|---|
| Form 2 Dosed | kg IV | kg IV | 1 mg/kg PO | 3 mg/kg PO |
| t½, h | — | 0.7 ± 0.2 | — | 1.8 ± 0.2 |
| AUC₀₋ₜ, ng * h/mL | 372 ± 22 | 504 ± 64 | 106 ± 14 | 438 ± 137 |
| AUC_{0-∞}, ng * h/mL | — | 512 ± 64 | 132 ± 18 | 485 ± 135 |
| Vd, L/kg | — | 1.9 ± 0.5 | — | — |
| CL, mL/min/kg | — | 34 ± 4 | — | — |
| Cₘₐₓ, ng/mL | — | — | 34 ± 4 | 422 ± 226 |
| Tₘₐₓ, h | — | — | 1.0 ± 0.0 | 0.4 ± 0.1 |
| Oral Bioavailability | — | — | 9 ± 1 | 31 ± 8 |

TABLE 8
Blood parameters of Compound 1 dosed as citric acid ester of Compound
1, Form 2

| | 0.3 mg/ | | 1 mg/ | |
|---|---|---|---|---|
| Form 2 Dosed | kg IV | 1 mg/kg IV | kg PO | 3 mg/kg PO |
| t½, h | 1.8 ± 0.3 | 2.3 ± 0.9 | 1.9 ± 0.1 | 2.1 ± 0.3 |
| AUC₀₋ₜ, ng * h/mL | 318 ± 37 | 951 ± 256 | 231 ± 54 | 892 ± 257 |
| AUC_{0-∞}, ng * h/mL | 344 ± 35 | 1125 ± 266 | 267 ± 51 | 980 ± 286 |
| Vd, L/kg | 2.3 ± 0.4 | 3.3 ± 1.1 | — | — |
| CL, mL/min/kg | 15 ± 2 | 18 ± 5 | — | — |
| Cₘₐₓ, ng/mL | — | — | 94 ± 20 | 771 ± 380 |
| Tₘₐₓ, h | — | — | 0.7 ± 0.2 | 0.3 ± 0.1 |
| Oral Bioavailability | — | — | 24 ± 4 | 29 ± 8 |

TABLE 9
Plasma parameters for Compound 1 dosed as boronic ester of Formula X

| | 0.3 mg/ | | 1 mg/ | |
|---|---|---|---|---|
| DEA Adduct Dosed | kg IV | 1 mg/kg IV | kg PO | 3 mg/kg PO |
| t½, h | 0.6 ± 0.1 | 1.1 ± 0.1 | — | 1.1 ± 0.1 |
| AUC₀₋ₜ, ng * h/mL | 449 ± 256 | 1225 ± 42 | 170 ± 16 | 990 ± 310 |
| AUC_{0-∞}, ng * h/mL | 457 ± 254 | 1240 ± 47 | 182 ± 17 | 1029 ± 299 |
| Vd, L/kg | 0.9 ± 0.3 | 1.2 ± 0.1 | — | — |
| CL, mL/min/kg | 20 ± 9 | 13 ± 1 | — | — |
| Cₘₐₓ, ng/mL | — | — | 179 ± 39 | 567 ± 185 |
| Tₘₐₓ, h | — | — | 0.3 ± 0.1 | 0.5 ± 0.0 |
| Oral Bioavailability | — | — | 12 ± 1 | 27 ± 8 |

TABLE 10
Blood parameters for Compound 1 dosed as boronic ester of Formula X

| | 0.3 mg/ | | 1 mg/ | |
|---|---|---|---|---|
| DEA Adduct Dosed | kg IV | 1 mg/kg IV | kg PO | 3 mg/kg PO |
| t½, h | 2.2 ± 0.4 | 1.4 ± 0.2 | 2.8 | 1.7 ± 0.2 |
| AUC₀₋ₜ, ng * h/mL | 168 ± 46 | 509 ± 89 | 166 ± 16 | 336 ± 69 |
| AUC_{0-∞}, ng * h/mL | 190 ± 45 | 535 ± 100 | 200 ± 17 | 381 ± 78 |
| Vd, L/kg | 5.8 ± 1.9 | 3.9 ± 0.7 | — | — |
| CL, mL/min/kg | 30 ± 6 | 33 ± 6 | — | — |
| Cₘₐₓ, ng/mL | — | — | 92 ± 39 | 205 ± 84 |
| Tₘₐₓ, h | — | — | 0.3 ± 0.1 | 0.8 ± 0.6 |
| Oral Bioavailability | — | — | 32 ± 1 | 23 ± 4 |

Based on these results it can be concluded that the DEA adduct of Compound 1 (i.e., compound of Formula X) is orally bioavailable.

As those skilled in the art will appreciate, numerous modifications and variations of the present invention are possible in light of the above teachings. It is therefore understood that within the scope of the appended claims, the invention may be practiced otherwise than as specifically described herein, and the scope of the invention is intended to encompass all such variations. All publications referenced herein are incorporated by reference in their entireties for all purposes.

1. A boronic ester of Formula I 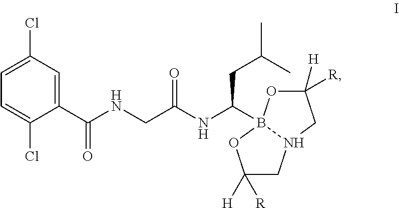
wherein R is H or methyl.

2. The boronic ester of claim 1, wherein R is H.

3. The boronic ester of claim 1, wherein R is CH₃.

4. A process for preparing a pharmaceutical composition comprising the step of combining a boronic ester of claim 1 with a pharmaceutically acceptable excipient.

5. A process for preparing a pharmaceutical composition of Compound 1 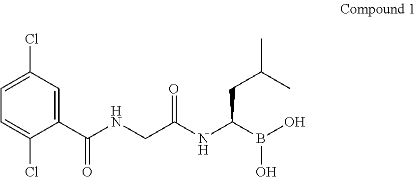 [SMILES: CC(C)C[C@H](NC(=O)CNC(=O)c1cc(Cl)ccc1Cl)B(O)O]
comprising the steps of:
(a) converting a boronic ester of claim 1 into Compound 1; and
(b) combining the Compound 1 with a pharmaceutically acceptable excipient.

6. A process for purifying Compound 1 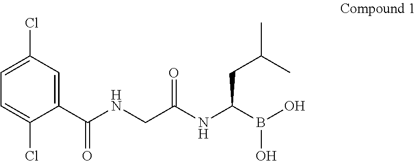 [SMILES: CC(C)C[C@H](NC(=O)CNC(=O)c1cc(Cl)ccc1Cl)B(O)O]
comprising the steps of:
(a) converting the Compound 1 into a boronic ester of claim 1;
(b) crystallizing the boronic ester from a solution;
(c) isolating the crystallized boronic ester from the solution; and
(d) converting the isolated boronic ester into Compound 1.

7. A process for preparing Compound 1 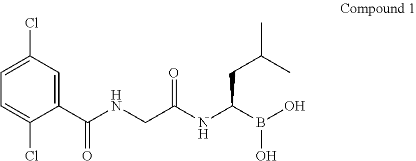 [SMILES: CC(C)C[C@H](NC(=O)CNC(=O)c1cc(Cl)ccc1Cl)B(O)O]
comprising the steps of
(a) crystallizing a boronic ester of claim 1 from a solution; and
(b) converting the crystallized boronic ester into Compound 1.

8. Compound 1 having a chemical purity of at least 99.5%

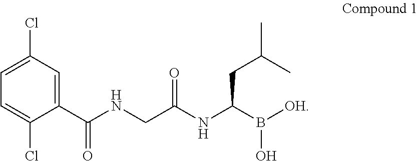 [SMILES: CC(C)C[C@H](NC(=O)CNC(=O)c1cc(Cl)ccc1Cl)B(O)O]

9. A pharmaceutical composition comprising Compound 1 having a chemical purity of at least 99.5% 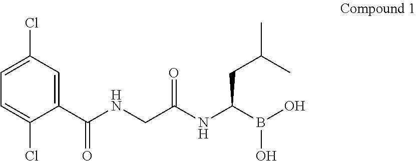 [SMILES: CC(C)C[C@H](NC(=O)CNC(=O)c1cc(Cl)ccc1Cl)B(O)O]
and a pharmaceutically acceptable excipient.
